(19) United States
(12) Patent Application Publication
(10) Pub. No.: US 2003/0135495 A1
(43) Pub. Date: Jul. 17, 2003

(54) Database indexing method and apparatus

(75) Inventor: Paul P. Vagnozzi, Farmington Hills, MI (US)

Correspondence Address: JAMES D. STEVENS, REISING, ETHINGTON, BARNES, KISSELLE, ET AL, P.O. BOX 4390, TROY, MI, 48099, US

(73) Assignee: ISC, INC., Wilmington, DE (US)

(21) Appl. No.: 10/176,566

(22) Filed: Jun. 21, 2002

Related U.S. Application Data
(60) Provisional application No. 60/299,952, filed on Jun. 21, 2001.

(51) Int. Cl. G06F 7/00

(52) U.S. Cl. 707/3

(57) ABSTRACT

A database indexing method and apparatus which includes an index structure for indexing a plurality of objects that are logically divided into fine slices of 8,000 records each, and the fine slices are grouped into coarse slices of 4,000 fine slices each. The indexes include fine and coarse keys, each of which corresponds to a particular data value and a particular fine or coarse slice. Bit vectors are used to determine which of the fine slices or objects identified by the fine slices have particular attributes, and these bit vectors can be stored in compressed format. The index structure can be used to index data where no data records exist. A word indexing technique for crossing page boundaries within a document is also disclosed, as well as a technique for enumerating and displaying virtual folders and their contents.

### CROSS-REFERENCE TO RELATED APPLICATION

This application claims the priority of U.S. Provisional Application No. 60/299,952, filed Jun. 21, 2001 and entitled Database Indexing Method and Apparatus. The entire content of that provisional application is hereby incorporated by reference.

### TECHNICAL FIELD

This invention relates in general to techniques for storing and retrieving data on digital computers, and in particular, to database indexing techniques used for document management.

### BACKGROUND OF THE INVENTION

As the processing speed and storage capacity of digital computers continues to increase, so does their suitability for management of very large databases. To be useful, a database typically needs to be searchable so that a user can perform keyword searching of the database and retrieve information associated with the keywords. For large databases, linear searching of the data for keywords is typically too time consuming to be useful. Consequently, large databases are often indexed to provide fast query processing and retrieval of data.

As is known, in most databases, data is organized logically and often physically into individual fields within a record, with each record representing a collection of data about an object such as a patient, a vehicle, or a document, and each field within the record containing a different item of data about the object, such as the patient's last name, first name, age, gender, etc. To provide flexibility, the database management program must not only permit single keyword searches of the data fields, but must support more complex queries, including boolean expressions (e.g., AND, OR, NOT) of keywords.

Often, a database will include both high and low cardinality data; that is, the database will include types of data that can have many different values as well as types of data that will have very few different values. Examples of low cardinality data include a person's gender (male or female), political party affiliation, or the make of a vehicle. Examples of high cardinality data include such things as last names, birth dates, vehicle identification numbers (VIN), and social security numbers (SSN), the last two of which will likely include a unique value in every record in the database. For optimum flexibility, a database index must permit efficient searching for both high and low cardinality data. However, typical storage methods are designed and optimized for retrieval of high cardinality data only, using single or compound key indexes.

One way of indexing a database is through the use of keys that provide a fast way to locate specific items of data within the database. These keys are used by a database management program to locate and retrieve records from the database that contain the data associated with the keys. Bitmaps or bit vectors are sometimes used along with keys to identify which records contain a particular item of data within a particular data field. These bit vectors comprise a string of bits with each bit representing a single record in the database. A particular bit vector will represent a particular item of data that is found in a particular field in at least one of the records of the database. The presence of a set bit (i.e., a bit set to a logical one) in the bit vector indicates that the record associated with that bit contains the particular item of data. Thus, for example, where a database contains patient records that include a “first name” field, a bit vector of “0010100000” that is associated with the name “Elizabeth” for the “first name” field will indicate that the third and fifth records are for patients named Elizabeth.

Sometimes, in addition to indexing a database, the database itself is stored along with the index rather than maintaining the database as a separately stored structure. For example, in U.S. Pat. No. 4,606,002 to A. Waisman et al., a B-tree is used to store the database data along with an inverted B-tree index that uses keys and associated sparse array bit maps to identify which records contain particular items of data. A record index is used to identify different tables of records (e.g., a table of patient records versus a table of doctor records) and to distinguish between the database data and the indexes. The data is stored using odd numbered record identifiers and the associated indexes are stored using the next even numbered record identifier. Each key and associated sparse array bit map are associated with a range of records and are stored together in the B-tree. The key itself comprises a record identifier, field identifier, data value, and range value, in that order. The record identifier indicates to which table of data the key relates. The field identifier is a numeric identifier of the field within the records to which the key relates. The data value is the actual item of data contained in at least one of the records to which the key relates. And the range value identifies the range of records to which the key relates. The sparse array bit map includes three levels of bit vectors. The bottom level comprises a number of one-byte bit vectors, with the individual bits of each bit vector indicating which records within the associated range of records contain the associated data value in the field specified by the field identifier. The middle level contains one-byte bit vectors in which each bit represents one of the one-byte bit vectors of the bottom level. A bit in the middle level bit vectors is set (to a logical one) if any of the bits in the bottom level bit vector that it represents is set; otherwise it is zeroed. This same structure is carried out to the upper level which includes a single byte representing all of the middle level bit vectors. Where a bit vector would not include any set bits, the bit vector is not allocated and its absence is indicated by its associated bit from the next higher level being zeroed.

As noted by Waisman et al., the use of bit vectors simplifies the processing of boolean expressions since two bit vectors can be combined in accordance with the specified boolean operator and the resulting bit vector represents the records that satisfy the boolean expression. One problem in combining upper level bit vectors in which the bits do not represent individual records is in the processing of NOT expressions. Since a set bit indicates only that at least one (but not necessarily all) records in the associated range of records includes the data value, the NOT operation cannot be accomplished simply by inverting the bit. Rather, as discussed in Waisman et al., the lower level bits that represent individual records must be inverted and used.

Since, in Waisman et al., the data is stored at the bottom level of a B-tree, consecutively numbered records need not be physically stored together. This permits the use of variable length fields and permits fields to be added to the database without having to reorganize the database or make changes to the database management program that is used to access the data. However, this type of database structure can complicate retrieval of records, since the fields of any one record may not all be physically stored together and since separate I/O accesses may often be required for retrieval of even a small group of consecutive records. Given the relative slowness of I/O access, the data storage structure utilized by Waisman et al. can result in undesirably slow retrieval of records.

### SUMMARY OF THE INVENTION

In accordance with the invention, there is provided a database indexing method and apparatus in which an index structure can be used to associate data with a plurality of objects, wherein each of the objects has a plurality of attributes associated therewith and one or more data values for each of the attributes. The index is associated with a first attribute of the objects, and it comprises a number of keys that include one or more coarse keys and a number of fine keys, wherein each of the fine keys is associated with a group of the objects and with one of the first attribute's data values. The one or more coarse keys are each associated with a particular one of the first attribute's data values and with a set of the fine keys that are also each associated with that particular data value. Bit vectors can be used for each data value to indicate whether or not each object has a particular data value for its first attribute. This arrangement permits the storage and retrieval of information concerning the objects without the need for records to store the actual data.

In accordance with another aspect of the present invention, there is provided an indexing method and apparatus in which in which the index is associated with an attribute of a group of objects and utilizes a plurality of compressed bit vectors to identify which objects have a particular data value for the attribute. At least some of the compressed bit vectors utilize run length encoding and have a variable run length field size.

In accordance with another aspect of the present invention, there is provided an indexing method and apparatus for use in indexing words contained in documents. The word index is associated with a text word contained in at least one of the documents, and includes a number of bit vectors that include a sequence of bits wherein each bit corresponds to a portion of one of the documents. Some of the bits correspond to an individual page of the document and others correspond to portions of two adjacent pages of the document.

In accordance with another aspect of the present invention, there is provided an indexing method and apparatus used to associate a time stamp with a plurality of objects. For this, a plurality of indexes are used, each having time stamp information related to an event concerning each of the associated objects. Each index includes a number of keys with the keys of each index being associated with a different length time interval than the keys of the other index(es). The time stamp for each of the objects is determinable from a combination of data contained in each of the indexes.

In accordance with yet another aspect of the present invention, there is provided an indexing method and apparatus that stores one or more indexes used to represent hierarchical relationships between objects such as files stored on a computer system. Each of the objects has a plurality of attributes associated therewith and one or more data values for each of the attributes. A plurality of indexes are used with each being associated with a different one of the attributes and each index associating data values of its corresponding attribute with objects that have those data values of the corresponding attribute. A computer program is used to access the indexes and to provide a graphical user interface displaying a virtual folder corresponding to a particular one of the data values and displaying a set of object identifiers contained within that virtual folder. The object identifiers then represent those objects that are associated with the particular data value.

### BRIEF DESCRIPTION OF THE DRAWINGS

A preferred exemplary embodiment of the present invention will hereinafter be described in conjunction with the appended drawings, wherein like designations denote like elements, and:

FIG. 1 depicts the structure of a sample database used for explaining the index structure utilized by the present invention;

FIG. 2 is an overview of query processing using a key-based index;

FIG. 3 depicts the logical separation of data records into coarse and fine slices for use in generating database indexes;

FIG. 4 is a diagrammatic representation of sample vehicle color data for each of a number of records from the database of FIG. 1;

FIG. 5 depicts the general form of the structure of an index utilized by the present invention;

FIG. 6A depicts an index structure for the sample data of FIG. 4;

FIG. 6B depicts an improved index structure for the sample data of FIG. 4 using bit vector compression;

FIG. 7 shows the layout of keys used in the indexes of FIGS. 5, 6A and 6B;

FIG. 8 shows the layout of the fine links used in the indexes of FIGS. 5, 6A, and 6B;

FIG. 9 shows the layout of the coarse links used in the indexes of FIGS. 5, 6A, and 6B;

FIG. 10 shows the layout of the coarse bit vector used in the indexes of FIGS. 5, 6A, and 6B;

FIG. 11A depicts the B-tree structure which is used to store the keys and links of the index of FIG. 6A;

FIG. 11B depicts the B-tree structure which is used to store the keys and links of the index of FIG. 6B;

FIG. 12 is a block diagram of a computer system for use in implementing the present invention;

FIG. 13 is a flow chart depicting a process for counting the number of records that satisfy a given query;

FIG. 14 is a flow chart depicting a process for retrieving the records that satisfy a given query;

FIGS. 15-23 depict various tables used in describing an indexing technique that uses bit vectors to manage arbitrary sets and subsets of objects;

FIGS. 24-56 are used to depict various aspects of a page indexing technique that can be used for document management; and

FIGS. 57-71 depict sample data sets, tables, and flow charts used to demonstrate and illustrate the use of the indexing techniques disclosed herein for enumeration of virtual folders and their contents.

### DESCRIPTION OF THE PREFERRED EMBODIMENT

Data Storage within the Database

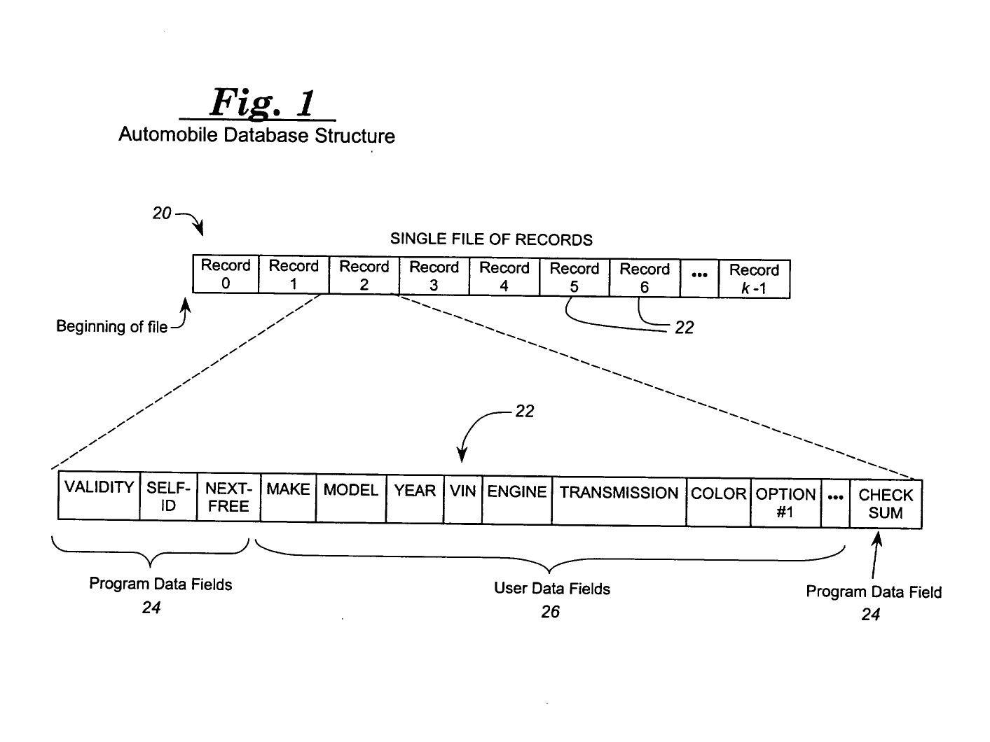

Referring to FIG. 1, there is shown a database 20 comprising a table of records 22. Each of the records has a fixed length and is assigned a unique record number, starting with zero. This allows the records to be stored sequentially in a single file with the location within the file of any particular record simply being determined by multiplying the record length (in bytes) by that record's assigned record number and using the resulting value as an offset from the beginning of the file. This arrangement provides very simple and fast allocation, de-allocation, and re-use of data record space within the file. Also, by storing all of the records within a single file, entire databases can be easily created or deleted. Creation simply requires creating a new, empty file. Deletion simply requires deleting an existing file. All user access to the database is by way of a database management program which allows the user to add, change, and delete data from the database. As will be discussed below, the database management program supports boolean and other query processing using key-based indexes that provide fast access to the data within the database.

As shown in FIG. 1, the database 20 consists of vehicle information with each record 22 having an identical format that includes a number of program data fields 24 and a number of user data fields 26. The program data fields include validity, self-id, next-free, and checksum fields. These fields are not accessible to the user, but are used by the database management program as a part of managing the database, as will be described below. The user data fields 26 include the actual data fields used to store the database data. In the illustrated embodiment, these fields include vehicle make, model, year, VIN, engine, transmission, color, and a number of option fields for storing information about various options a vehicle may have; for example, a sun-roof, aluminum wheels, side-impact airbags, etc. As will be appreciated, the user data fields can be specified by the user as a part of initially setting up the database, with the user specifying the size and data type (e.g., string, date, integer) of each user data field to be included in the database. All fields, both program data fields and user data fields, are fixed length fields so that the records all have a fixed length and can be easily accessed using a calculated offset, as described above.

The validity data field is used to mark the record as either in-use (valid) or deleted (invalid). This is used where a record has used and then deleted by the user, in which case the validity field is used to indicate that the record does not contain valid data and can be re-used. The validity field can be a single bit, although a byte pattern can preferably be used to prevent loss of data due to a corruption of a single bit. The validity field can be used during recovery operations to determine the validity of data contained in the record's fields. This field can be indexed along with the user data fields, as will be described below. The self-id data field contains a unique identification of the record. The self-id comprises the file identifier (e.g., filename of the database) and the record number of the record. This field is used by the database management program to verify that the record is in fact what it is believed to be. The next-free field points to the next free (i.e., deleted) record using the offset of the record to which it points. This field is used to form a stack of deleted records which can be re-used when new data records are added to the database. Finally, the checksum field contains a checksum value computed on the entire contents of the record, except for the checksum item itself. The checksum provides validity checking to insure database consistency and correctness.

Indexing of the Database

To permit keyword searching of user data fields within database 20, all searchable user data fields 26 are indexed with keys that are used to identify which records contain a particular item of data (i.e., data value) within a particular field. Typical queries might be, for example:

VIN=XYZ123

MAKE=Chevrolet

MODEL=Corvette AND YEAR=1975

ENGINE=V6A OR ENGINE=V8G

MODEL=Scout AND (Trans=T3 OR Trans=T4)

AND NOT (COLOR=Grey OR YEAR<1969)

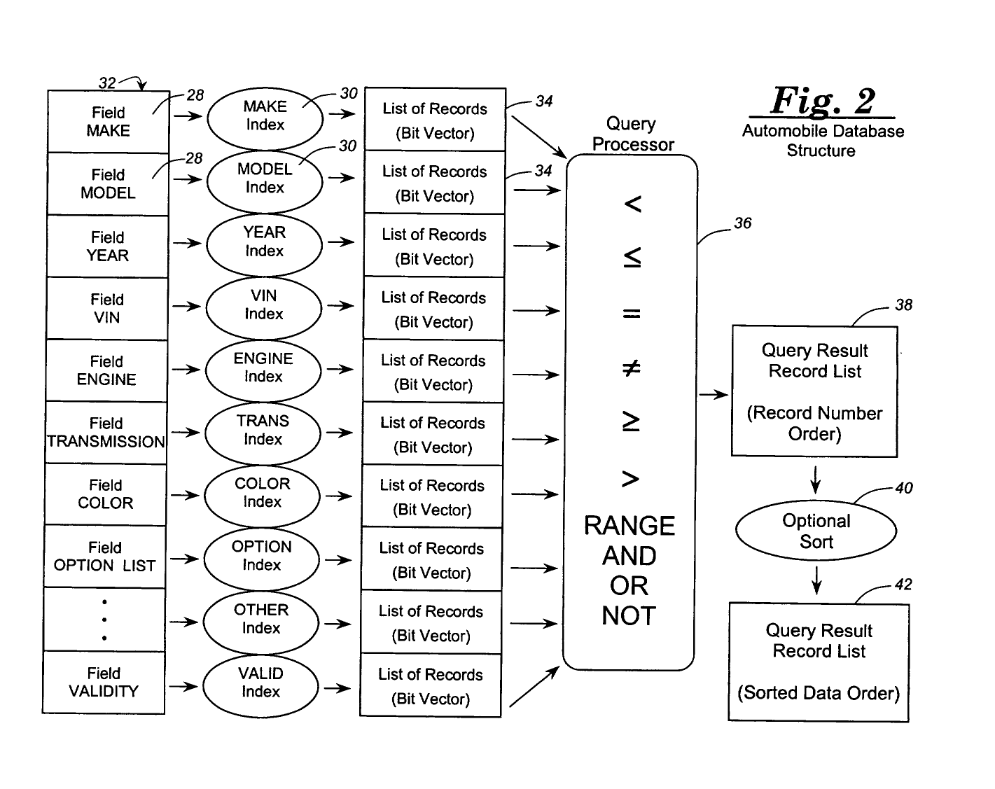

FIG. 2 provides an overview of how query processing is accomplished using these indexes. For each indexed data field 24 and 26, a pointer 28 is provided which points to an index 30 for that particular data field. The pointers are stored in a table 32 that is separate from the actual database itself. Using the index 30, the database management program obtains a list 34 (represented by one or more bit vectors) of records 22 that contain the keyword used in the query. For boolean and range searches (i.e., for multiple keyword queries), the lists are processed by a query processor module 36 that compares the lists 34 to each other in accordance with the appropriate boolean logic, resulting in a list 38 of records that satisfy the query. The records are then retrieved and, if desired, processed by an optional sort 40, resulting in a final, sorted query result record list 42.

The indexes 30 are actually collections of keys stored in a B-tree. In creating the indexes, separate keys are generated not only for each user data field, but also for each data value that is stored within that data field in at least one of the records. Associated with each key is a link that is used to determine which records contain the data value associated with the key. To optimize the retrieval of records based upon query processing, a hierarchical structure of keys and bit vectors are used, with each key and bit vector representing no more than a certain number of records in the database. Thus, when creating the index, multiple keys and bit vectors are generated for each data value of each data field and the number of keys and bit vectors generated will depend upon the total number of records in the database and the distribution of data among those records. Two types of keys and bit vectors are used: coarse and fine, with the fine keys and bit vectors each representing a group of consecutive records and the coarse keys and bit vectors each representing a set of consecutive fine bit vectors.

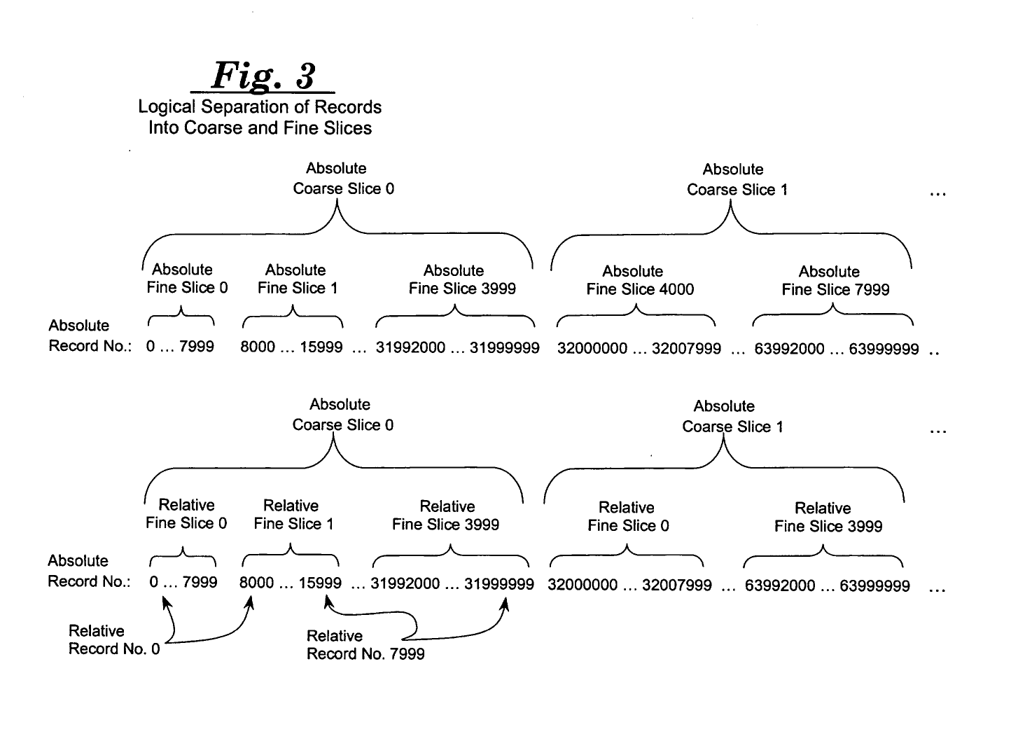

The indexing of database 20 using these keys and bit vectors will now be described in detail in connection with FIGS. 3-11. FIG. 3 depicts the logical separation of records into groups of what will be referred to as fine slices, with the fine slices being logically organized into sets of what will be referred to as coarse slices. As shown in the top portion of FIG. 3, each fine slice comprises 8,000 consecutive records and each coarse slice comprises 4,000 consecutive fine slices. Accordingly, a single coarse slice represents 32 million consecutive records in the database. Each fine slice has a unique, absolute fine slice number which, for a given record k and fine slice length fsl, is equal to:

k DIV fsl,

where DIV indicates integer division which returns the integer quotient. Thus, for (absolute) record number 40,420,973 and a fine slice length of 8,000, the absolute fine slice number will be equal to 5,052 (40,420,973 DIV 8,000). Similarly, each coarse slice has a unique, absolute coarse slice number that, for a given record k, a given coarse slice length csl, and a given fine slice length fsl, is equal to:

k DIV (csl×fsl).

Thus, for record number 40,420,973 with a coarse slice length of 4,000 and a fine slice length of 8,000, the absolute coarse slice number will be 1 (40,420,973 DIV 32,000,000).

Within any particular fine slice, each record 22 can be identified by a relative record number which indicates the position of the record within that particular fine slice. For a given record k, the relative record number is equal to:

k MOD fsl,

where MOD indicates modulus division which returns the integer remainder. Thus, for a fine slice length of 8,000, (absolute) record number 40,420,973 has a relative record number of 4,973 (40,420,973 MOD 8,000). Similarly, within any particular coarse slice, each fine slice can be identified by a relative fine slice number which indicates the position of the fine slice within that particular coarse slice. For a given record k, the relative fine slice number is equal to:

(k MOD (csl×fsl)) DIV fsl,

Thus, for the slice lengths given above, the relative fine slice number for record number 40,420,973 would be 1,052 ((40,420,973 MOD 32,000,000) DIV 8,000). As will be discussed further below, the relative record numbers and relative fine slice numbers are used in connection with the links associated with the fine and coarse keys, respectively.

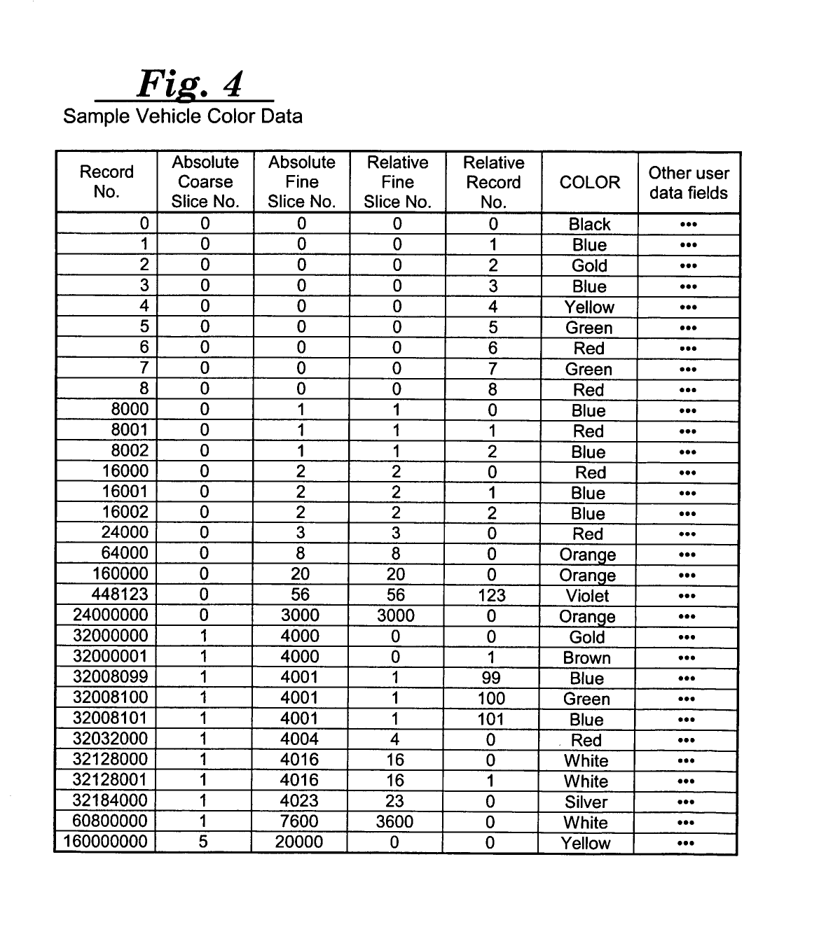

For purposes of illustration, FIG. 4 provides sample data from database 20 of FIG. 1 showing different data values stored in the “vehicle color” field 26 of a number of records 22 within the database. To aid in understanding the index structure, FIG. 4 also includes columns listing the absolute coarse and fine slice numbers for the records 22, the relative fine slice numbers of the records within a particular coarse slice, and the relative record numbers of the records within a particular fine slice. It will be appreciated that the table of FIG. 4 is simply a logical view of the data and associated slice numbers and does not represent any actual data structure used by the database management program. Also, while the sample data provided in FIG. 4 will be used in connection with the following description and attached drawings, it will be appreciated that the sparseness of the vehicle color data is only provided for the purpose of simplifying the illustration of the database and that, for low cardinality data such as vehicle color, it is probable that most if not all fine slices will contain a large number of records having a particular data value, such as blue.

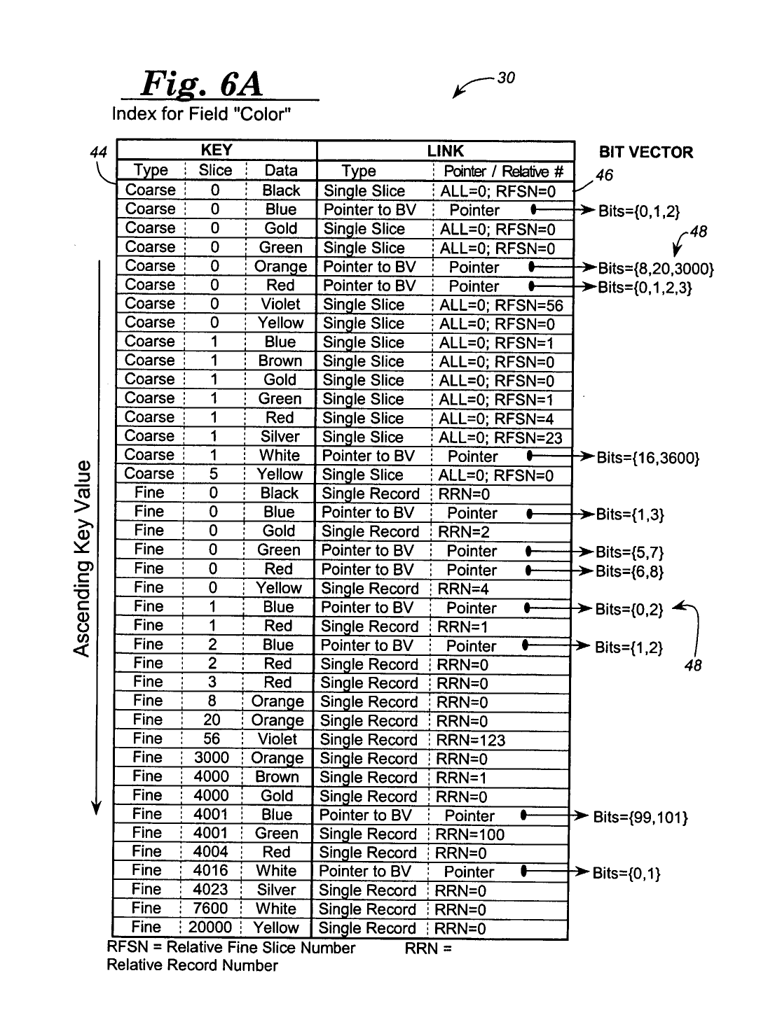

For each data value of an indexed data field, there will be one key generated for each fine slice and coarse slice that contains at least one record having the data value within the data field. For example, assuming the database contains 160.5 million records, there will be a minimum of 1 coarse key and 1 fine key and a maximum of 6 coarse keys and 20,063 fine keys generated for each item of data, with the actual number of coarse and fine keys depending upon the number and distribution of the data value among the records in the database. For instance, in the sample data of FIG. 4, only records 32,128,000, 32,128,001, and 60,800,000 contain data value =“white” in the vehicle color field. Thus, for this data value there will be a total of three keys: one coarse key (since all three records are within the same coarse slice) and two fine keys—one for fine slice 4016, which contains both records 32,128,000 and 32,128,001, and one for fine slice 7,600, which contains record number 60,800,000. These three keys are shown in the sample index of FIG. 6, which will be discussed below.

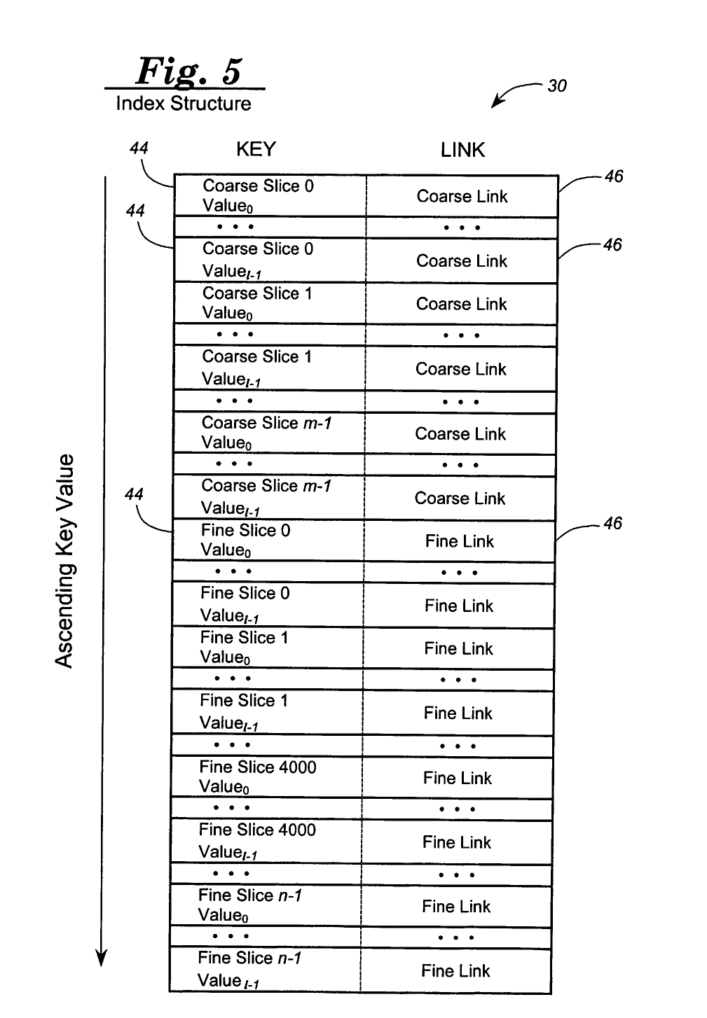

Referring now to FIG. 5, there is shown the general form of an index 30 for one of the data fields. As mentioned above, the index is comprised of keys 44 and associated links 46, with the key indicating the particular slice and data value with which it is associated and the link being used in determining which records contained in the slice include the data value in the associated user data field. For each data value contained in the data field 26 in at least one record 22 of the database, there will be at least one coarse key 44 and one fine key 44. Very high cardinality data, such as VIN number, may only have a single coarse and fine key, whereas low cardinality data, such as gender, is likely to be found in every fine slice in the database and can therefore require a key for every fine and coarse slice contained in the database. Thus, for any particular data field having data of cardinality l with a number m of coarse slices and a number n of fine slices, the index will logically take the form of FIG. 5, with there potentially being up to (n+m)×l separate keys and links.

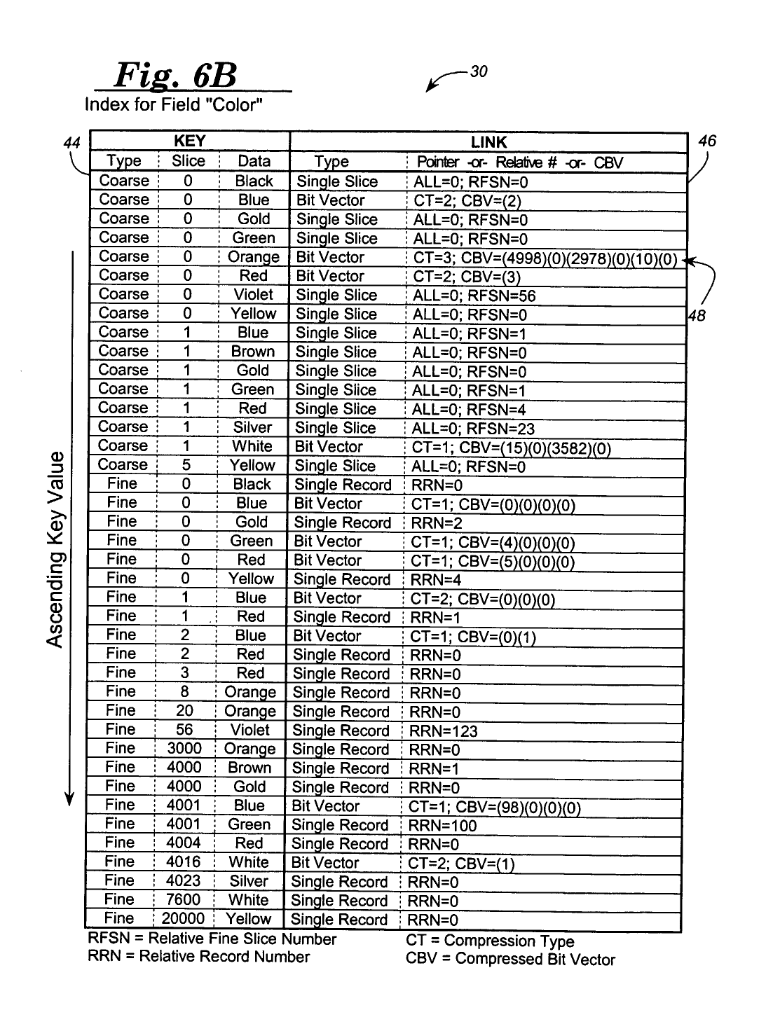

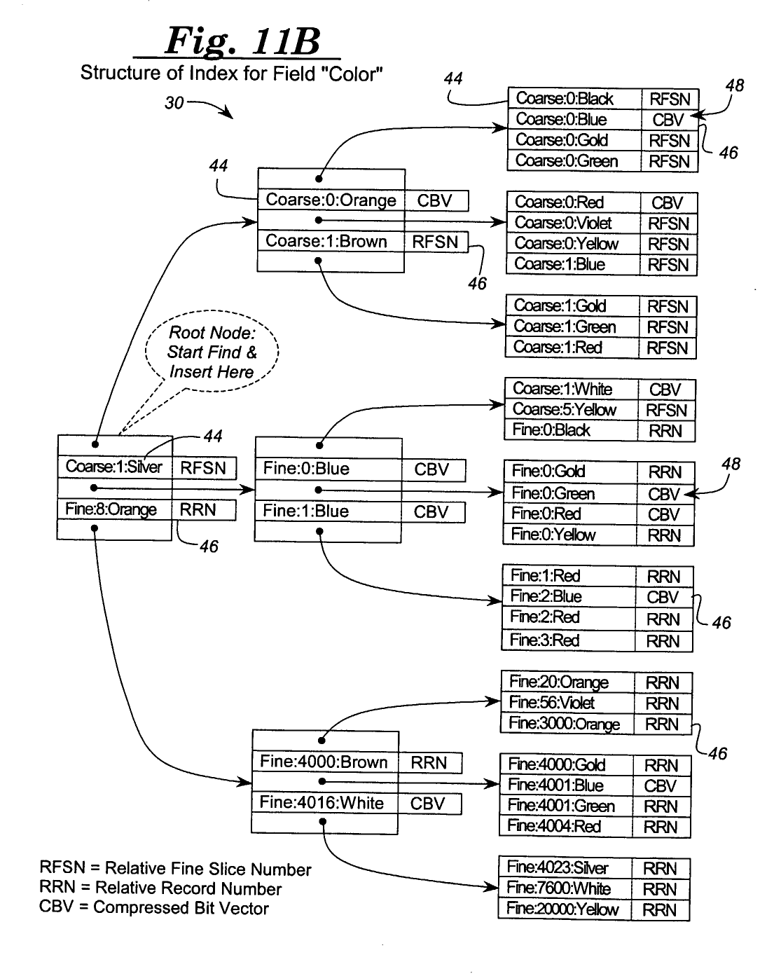

As a specific example, FIG. 6A depicts the actual contents of the vehicle color index 30 for the sample data from FIG. 4. FIG. 6B shows this same index 30 as it would be implemented using bit vector compression which will be described further below. The sample index includes a plurality of keys 44 and a link 46 associated with each of the keys. As mentioned above, for each data value (e.g., black, blue, gold, green, etc.) found anywhere in the database in the “color” data field, there is provided a coarse key for each coarse slice and a fine key for each fine slice containing at least one record having that data value within the “color” field. Thus, as explained above, for the color white, there would be one coarse key and two fine keys for the sample database. Although the index can be stored in various formats such as in the table format shown in FIGS. 5 and 6, it is preferably stored in a B-tree as will be discussed in connection with FIG. 11. In whatever form the index is stored, the keys are maintained in order by ascending key value, as will now be described in connection with FIG. 7.

FIG. 7 depicts the format of the keys 44, whether coarse or fine. Each key includes three portions 44a-c that are concatenated together into a single item for ordering of the keys within the index. The first portion 44a is a single bit which indicates the type of key, with a zero indicating that it is a coarse key and a one indicating that it is a fine key. The second portion 44b indicates the absolute slice number for the key, with the first slice being zero. Thus, for a fine key and a fine slice length of 8,000, fine slice 2 would correspond to records 16,000 through 23,999. For a coarse key, coarse slice 2 would correspond to fine slices 8,000 through 11,9999 (and, therefore, records 64,000,000 through 95,999,999). The third and final portion 44c of a key is the key's data value, which is simply the data value (e.g., black, blue, gold, green, etc.) to which that key corresponds.

Since, for both the fine and coarse slices there is only one key per data value, no two keys will be the same and, consequently, the three portions of the keys that are concatenated together provide a unique key value that is used to maintain the ordering of the keys within the B-tree index. The keys are stored in order of ascending key value. Thus, as shown in FIGS. 6A and 6B, the coarse keys (which begin with a cleared bit) will all be listed in the index before any of the fine keys (which begin with a set bit). Within the group of coarse keys, the keys will then be listed in order of slice number. For two or more coarse keys having the same slice number, the keys will be listed in order of the keys' data values (e.g., black, blue, gold, green, etc.), which may be alphabetically ordered for characters and strings or numerically ordered for integer and decimal numbers. Similarly, the fine keys will be ordered by slice number and, among fine keys having the same slice number, by key data value.

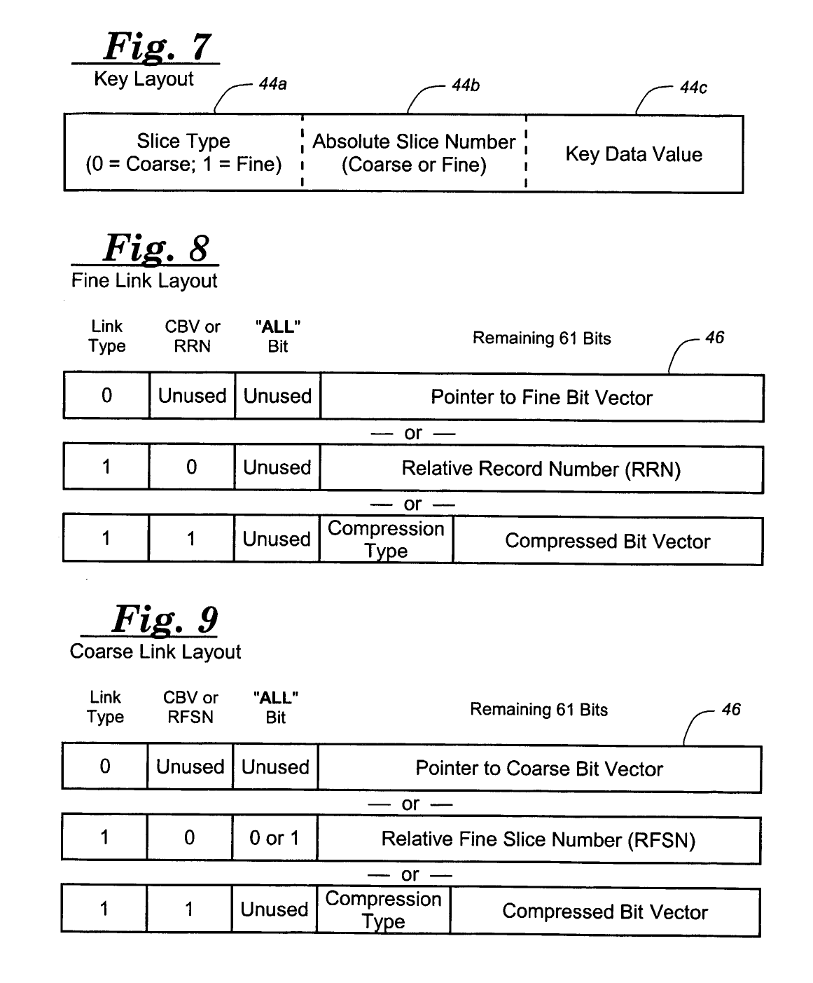

As mentioned above, the link 46 associated with each fine key is used to indicate which records within the associated fine slice contain the data value associated with the fine key. Referring now to FIG. 8, the layout for the fine link 46 is shown. The fine link can take any of three forms—a pointer to a bit vector, a relative record number (RRN), or a compressed bit vector (CBV). The first portion of the link comprises a link type which is a single bit indicating which type of link it is. A zero (i.e., cleared bit) indicates that the link is a pointer to a bit vector and a one (i.e., set bit) indicates that the link stores data identifying the records having the associated data value. This data is either a relative record number or a compressed bit vector. The first type of link (pointer to a bit vector) is used whenever the fine slice includes at least two records containing the data value. The pointer can either be an offset in the case of the bit vector being stored in the same file as the index, or can be a filename of another file along with an offset, if necessary. In either event the bit vector will include one bit for each record within the fine slice which, in the illustrated embodiment, would be 8,000 bits, with the first bit indicating whether or not the first record in the fine slice contains the data value, the second bit indicating whether or not the second record contains the data value, and so on for each of the remaining records in the fine slice. The second type of link (relative record number) is used whenever there is only one record within the fine slice that contains the associated data value. In that case, the fine link provides the relative record number of that one record. The third type of link (compressed bit vector) is used whenever the fine slice includes at least two records containing the data value, and the bit vector can be compressed to fit within the compressed bit vector portion of the link. When the bit vector can be compressed this provides significant savings of space and improvement in efficiency. As will be described further below, 61 bits are utilized for compression of the bit vector, 5 of which are used for specifying the compression type and the remaining 56 for storing the compressed bit vector. This provides a very large savings over the 8000 bit uncompressed fine bit vector. The second and third types of links are distinguished using the second bit of the link with a zero indicating that the link contains a relative record number and a one indicating that it contains a compressed bit vector. The third bit of the link is reserved for an “ALL” bit that is used by the coarse links, as will be described below.

Referring back to FIG. 6A, the two fine keys for slice 1 provide an example of the first two types of links. The first fine key associated with slice 1 has a value of blue and can be represented as f: 1:blue, with “f”indicating that it is a fine key, the “1” being the absolute slice number, and “blue” being the data value to which the key relates. As indicated in FIG. 6A, the link associated with key f:1:blue is of type 0, meaning that the link contains a pointer to a bit vector 48. In this case bit vector 48 contains a set bit (logical one) in bit positions 0 and 2. All other bit positions are cleared to a zero. This indicates that relative record numbers 0 and 2 of fine slice 1 contain blue in the vehicle color field. Referring back to the sample database of FIG. 4, it will be evident that this is correct—records 8,000 and 8,002 (which are relative records 0 and 2 of fine slice 1) contain the value “blue” in the vehicle color field.

Turning back to FIG. 6A, the second key for fine slice 1, namely, f:1:red, has a link of type 1, meaning that the link does not contain a pointer, but instead provides the relative record number (RRN=1) of the only record within fine slice 1 that contains “red” in the vehicle color field. Referring again to FIG. 4, it will be seen that relative record number 1 (which is absolute record number 8001) is in fact the only record within fine slice 1 that contains the value “red” in the vehicle color field. For high cardinality data such as a VIN, there will be a great number of keys created (since the number l of potential data values will be high) but very few records (often only one record) with the data value. Thus, where a slice has only a single record containing the data value, the storage of a record number within the link rather than both a pointer and an almost 1 KB bit vector can result in the saving of large amounts of storage memory.

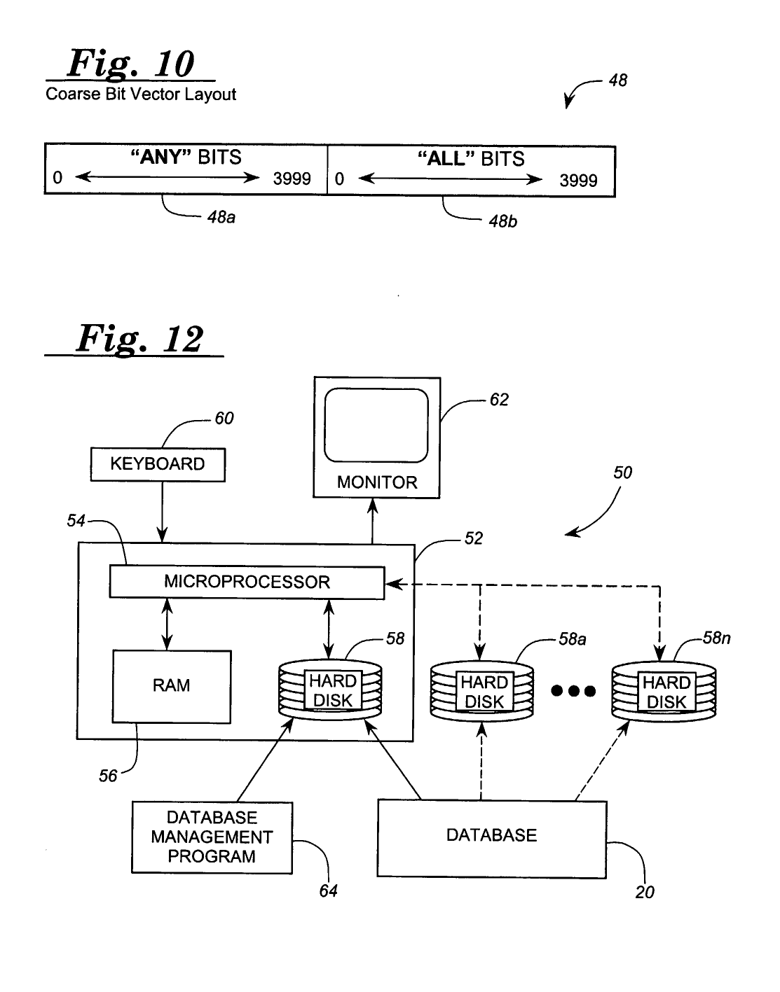

Referring now to FIG. 9, the layout is shown for the coarse links that are associated with the coarse keys. As with the fine links, the coarse links can be any of three types which are identified using two bits at the beginning of the link. The first type of link (pointer to bit vector) is indicated by a zero in the first bit position and contains a pointer to a bit vector that represents each of the fine slices within the associated coarse slice. The second type (relative fine slice number) is indicated by a one in the first bit position and a zero in the second position, and is used whenever the coarse slice contains only one fine slice having any records that contain the data value. In this case the link contains the relative fine slice number (RFSN) of that one fine slice. Note that, in addition to the relative fine slice number, the second type of link also utilizes the single “ALL” bit which, as will be discussed below in greater detail, is used to indicate whether or not all of the records within the fine slice include the data value. The third type (compressed bit vector) is indicated by a one in both the first and second bit positions and contains a compressed bit vector representing the fine slices within the associated coarse slice. This compressed bit vector is created in the same manner as that of the fine link of FIG. 8 and this technique used to generate these compressed bit vectors will be described further below.

Examples of these two types of coarse links can be seen in FIG. 4. As shown therein, the value “orange” is found in records contained within fine slices 8, 20, and 3,000, all of which are within coarse slice 0. Thus, in FIG. 6A, key c:0:orange (coarse slice 0, orange) has associated with it a link that contains a pointer to a bit vector 48 in which bit positions 8, 20, and 3,000 are set to one and the others cleared to zero. As another example, while the value “green” is found in more than one record of the database of FIG. 4, it is only located in one record within coarse slice 0. Thus, key c:0:green of FIG. 6A includes a link that is not a pointer to a bit vector, but rather is the relative fine slice number (RFSN=0) of the fine slice that contains the record having “green” in the vehicle color field.

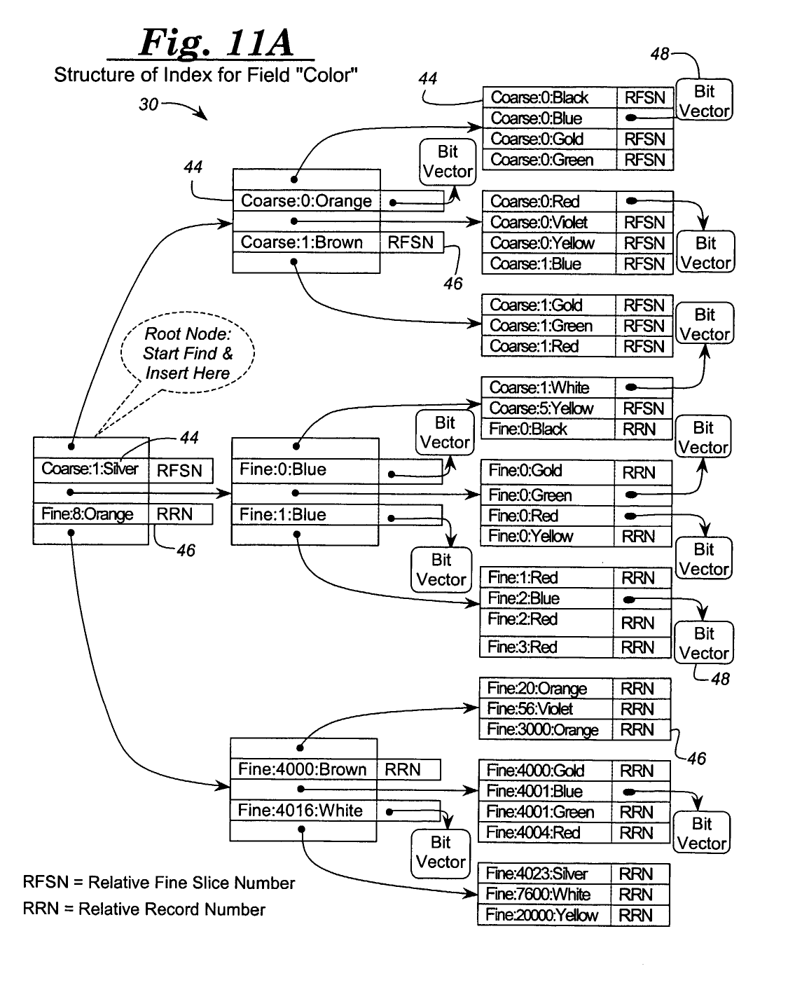

With reference to FIG. 10, it will be seen that, unlike the fine bit vectors 48, the coarse bit vector 48 is actually two different bit vectors concatenated together. The first of these two bit vectors includes what will be referred to as “ANY” bits, with the ANY bit vector 48a including a single ANY bit for each of the 4,000 fine slices contained within the coarse slice. An ANY bit is used to indicate whether any of the records contained within its associated fine slice has the data value in its associated field. If so, the ANY bit is set to one. Thus, an ANY bit will be zero only if none of the records within its associated fine slice contain the data value. The second of these two bit vectors includes what will be referred to as “ALL” bits, with the ALL bit vector 48b also including a single ALL bit for each of the 4,000 fine slices. An ALL bit is used to indicate that all of the records contained within its associated fine slice have the data value. If so, the ALL bit is set to one. If the data value is not included within even a single record within the fine slice, then the corresponding ALL bit is cleared to zero. As will be discussed below, the ALL bit is useful in processing queries involving the NOT operator.

As discussed above, where a particular data value does not exist in any of the records contained in a particular fine slice, no fine key is created. Thus, where an ANY bit in a coarse key is zero, no fine key is created for the fine slice associated with that ANY bit. Similarly, where a particular data value does not exist within any of the records contained in a particular coarse slice, no coarse key or fine keys are created for that coarse slice. Thus, in FIG. 6A, there is no coarse 0 key for “silver” because none of the first 32 million records contain silver in the vehicle color field. Rather, the only keys for silver are a coarse slice 1 key which has a link to its relative fine slice 23, and a fine slice 4023 key which has a link to its relative record number 0 (which is absolute record number 32,184,000), which as shown in FIG. 4 is the only record listing silver as the vehicle color.

Referring now to FIG. 11A, there is shown the actual structure of the “color” field index 30 of FIG. 6A. The index is stored as a B-tree with keys 44 stored not just at the leaves of the tree, but also at the root and intermediate nodes. This provides faster searching of the B-tree on average, since the search need not traverse all levels of the tree when searching for a key that happens to be located either at the root or an intermediate node. Also, when keys are deleted, the levels in the tree decrease faster than in traditional B-tree structures, since a sole key is never left at a terminal node, but is instead moved up to the next level node. Furthermore, the keys at the root and intermediate nodes are used to determine the search path through the tree. This saves storage space because the data stored at the root and intermediate nodes that is used to determine the search path through the tree is not duplicative of data stored at the leaves of the tree, as in traditional B-trees.

Compression of Bit Vectors

As mentioned above, the second type of link (relative record number) is useful for indexing fields that contain high cardinality data (vehicle identification numbers, socials security numbers). In the case of low or medium cardinality data, a lot of records will have the same data values, and thus a lot of bits will be turned on within a fine slice. In this case, the third type of link (compressed bit vector) can often be used within the link rather than both a pointer and a separate, almost 1 KB bit vector. When used, this compressed bit vector results in the same saving of large amounts of storage memory as the use of the single record number approach. The records for low or medium cardinality data can often be clustered together sequentially, with gaps between the clustered sequences. In a fine slice, this results in a bit vector with a relatively small number of alternating strings of 0 bits and strings of 1 bits, with each string being of arbitrary length. The compression method described below for compressing the bit vector has been designed to maximize the effective compression of this kind of data.

The method used to create a compressed bit vector is an adaptive method. It consists of multiple types of compression. These types of compression fall into two major categories, with multiple minor variations of each category forming sub-categories. Each type of compression is optimized for a particular set of conditions in the bit vector to be compressed. The compression process tries each of the applicable compression types until either the bit vector is successfully compressed into the allowed space; or all compression types fail. Thus, the compression process adapts to each instance of bit vector to be compressed. This adaptive process can be extended by adding additional compression types as required.

The compression type, consisting of the compression category and compression sub-category, is stored as part of the compressed bit vector. This allows the decompression process to properly and unambiguously decompress the compressed bit vector.

The first compression category is variable run-length encoding. This method compresses a bit vector by viewing the bit vector as a string of alternating runs of identical bit values (either 0 or 1); and encoding this string of runs as a string of run-length numbers. Since a single bit can have only two values, either 0 or 1, the encoded string of runs does not need to specify a bit value; it need only specify a run length. The bit value of the first run is specified by the compression sub-category; the bit value for each subsequent run simply alternates from the previous run. For example, the following bit vector:

0000 1111 1111 1111 1111 1111 1111 0000 0000 0000 0000 1100 0000

would be compressed and encoded as follows, where the bit value of the first run is 0:

(4) (24) (16) (2) (6)

If the total length of the uncompressed bit vector is known, as is the case in the present invention, there is no need to encode the last run. If there is space remaining for the last run in the compressed bit vector, it is encoded so that the decompression process can properly interpret the compressed bit vector. If there is not enough space for the last run in the compressed bit vector, it is not encoded. Since the remaining bits in the uncompressed bit vector must all have the alternate value from the previous run, the decompression process can simply calculate the number of uncompressed bits left and set them to the next alternate value. The optimal compressed and encoded bit vector thus becomes:

(4) (24) (16) (2)

Each encoded run-length field occupies a certain number of bits. In the simplest implementation, all run-length fields occupy the same number of bits, which is chosen as the minimum number of bits required to hold the longest run possible. The longest run possible is the size of the uncompressed bit vector, since the entire bit vector could contain the same bit value. For a given total uncompressed bit vector length tubl, this fixed run-length field frlf is calculated as follows:

frlf=floor(log₂ tubl)+1

where floor is the function returning the largest integer less than or equal to its argument. For the current example, the value of tubl is 52, and thus the value for frlf is calculated as 6. Since the compressed bit vector contains 4 runs, the compressed bit vector will require 4·6 or 24 bits.

This implementation can be improved by allowing the run-length fields to occupy a variable number of bits. Since the longest run possible decreases as the remaining uncompressed portion of the bit vector decreases, each successive run-length field need occupy only as many bits as are required to hold the longest remaining run possible. The longest remaining run possible is the size of the remaining uncompressed bit vector, since the entire remaining bit vector could contain the same bit value. For a given remaining uncompressed bit vector length rubl, this variable run-length field vrlf is calculated as follows:

vrlf=floor(log₂ rubl)+1

For the current example, this gives the following compressed encoded bit vector:

| | | | | |
|---|---|---|---|---|
| encoded runs: | (4) | (24) | (16) | (2) |
| remaining uncompressed length: | 52 | 48 | 24 | 8 |
| variable run length field size: | [6] | [6] | [5] | [4] |

Thus, the compressed bit vector will require 6+6+5+4 or 21 bits.

This method of using variable run-length field sizes can be further improved by taking advantage of the fact that a run length of 0 will never be encoded; the minimum possible run-length is 1. By biasing the encoded run-length by −1, this can in some cases reduce the size of the variable run-length field required. This biasing is accomplished by subtracting 1 from the run-length value before it is encoded during compression; and adding 1 to the run-length value after it is decoded during decompression. This allows the remaining uncompressed bit vector length to also be biased by −1 when calculating the variable run-length field size. Thus, for a given remaining uncompressed bit vector length rubl, this biased variable run-length field bvrlf is calculated as follows:

bvrlf=floor(log₂ (rubl-1))+1

For the current example, this gives the following compressed encoded bit vector:

| | | | | |
|---|---|---|---|---|
| biased encoded runs: | (3) | (23) | (15) | (1) |
| biased remaining uncompressed length: | 51 | 47 | 23 | 7 |
| biased variable run length field size: | [6] | [6] | [5] | [3] |

Thus, the compressed bit vector will require 6+6+5+3 or 20 bits.

The sub-category of the compressed bit vector indicates whether the bit vector starts with a 0 value bit or a 1 value bit. This is necessary because the biased run-length value does not allow for a zero length run. It also provides better compression, because there is no need to waste a run-length field specifying a length of zero bits. If the first run starts with the bit value 1, the encoding process is the same as if the first run started with the bit value 0. The only difference is that the first run-length value indicates the number of 1 value bits, and the bit value of the following runs alternate from there. For example, the following bit vector:

1111 0000 0000 0000 0000 0000 0000 1111 1111 1111 1111 0011 1111

would be compressed and encoded as follows:

| | | | | |
|---|---|---|---|---|
| biased encoded runs: | (3) | (23) | (15) | (1) |
| biased remaining uncompressed length: | 51 | 47 | 23 | 7 |
| biased variable run length field size: | [6] | [6] | [5] | [3] |

Thus, the compressed bit vector will require 6+6+5+3 or 20 bits. Note that the encoded runs for this compressed bit vector are identical to the encoded runs for the compressed bit vector of the prior example, which is actually a different bit vector. This is because the pattern of the alternating runs for the two bit vectors is the same, even though the bit values are reversed. However, because the compression type is stored as part of the compressed bit vector, the two compressed bit vectors are distinct. This allows the decompression process to decompress these two compressed bit vectors into their proper and correct original uncompressed bit vectors. The compression type for the prior example specifies that the uncompressed bit vector starts with a 0 bit value. The compression type for the current example specifies that the uncompressed bit vector starts with a 1 value.

In the case of the present invention, the total size available for the compressed bit vector is both known and fixed. Thus, in order to be compressible, an uncompressed bit vector must compress to a size less than or equal to the total size available for the compressed bit vector. For example, the following bit vector:

0101 0000 1111 0000 0000 0000 0000 0000 0000 0000 0000 0000 0000

would be compressed and encoded as follows:

| | | | | | | |
|---|---|---|---|---|---|---|
| biased encoded runs: | (0) | (0) | (0) | (0) | (3) | (3) |
| biased remaining uncompressed length: | 51 | 50 | 49 | 48 | 47 | 43 |
| biased variable run length field size: | [6] | [6] | [6] | [6] | [6] | [6] |

Thus, the compressed bit vector will require 6+6+6+6+6+6 or 36 bits. If the total available size for the compressed bit vector run-length encoding was 24 bits, this bit vector would be uncompressible. However, this bit vector consists of a large number of short runs at the most significant (left) end of the uncompressed bit vector, followed by a small number of long runs at the least significant (right) end of the bit vector. Because the compression process operates in the most significant (left) to least-significant (right) direction, the biased variable run length field size remains high. This method can be improved by implementing a reverse-direction compression process, and using the sub-category of the compressed bit vector to also indicate the direction of the run-length encoding process.

By starting at the least significant (right) end of the uncompressed bit vector, and building runs from right-to-left, the current bit vector would be compressed and encoded as follows:

| | | | | | | |
|---|---|---|---|---|---|---|
| biased encoded runs: | (39) | (3) | (3) | (0) | (0) | (0) |
| biased remaining uncompressed length: | 51 | 11 | 7 | 3 | 2 | 1 |
| biased variable run length field size: | [6] | [4] | [3] | [2] | [2] | [1] |

Thus, the compressed bit vector will require 6+4+3+2+2+1 or 18 bits. This will fit within the total available size for the compressed bit vector run-length encoding of 24 bits, making this bit vector compressible.

Thus, the compression category of variable run-length encoding contains the following compression types:

1) Variable Run-Length, from Most Significant Bit, first run is 0s

2) Variable Run-Length, from Most Significant Bit, first run is 1s

3) Variable Run-Length, from Least Significant Bit, first run is 0s

4) Variable Run-Length, from Least Significant Bit, first run is 1s

With the compression type of variable run-length encoding, from Most Significant Bit, first run is 0s the following bit vector:

0000 0000 0000 0000 0000 0001 0101 0100 0000 0000 0000 0000 0000

would be compressed and encoded as follows:

| | | | | | | | | |
|---|---|---|---|---|---|---|---|---|
| biased encoded runs: | (22) | (0) | (0) | (0) | (0) | (0) | (0) | (0) |
| biased remaining uncompressed | 51 | 28 | 27 | 26 | 25 | 24 | 23 | 22 |
| length: | | | | | | | | |
| biased variable run length | [6] | [5] | [5] | [5] | [5] | [5] | [5] | [5] |
| field size: | | | | | | | | |

Thus, the compressed bit vector will require 6+5+5+5+5+5+5+5 or 41 bits. If the total available size for the compressed bit vector run-length encoding was 24 bits, this bit vector would be uncompressible. In this case, the compression type of variable run-length encoding, from Least Significant Bit, first run is 0s does not provide any improvement. However, this bit vector consists of a large number of short runs closely packed together in the middle of the uncompressed bit vector. Because the short runs are located in the middle of the bit vector, the biased variable run length field size remains high. This method can be improved by another compression category which encodes this string of short runs as a literal, instead of as a series of runs.

The second compression category is two runs with literal encoding. This method compresses a bit vector by viewing the bit vector as a literal string of arbitrary bit values (both 0 and 1) surrounded on both ends by a string of identical bit values (either 0 or 1); and encoding these three strings as a run-length number followed by a literal string of bits followed by a run-length number. Since a single bit can have only two values, either 0 or 1, the encoded runs of identical bits surrounding the literal string do not need to specify a bit value; they need only specify a run length. The bit value of the first run and the bit value of the last run is specified by the compression sub-category. For example, the following bit vector:

0000 0000 0000 0000 0000 0001 0101 0100 0000 0000 0000 0000 0000

would be compressed and encoded as follows, where the bit value of the both the first run and the last run is 0:

(23) 1010 101 (22)

If the total length of the uncompressed bit vector is known, as is the case in the present invention, there is no need to encode the last run. If there is space remaining after the literal string in the compressed bit vector, the literal string is extended to fill the remaining space, setting each filled-in bit to the bit value of the last run. Since the remaining bits after the literal string in the uncompressed bit vector must all have the last run value specified by the compression sub-category, the decompression process can simply calculate the number of uncompressed bits left and set them to the compression sub-category value. The optimal compressed and encoded bit vector thus becomes:

(23) 1010 1010 0000 00. . .

The first encoded run-length field occupies a certain number of bits. This is chosen as the minimum number of bits required to hold the longest run possible. The longest run possible is the maximum distance from the end of the bit vector to the start of the literal string. If the compression method can start from either end of the uncompressed bit vector, the maximum distance from the end of the bit vector to the start of the literal string is equal to one-half the size of the uncompressed bit vector. If the literal string starts more than halfway from the most significant (left) end of the uncompressed bit vector, it will start less than halfway from the least significant (right) end of the uncompressed bit vector. The sub-category of the compressed bit vector can be used to also indicate the direction of the run-length encoding process (the end from which to start compressing). For a given total uncompressed bit vector length tubl, the fixed run-length field frlf is calculated as follows:

frlf=floor(log₂ (tubl/2)+1

For the current example, the value of tubl is 52, and thus the value for frlf is calculated as 5. If the total available size for the compressed bit vector two runs with literal encoding was 24 bits, this would allow 19 bits for the literal string.

This method of compression can be further improved by taking advantage of the fact that a run length of 0 will never be encoded; the minimum possible run-length is 1. By biasing the encoded run-length by −1, this can in some cases reduce the size of the fixed run-length field required. This biasing is accomplished by subtracting 1 from the run-length value before it is encoded during compression; and adding 1 to the run-length value after it is decoded during decompression. Thus, for a given total uncompressed bit vector length tubl, the biased fixed run-length field bfrlf is calculated as follows:

bfrlf=floor(log₂ ((tubl-1)/2))+1

For the current example, the value of tubl is 52, and thus the value for bfrlf is calculated as 5. If the total available size for the compressed bit vector two runs with literal encoding was 24 bits, this would allow 19 bits for the literal string. For this example, this would give the following compressed encoded bit vector:

(22) 1010 1010 0000 0000 000

Thus, for certain patterns of data, the two runs with literal encoding compression category allows for successful compression where the variable run-length encoding compression category fails.

The compression category of two runs with literal encoding contains the following compression types:

5) Two Runs w/ Literal, from Most Significant Bit, first run is 0s, last run is 0s

6) Two Runs w/ Literal, from Most Significant Bit, first run is 0s, last run is 1s

7) Two Runs w/ Literal, from Most Significant Bit, first run is 1s, last run is 0s

8) Two Runs w/ Literal, from Most Significant Bit, first run is 1s, last run is 1s

9) Two Runs w/ Literal, from Least Significant Bit, first run is 0s, last run is 0s

10) Two Runs w/ Literal, from Least Significant Bit, first run is 0s, last run is 1s

11) Two Runs w/ Literal, from Least Significant Bit, first run is 1s, last run is 0s

12) Two Runs w/ Literal, from Least Significant Bit, first run is 1s, last run is 1s

The present embodiment performs optimization of the fine link in the following manner:

If the fine slice contains only a single record, the link is formatted as a single record link, with the relative record number (RRN) contained within the link;

otherwise, if the fine slice bit vector can be compressed to fit within the link, the link is formatted as a compressed bit vector, with the compressed bit vector stored within the link;

otherwise, the link is formatted as a pointer to a bit vector, with the bit vector stored external to the link.

For the coarse links, the ANY and ALL bit vectors of FIG. 10 are treated as a single bit vector for the purpose of compression.

The advantage of using compressed bit vectors is shown in FIGS. 6B and 11B. As shown in FIG. 6B, the compression permits the bit vectors to be stored in the link, rather than needing a pointer to a separate bit vector. When compression is used, the link includes both the compressed bit vector plus a four-bit compression type (CT) data value indicating which of the twelve compression schemes disclosed above are used. For example, for the blue coarse slice 0 key, the compression type is 2 (since the uncompressed bit vector begins with a one bit) and, using the biased, variable run length encoding described above, the compressed bit vector can be stored as a single biased encoded run of (2). For the orange coarse slice 0 key, the first compression type (CT=1) results in a compressed bit vector of 78 bits, too big to fit into the available 56 bits in the link. However, compression type 3 compresses the bit vector to only 51 bits which fits. Therefore, the resulting biased encoded run is (4998)(0)(2978)(0)(1 0)(0).

Query Processing Using the Indexes

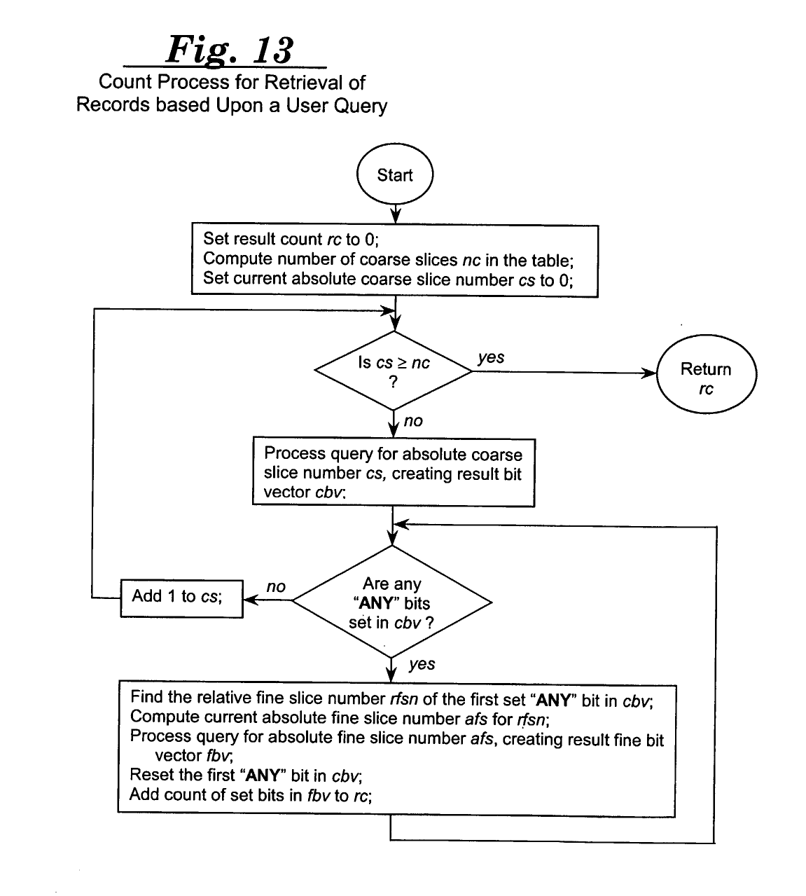

Referring now to FIG. 12, there is shown a computer system 50 for use in implementing the database, index structure, and query processing shown in the previous figures. Computer system 50 includes a computer 52 having a microprocessor 54, RAM 56, a hard disk 58, a keyboard 60, and monitor 62. Computer 52 can be any of a number of commercially-available personal computers running an operating system such as WindowsNT®, with microprocessor 54 comprising an Intel® Pentium® II or equivalent processor. Database 20 is stored as a single file on a computer-readable memory such as a hard drive 58. Similarly, each of the indexes are stored on hard drive 58 as a separate file. Hard drive 58 can comprise a fixed magnetic disk or other non-volatile data storage. Depending upon the size of database 20, the non-volatile data storage device may comprise a number of hard drives 58a-n, such as in a RAID array, with the database spanning two or more of these hard drives. As mentioned above, the database management program 64 is used to setup and maintain the database 20 and its indexes, as well as to perform query processing and associated retrieval of records using the indexes. As with database 20, database management program 64 is also stored in computer-readable format on hard drive 58. As will be appreciated, computer 52 can be a server attached via a network interface card (not shown) to a network, whether it be a local area network or a global computer network such as the Internet.

Query processing is implemented by computer 52 by way of microprocessor 54 executing instructions from database management program 64. Program 64 locates the one or more records that satisfies a particular user query by creating a target keys (e.g., c:0:blue) for each coarse and fine slice and then searches the appropriate index for those target keys, starting with the lowest key valued key (i.e., coarse slice 0). If no key is found, a bit vector of all zeros is returned. If a matching key is found in the index, then the associated link is used to obtain a bit vector for that key. If the link is of type 0, as shown in FIGS. 8 and 9, then the bit vector identified by the link is returned. Where one or both of the keys' links are of type 1; that is, they contain a relative fine slice number (in the case of a coarse key) or a relative record number (in the case of a fine key) rather than a pointer to a bit vector, then a bit vector is created and, for a fine bit vector, the bit corresponding to the record identified by the link is set to one and the remaining bits of the vector being cleared to zero. When creating a coarse bit vector (which includes both ANY bits and ALL bits), the ANY bit corresponding to the fine slice number identified by the link is set to one, with the remaining ANY bits being cleared to zero, and the ALL bit corresponding to the fine slice number identified by the link is set to the same value (0 or 1) as the ALL bit contained in the link, with the other ALL bits being cleared to zero. In this way, query processing can always be carried out using bit vectors, regardless of which type of link is stored in the index.

In the case of simple queries, such as MAKE=Chevrolet, once a coarse bit vector has been obtained, it can be used to determine which fine slices contain records satisfying that query. The keys for those fine slices (e.g., f:0:Chevrolet) can then be accessed, in order of their key value, and their associated bit vectors obtained. As records containing the data value are identified, they are retrieved for processing.

For boolean operations, such as would be required for a query of MODEL=Corvette and YEAR=1975, corresponding bit vectors for each of the keyword search terms are obtained in the manner described above, and then are logically combined in accordance with the boolean logic (AND) specified in the user's query. The following operators are used to perform boolean operations on the bit vectors:

AND_BV

This is a binary operator, taking two bit vector parameters, and returning a single bit vector result. All bits of the two bit vectors are logically AND-ed together, yielding a single result bit vector. The operation is identical for coarse and fine bit vectors.

OR_BV

This is a binary operator, taking two bit vector parameters, and returning a single bit vector result. All bits of the two bit vectors are logically OR-ed together, yielding a single result bit vector. The operation is identical for coarse and fine bit vectors.

NOT_BV

This is a unary operator, taking one bit vector parameter, and returning a single bit vector result. All bits of the one bit vector are logically NOT-ed (complemented), yielding a single result bit vector. The operation is different for coarse and fine bit vectors. For fine bit vectors, all bits are simply NOT-ed in place. For coarse bit vectors, the ANY and ALL bits are NOT-ed and then the ANY and ALL bit vectors are swapped; that is, the ALL bit vector is moved to the left portion of the coarse bit vector as shown in FIG. 10 and thereby becomes the ANY bit vector for the NOT-ed coarse bit vector. Similarly, the ANY bit vector is moved to right portion of the coarse bit vector so that it becomes the ALL bit vector of the NOT-ed coarse bit vector.

The following are basic “find” operators that are used in searching through an index to obtain a bit vector for specified target keys or key ranges.

FIND_EQUAL_BV

This operator searches an index to find the key that matches the specified target key, which is a parameter to this operator. There will be at most one entry in the B-tree matching the target key. If the target key doesn't exist, a bit vector of all zero bits is created and returned. At the end of this operator, a current path structure is created pointing to the location in the B-tree where the target entry was found, or where it would have been found if it had existed, and the target key is saved for use by the FIND_NEXT_BV operator discussed below.

FIND_NEXT_BV

This operator searches an index to find the next key whose field Slice Type and Absolute Slice Number values (see FIG. 7) match the target key's field Slice Type and Absolute Slice Number values. Thus, the key data value portion of the key is ignored. The target key is the target key saved by the last previous FIND_EQUAL_BV operator. There can be any number of entries in the B-tree matching the target key. If the next target key does not exist, a special completed result value is returned to indicate that no more entries exist matching the target key. The search starts from the current path created by the last previous FIND_EQUAL_BV operator, or updated by the last previous FIND_NEXT_BV operator. At the end of this operator, the current path structure is updated to point to the location in the B-tree where the next target key was found.

The following are relational “find” operators that are used to search through an index. Each execution of one of these operators finds one or more target keys in an index, and returns the bit vector, either coarse or fine, associated with the target keys. If multiple keys are found, their associated bit vectors are logically OR-ed together to form a single result bit vector. This single result bit vector is an accumulation of all the keys found in the search. Each operator executes on a single Slice Type value and Absolute Slice Number value. Depending on the operator, it executes on one or more Key Data Values. These operators are executed multiple times to operate on more than one Slice Type or Absolute Slice Number.

FIND_LSS_SLICE

This operator searches an index to find all entries whose Key Data Value (see FIG. 7) is less than the specified target key, which is a parameter to this operator. It operates as follows. A FIND_EQUAL_BV operator is executed on the target key, generating an initial FIND_LSS_SLICE result bit vector. The FIND_NEXT_BV operator is executed continuously until it returns a completed result. Each execution result bit vector is logically OR-ed with the OR_BV operator into the FIND_LSS_SLICE result bit vector. The FIND_LSS_SLICE result bit vector is logically NOT-ed with the NOT_BV operator. The FIND_LSS_SLICE result bit vector is returned as the operator result.

FIND_LEQ_SLICE

This operator searches an index to find all entries whose Key Data Value is less than or equal to the specified target key, which is a parameter to this operator. It operates as follows. A FIND_EQUAL_BV operator is executed on the target key. The initial FIND_LEQ_SLICE result bit vector is set to all zero bits. The FIND_NEXT_BV operator is executed continuously until it returns a completed result. Each execution result bit vector is logically OR-ed with the OR_BV operator into the FIND_LEQ_SLICE result bit vector. The FIND_LEQ_SLICE result bit vector is logically NOT-ed with the NOT_BV operator. The FIND_LEQ_SLICE result bit vector is returned as the operator result.

FIND_EQL_SLICE

This operator searches an index to find all entries whose Key Data Value is equal to the specified target key, which is a parameter to this operator. It operates as follows. A FIND_EQUAL_BV operator is executed on the target key, generating a FIND_EQL_SLICE result bit vector. The FIND_EQL_SLICE result bit vector is returned as the operator result. ps FIND_PEQL_SLICE

This operator searches an index to find all entries whose Key Data Value is partially equal to the specified target key, which is a parameter to this operator. Partially equal means that the entry Key Data Value matches the specified target key for the length of the target key's Key Data Value (the target key is a partial Key Data Value). It operates as follows. A FIND_EQUAL_BV operator is executed on the target key, generating an initial FIND_PEQL_SLICE result bit vector. The FIND_NEXT_BV operator is executed continuously until it returns a completed result, or the next key's Key Data Value is greater than the target Key Data Value. Each execution result bit vector is logically OR-ed with the OR_BV operator into the FIND_PEQL_SLICE result bit vector. The FIND_PEQL_SLICE result bit vector is returned as the operator result.

FIND_NEQ_SLICE

This operator searches an index to find all entries whose Key Data Value is not equal to the specified target key, which is a parameter to this operator. It operates as follows. A FIND_EQUAL_BV operator is executed on the target key, generating an initial FIND_NEQ_SLICE result bit vector. The FIND_NEQ_SLICE result bit vector is logically NOT-ed with the NOT_BV operator. The FIND_NEQ_SLICE result bit vector is returned as the operator result.

FIND_GEQ_SLICE

This operator searches an index to find all entries whose Key Data Value is greater than or equal to the specified target key, which is a parameter to this operator. It operates as follows. A FIND_EQUAL_BV operator is executed on the target key, generating an initial FIND_GEQ_SLICE result bit vector. The FIND_NEXT_BV operator is executed continuously until it returns a completed result. Each execution result bit vector is logically OR-ed with the OR_BV operator into the FIND_GEQ_SLICE result bit vector. The FIND_GEQ_SLICE result bit vector is returned as the operator result.

FIND_GTR_SLICE

This operator searches an index to find all entries whose Key Data Value is greater than the specified target key, which is a parameter to this operator. It operates as follows. A FIND_EQUAL_BV operator is executed on the target key. The initial FIND_GTR_SLICE result bit vector is set to all zero bits. The FIND_NEXT_BV operator is executed continuously until it returns a completed result. Each execution result bit vector is logically OR-ed with the OR_BV operator into the FIND_GTR_SLICE result bit vector. The FIND_GTR_SLICE result bit vector is returned as the operator result.

FIND_RANGE_SLICE

This operator searches an index to find all entries whose Key Data Value is greater than or equal to the specified minimum target key, and less than or equal to the specified maximum target key, which are parameters to this operator. It operates as follows. A FIND_EQUAL_BV operator is executed on the minimum target key, generating an initial FIND_RANGE_SLICE result bit vector. The FIND_NEXT_BV operator is executed continuously until it returns a completed result, or the next Key Data Value is greater than the maximum target key's Key Data Value. Each execution result bit vector is logically OR-ed with the OR_BV operator into the FIND_RANGE_SLICE result bit vector. The FIND_RANGE_SLICE result bit vector is returned as the operator result.

FIND_RANGE_X_SLICE

This operator searches an index to find all entries whose Key Data Value is greater than the specified minimum target key, and less than the specified maximum target key, which are parameters to this operator. It is similar to the FIND_RANGE_SLICE operator defined above, except the range is exclusive of both (minimum and maximum) endpoint values, rather than inclusive. It operates as follows. A FIND_EQUAL_BV operator is executed on the minimum target key. The initial FIND_RANGE_X_SLICE result bit vector is set to all zero bits. The FIND_NEXT_BV operator is executed continuously until it returns a completed result, or the next Key Data Value is greater than or equal to the maximum target key's Key Data Value. Each execution result bit vector is logically OR-ed with the OR_BV operator into the FIND_RANGE_X_SLICE result bit vector. The FIND_RANGE_X_SLICE result bit vector is returned as the operator result.

FIND_RANGE_LX_SLICE

This operator searches an index to find all entries whose Key Data Value is greater than the specified minimum target key, and less than or equal to the specified maximum target key, which are parameters to this operator. It is similar to the FIND_RANGE_SLICE operator defined above, except the range is exclusive of the left (minimum) endpoint value, rather than inclusive. It operates as follows. A FIND_EQUAL_BV operator is executed on the minimum target key. The initial FIND_RANGE_LX_SLICE result bit vector is set to all zero bits. The FIND_NEXT_BV operator is executed continuously until it returns a completed result, or the next Key Data Value is greater than the maximum target key's Key Data Value. Each execution result bit vector is logically OR-ed with the OR_BV operator into the FIND_RANGE_LX_SLICE result bit vector. The FIND_RANGE_LX_SLICE result bit vector is returned as the operator result.

FIND_RANGE_RX_SLICE

This operator searches an index to find all entries whose Key Data Value is greater than or equal to the specified minimum target key, and less than the specified maximum target key, which are parameters to this operator. It is similar to the FIND_RANGE_SLICE operator defined above, except the range is exclusive of the right (maximum) endpoint value, rather than inclusive. It operates as follows. A FIND_EQUAL_BV operator is executed on the minimum target key, generating an initial FIND_RANGE_RX_SLICE result bit vector. The FIND_NEXT_BV operator is executed continuously until it returns a completed result, or the next Key Data Value is greater than or equal to the maximum target key's Key Data Value. Each execution result bit vector is logically OR-ed with the OR_BV operator into the FIND_RANGE_RX_SLICE result bit vector. The FIND_RANGE_RX_SLICE result bit vector is returned as the operator result.

Retrieval of Records

As a result of the query process, a list of absolute record numbers is generated, with the list representing a subset of all of the records contained in the database. The records are listed in record number order as an inherent result of the index structure and query processing techniques described above. The retrieval operation is used to select and retrieve from database 20 the list of records generated as a result of the query processing. The retrieval operation described is designed to provide very fast retrieval response.

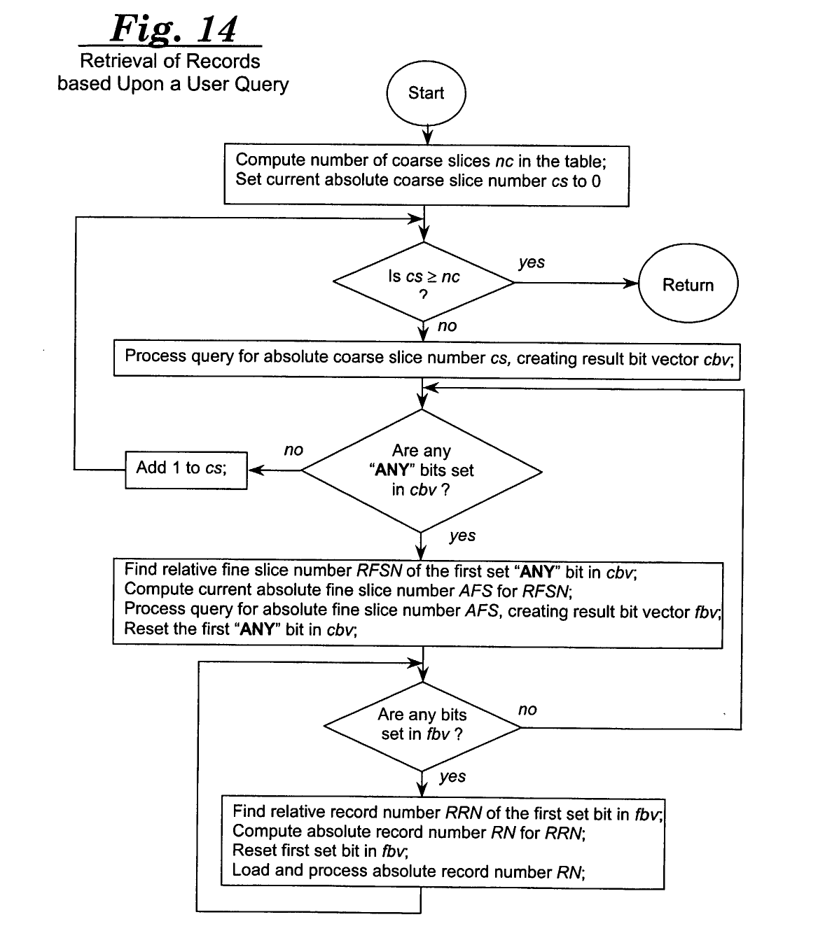

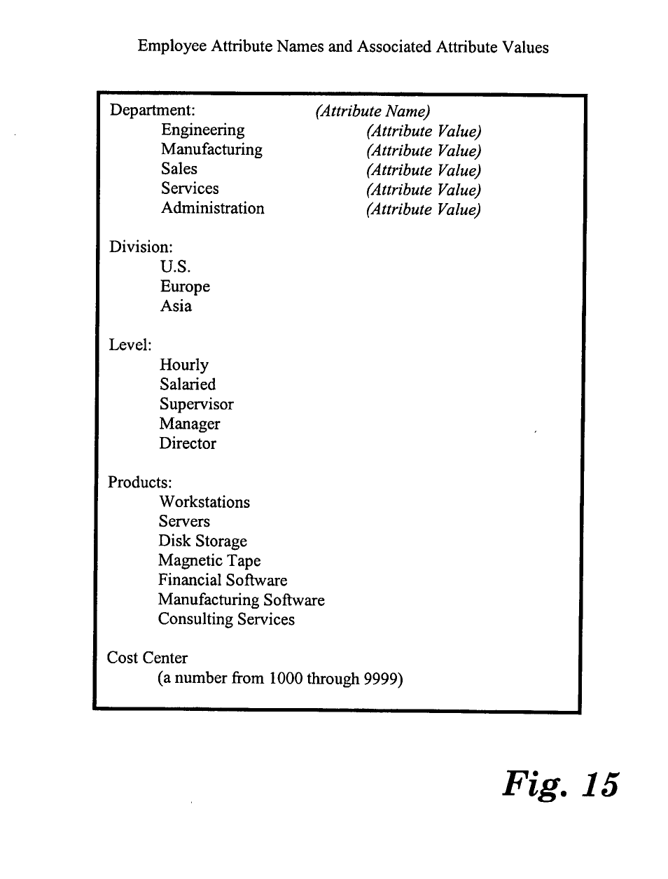

In the preferred embodiment, there are two types of retrieval operations: COUNT and FIND. A COUNT retrieval simply counts the selected subset of records. Since the records themselves don't need to be retrieved, this operation is extremely fast. The retrieval operation to select and COUNT a subset of records from a database is shown in FIG. 13. A FIND retrieval retrieves each of the records in the subset. The retrieval operation to select and FIND a subset of records from a database is shown in FIG. 14. Since the selection operation rapidly identifies the selected records, the retrieval time is in general proportional to the number of records selected, not the number of records in the data record table.

A unique aspect of the retrieval operation is that it operates by examining the indexes in record number order first, and then field value order, rather than field value order first, and then record number order. One reason this is possible is that, as shown in FIG. 11, the index B-tree is organized and ordered for efficient index-sequential operation in this search order. A given slice and data value combination can be efficiently located in the index B-tree. This is accomplished using normal B-tree search methods, starting at the top of the tree, and utilizing a binary search in each tree node, until the target index entry is found. Since all of the field values for the given slice are stored in sequential entries in the B-tree immediately preceding and following the target key, they may be retrieved easily and extremely quickly. A second reason this is possible is the combination of coarse and fine bit vectors. As a result of this combination, a single coarse bit vector represents 32,000,000 records. This means that by processing a single coarse slice for the retrieval criteria, 32,000,000 records have been processed, and the fine slices of interest in the current coarse slice have been identified. From there only the fine slices of interest are directly accessed and processed 8,000 records at a time. Then only the individual records of interest are counted or retrieved. A third reason this is possible is the ability to logically NOT a bit vector rapidly. For example, the NOT EQUAL criteria is implemented by finding the bit vector EQUAL to the criteria, and NOT-ing this bit vector. This is much faster than finding all the bit vectors NOT EQUAL to the criteria. The special capability of a coarse bit vector to contain both “ANY” and “ALL” bit vectors allows the NOT operation to work as effectively on coarse bit vectors as on fine bit vectors. Yet a fourth reason this is possible is the ability to rapidly evaluate a LESS THAN, LESS THAN OR EQUAL, GREATER THAN, GREATER THAN OR EQUAL, or RANGE criteria by simply OR-ing together bit vectors stored sequentially in the index. Since each coarse bit vector represents 32,000,000 records, it is much faster to enumerate the Key Data Values within a slice this way, than to find the Key Data Values first, and then enumerate the record numbers. Thus, the retrieval criteria is quickly processed in record number order 32,000,000 records at a time. Even with a record count of 1 billion records, only 32 coarse slices would need to be examined.

During execution of the criteria code, the validity index (see FIG. 2) may be used by the retrieval operation. The validity index is a standard index with a one bit for every in-use data record, and a zero bit for every deleted data record. If a NOT_BV operator is executed at any time in the criteria code, a flag is set specifying that the validity index is needed. This flag is needed because a zero bit in a bit vector represents deleted data records as well as data records not matching the current criteria. If this flag is set at the end of execution of the query processing, the validity index bit vector for the current coarse or fine slice is AND-ed in to the current result bit vector with the AND_BV operator. This eliminates deleted records which were introduced by the NOT_BV operator from the final result bit vector.

The database should be locked against update during certain portions of the retrieval operation. The retrieval operation is optimized to reduce the number of times and duration of this locking. The database is locked with a shared-lock (reader lock) only during execution of the query process. This allows any number of other retrieval operations on the table to proceed concurrently, while temporarily locking out update operations. The database is locked at the beginning of the query processing, and unlocked at the end of the query processing. Since the query is executed a slice at a time (via the bit vector mechanism), a single lock-unlock cycle covers query processing for 32,000,000 records for coarse slices, and 8,000 records for fine slices. The design of the index makes criteria code execution very simple and quick. In this way, the number of lock-unlock cycles is minimized, and the duration of the time the database is locked against update is minimized.

The database is unlocked during the loading and processing of retrieved data records. This creates the possibility of a data record being modified between the time the query is executed, and the time the data record is loaded. This means that the actual data record loaded could no longer match the retrieval criteria. This problem is avoided by assigning a unique update transaction number to each data record update. This update transaction number is stored in the data record itself. The then-current update transaction number is captured and stored by the retrieval operation during the execution of the query. When a data record is loaded during a retrieval operation, its update transaction number is compared against the query's update transaction number. If the data record update transaction number is higher, it means the data record has been updated since the execution of the query, and may no longer match the retrieval criteria.

When this condition is detected, the updated data record is not processed. Instead, the retrieval operation is interrupted, and restarted at the current coarse and fine slices. The query is re-executed for the current coarse slice and then for the current fine slice. Processing of the current fine slice is then restarted at the bit represented by the record number which was being loaded and processed at the time of the interruption. This insures that the data record is consistent with the newly executed query, and processing resumes (unless the data record has been updated again, in which case the interruption/restart will be repeated). Thus, the retrieval operation can evaluate retrieval criteria for large numbers of records at a time, with minimal locking, while providing consistency of results. The method of retrieval operation processing in record number order provides the ability of interrupting and restarting retrieval at any record number location simply and effectively.

Although retrieval operations operate a slice at a time for speed and efficiency, this does not mean that a FIND retrieval operation has to process all of the records meeting the retrieval criteria. A FIND retrieval operation can be terminated whenever a data record is loaded and processed. For example, an application may decide that it should process only 100 data records at a time. The FIND retrieval operation would count the data records as they were loaded and processed, and stop the FIND retrieval operation when that count reached 100. Because retrieval operations process in record number order, this is very easy to implement and very efficient. In addition, a subsequent FIND retrieval operation can simply start with the next record after the last record previously loaded and processed, by starting with the coarse and fine slice containing that next record number.

Data Indexing Without Records

In the discussion above, it was shown how indexes and bit vectors could be used to index data that is stored within records. The example of automobile records for an automobile database was used for this purpose. This approach to using indexes and bit vectors can be generally abstracted and this will be done using the example of employees and employee attributes. Generally, if there are several employees in an organization a user would want to be able to go a list of employees and select sets or sub-sets of employees based on attributes. For example, finding all of the employees who belong to a given department, or all those employees that are manager level, or all the employees that work on a given product or some combination. For a more complex example, finding all the employees who are in engineering and a supervisor or higher level and work on just storage products, and the kind of queries previously addressed exactly maps into the developed database architecture. The difference, however, is that the records do not exist. Previously, a record for each automobile with information concerning that automobile can have associated indexes to find associated information. In the case of abstraction, for the example of employees, the database of employee information does not have to exist. The employee information is a separate set of data and the indexing approach described below provides the ability to abstract it and build a list of employees that have attributes names and values, without needing to have and maintainbut we don't really need to ever have data records.

For example, a human resources department wants to keep a skills database to find employees so that when they need to find people to work on certain projects they can. Or to route information to recipients, in a company its very common to be sending information out to employees which could be reports coming out of the computer systems, financial reports, production and sales reports. The right report has to be sent to the right person, so the attributes of the employees can be used to build queries that find the people. For instance, the financial people need to receive the financial reports. For these applications, however, lists are created, but the actual employee record is not necessary. This example is actually a one way implemented distribution list, but it is a more efficient way to implement distribution lists than just keeping a list of employees.

For another example, assume there were 100 different reports that had to be distributed to 100 different groups of employees in a company. If a simple distribution list is used, then there would be 100 reports each with various employees on them every time an employee changed or moved from one division or one level or one product or one department to another—all 100 lists would have to accessed to update them. However, by using the attribute method described herein, all that is needed to do is go to that one employee and change his attributes. If he switched departments, his department attribute can be changed; if he switched products, the product attribute is changed and it would automatically be reflected in all of the 100 distribution lists because those distribution lists are queried against the attribute database.

The following is an example of how to use this with employee attributes and then this concept will be generalized further. In the explanation that follows, the employee application is provided as an example, but really this can be used to maintain an attribute value database for any kind of structure for any kind of data.

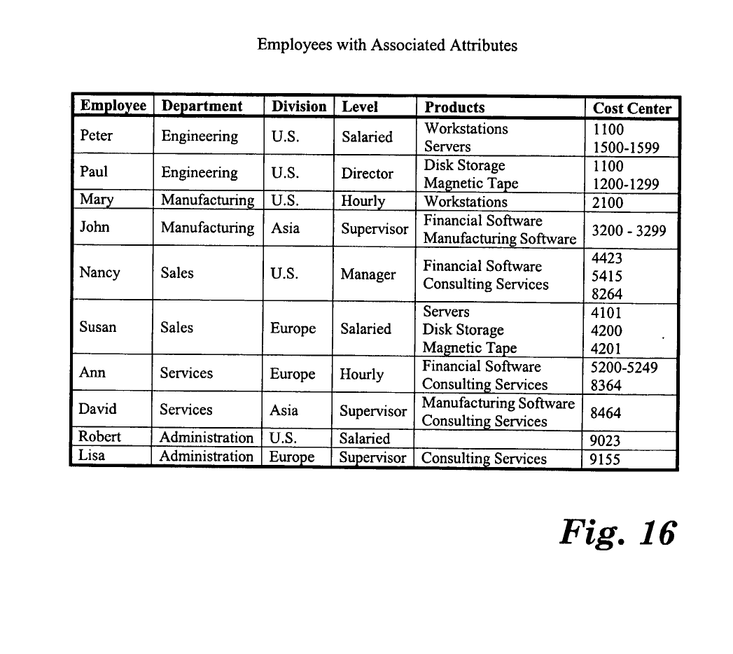

FIG. 15 shows for the purposes of illustrating the preferred embodiment, a list of employee attribute names and associated attribute values. In this table, department, for example, is an attribute name with example attribute values: engineering, manufacturing, sales, services, and administration. Division is another attribute name and has the values U.S., Europe and Asia and so forth. Level is an attribute name that indicates employee level, with the sample attribute values of hourly, salaried, supervisor, manager and director. Products is yet another sample attribute name, with attribute values of workstations, servers, disk storage, magnetic tape, financial software, manufacturing software and consultant services. Cost center designates which cost center the employee belongs to, with range of attribute values from 1000 to 9999. All of the attribute values may not apply to all attribute names, but on some attribute names it is possible that a given employee could have more than one attribute value. For example, in the products attribute name, a given employee could work with financial software and manufacturing software or with workstations and servers and disk storage.

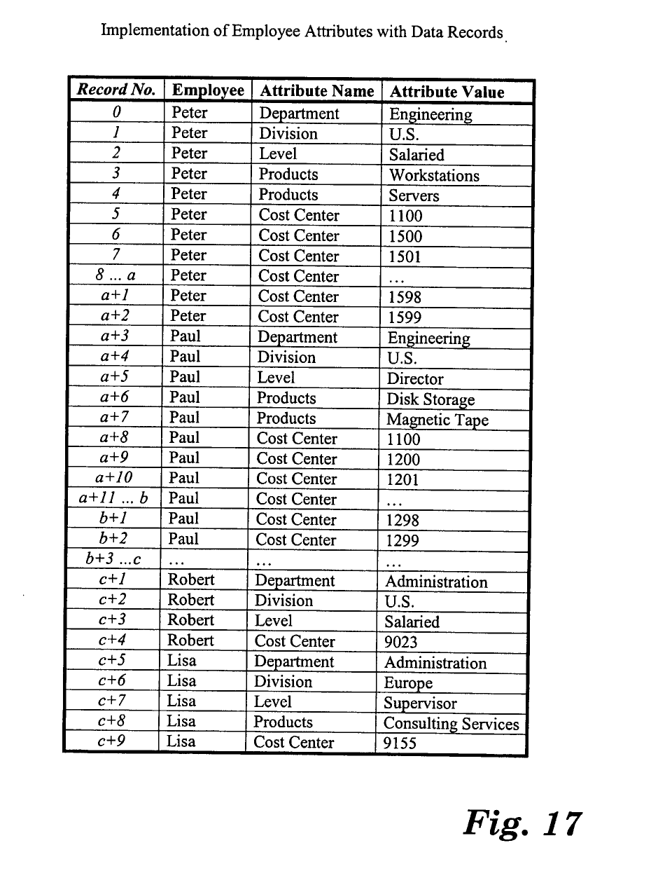

FIG. 16 illustrates an example set of data including a set of 10 sample employees, each of which is assigned a department, a division, a level, various products (an employee can have multiple products or no products that they are associated with), and the costs centers. The employee can have one or more cost centers or a range of cost centers.

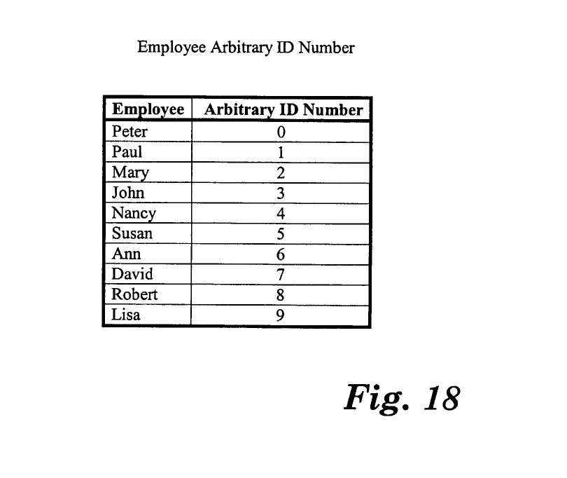

FIG. 17 shows a conventional way to implement this employee attribute data, specifically implementing it with data records. In the example illustrated in FIG. 17, we've got a table called Employee Attributes and each single record in that table indicates an employee name, an attribute name, and an attribute value. So in a single record one attribute value for one attribute name is associated with one employee. So if with reference to this example, Employee Peter is in record number 0, and his department attribute is engineering. As illustrated, this actually is a table that has three fields. A field called employee name or employee, a field call attribute name, and a field called attribute value. So record 0 has been created with employee Peter, attribute name Department and attribute value Engineering. Another record called record number 1 with employee Peter, attribute name Division, and Value U.S., etc. Looking at records 3 and 4, specifically products, this employee has two products (two values) for the attribute name products so that takes two records, record number 3 is employee name Peter, attribute name Products and attribute value Work Stations. Likewise record number 4 is employee name Peter, attribute name of Products, and attribute value Servers. This employee Peter has a large number of costs centers. He has cost center 1100 and then also cost centers 1500 through 1599 so a record for each one of them will have to be made. At record number 5 is the cost center attribute name and the attribute value is 1100, and then at record number 6 for the attribute name cost center the attribute value is 1500, the next record is 1501 and then with the ellipses there are all the values in between records 8 through a and then for a+1 the cost center attribute value is 1598, and the next record is 1599, and then move on to the next employee Paul.

There are so many records per employee to provide the flexibility that is required in this example—there could be thousands of permutations to complicate things even more, requiring the need to add attributes at any time. A given attribute name could have any number of attribute values, so it would be best to not define one employee record with a given number of attribute names and attribute values; instead the need exists to make a relational table like this where for each attribute name, attribute value, and employee name there is a separate record.

There are two problems with the example illustrated in FIG. 17, that require solving. The first problem is the amount of data and the time to create it. In this conventional approach, for every employee and their set of attributes a lot of records are created. Each of these records takes space and it also takes time to create it and delete it. The second problem is not as apparent. If this table is designed and implemented the way described earlier in the patent, each one of the columns (employee, attribute name and attribute value) would be a field in the record and they would be a key field, they would be indexed with an index by employee, an index by attribute name, and an index by attribute value. This would provide the kind of processing needed to find all employees who are in the U.S. division, for example. One could then search with the method described above using the fields saying find it where the attribute name field is equal to division and the attribute value field is equal to the U.S. and that would execute very quickly and that would give in this case record number 1 for division U.S., it would give record number a+4 for division U.S., and it would give record c+2 for division U.S. The record numbers would have to be retrieved to find out that record number 1 is employee Peter, record number a+4 is employee Paul and record number c+2 is employee Robert.

However, this approach falls apart or fails when we try to do a combination to find everybody who is either in the division U.S. or is a director. In this example, searching for division U.S. would uncover record 1; searching for the level of director would uncover record a+4 for level director, also record a+5 would return, and the problem is that there is no way to indicate that record a+4 is the same person as record a+5 because different record numbers have been retrieved. Reviewing the way it works, when AND and OR and NOT are all used, it assumed that the results included the same record number for the same value. So in this case, if it was desirable to find everybody who was in the division U.S. and was a director that would fail. For division U.S. record number 1 is returned, and next record a+4. Then for level director record a+5 is returned, but those would be different bits; a+4 and a+5 are different bits. When those are AND-ed together, a zero bit would be returned, and the result is that nobody is both division U.S. and is a director where it is very obvious here that Paul is both in the U.S. division and his level is a director.

Since each attribute name/value pair for a given employee or given entity is stored in a separate record, then the normal retrieval operations using the above-described bit vector mechanism cannot resolve that. One way to do this, which is the way the traditional database would do, is to: (1) execute the queries, (2) come up with a list of record numbers, (3) go through those record numbers, and (4) see if they relate to the same person.

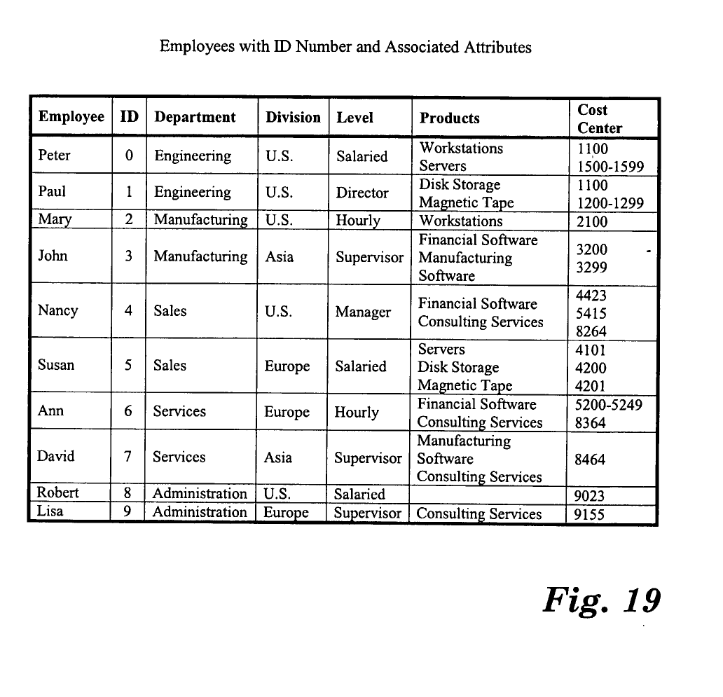

To overcome these difficulties, an arbitrary index can be generated using the indexing approach described in conjunction with FIGS. 1-14, except without the use of data records. Thus, the index is the database itself. The index is referred to as arbitrary index because it uses arbitrary ID numbers; that is, they are arbitrary in that they are not related to the attribute data that they are indexing. FIG. 18 shows the assignment of an arbitrary ID number to each employee and in other words, employee Peter in this case is assigned the arbitrary ID number 0, Paul is 1, Mary 2, and so forth on through Lisa which is 9, and these numbers should be assigned sequentially and they should be closely packed together because, as discussed further, the ID number really becomes (takes the place of) the record number. It's a pseudo-record number so if they are packed together then they will correspond to a single bit in a contiguous bit vector that will provide the same performance previously discussed. FIG. 18 is an example implementation for the case of a database with employees, where it is desirable to add a field to the employee record. In the master employee record, for each employees there is an employee number, name, date of birth, etc., and if it is desirable to add a field for ID number, assign it in a row. To assign employee ID, it is desirable to start with 0 and continuing sequentially, all while maintaining a counter to track numbers already used.

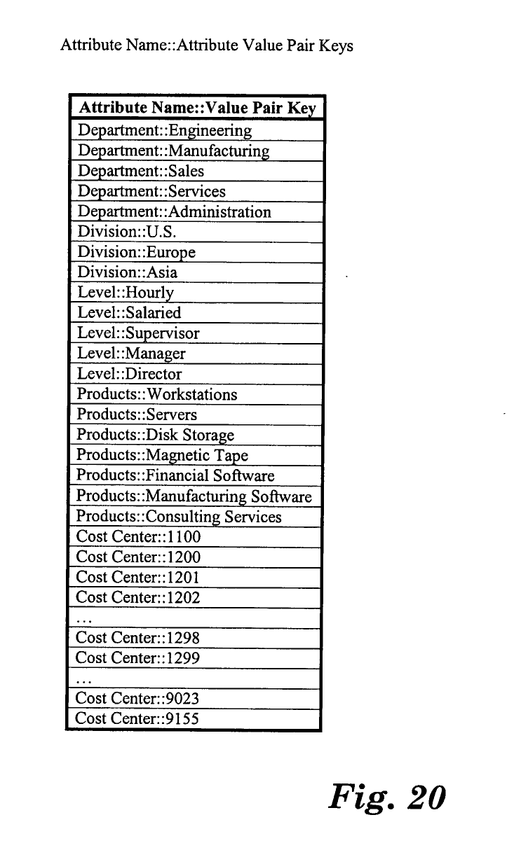

FIG. 19 illustrates a sample database, where the Employee ID column is added help in understanding the following figures. This sample data is depicted in FIG. 19 in the form of a table for ease of explanation, although it will be appreciated that no such database table would be used. This data shows, for instance, that employee Peter is ID 0, in department Engineering, in division U.S., level Salaried, the products he is responsible for is associated with Workstations and Servers, and the cost centers are 1100 though 1599.

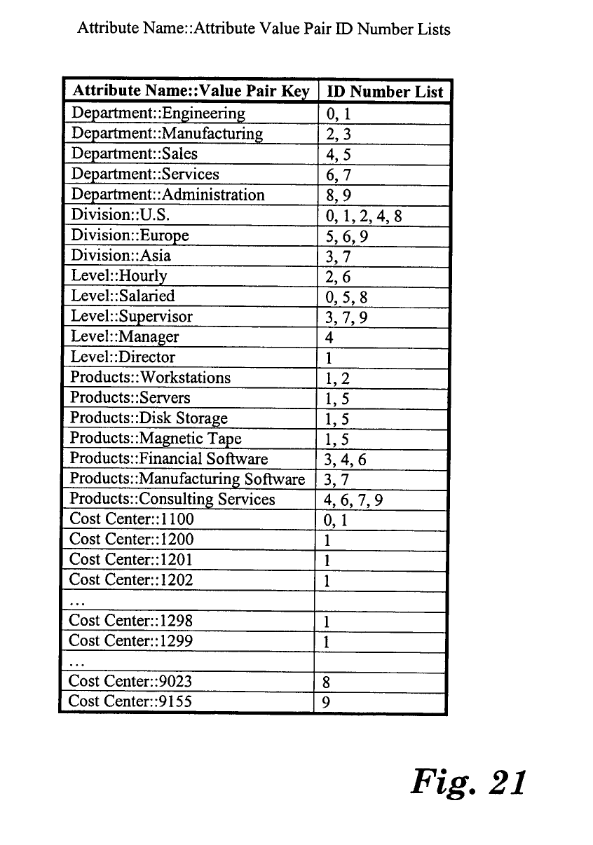

FIG. 20 illustrates how the data is stored with a method that utilizes the indexes without the need for records. Recalling the discussion above, an index consists of a key and associated with it is a list of records and, referring back to FIG. 2, everything except item 32 (which is the database list of field names) would be used That is, the records 32 can be eliminated resulting in the arbitrary index 30 that comprise index, model index, etc. For the employee example, the arbitrary index is the employee attribute index. Then in place of list of records it would be lists of ID numbers (corresponding to bits within a bit vector). The query processor would then return a query result ID number list in ID number. From that point, the ID number list could be processed (e.g., sorted), as shown in FIG. 2.

To properly illustrate the operation of an index, also referring to FIG. 11A, begin with an index for field color, which could be created as a structure of an index for employee attributes and it would work the same. There is the word “fine,” colon (:), the slice number, colon (:), then instead of, for example, orange or brown the key would be an entry from this table; and the key would be shown as a pair. It's the attribute name concatenated with the attribute value and in the table of FIG. 20 appears the concatenation with two colons (::), which can be any pattern that is unique that is not part of the data, for example, it could be a null character, it could be a special unicode character, but basically its just a reserved character that indicates that the attribute name has stopped and the attribute value has started. By using this then it becomes transparent to the key management and bit vector management routines that are written to assume just a simple string. As the key, in this case the string is Department::Engineering or Division::Asia and, for purposes of the database management part of the system, it is being treated as one key. The key is really subdivided into two separate strings or a pair of strings which are the attribute name and the attribute value. Now all possible combinations are enumerated, showing that if it desirable to implement either a new attribute name or a new attribute value for an existing attribute name, all that occurs is key creation and then start processing it.

The following routines are used for such things as creating arbitrary indexes, destroying arbitrary indexes, inserting attribute name/value keys into an arbitrary index, deleting an attribute name/value key from an arbitrary index, showing the arbitrary index keys or enumerating them, and doing a find or query against the arbitrary index retrieving a list of ID's. The database provides exported methods whereby the definition of attributename::value arbitrary indexes, insertion/deletion operations, and retrieval operations can all be performed under the control of applications external to the database. These operations are performed manually by the routines that manage the members of the set, instead of being automatically tied to the creation, modification, and deletion of data records. This allows the indexing and retrieval operations of the database to be utilized by arbitrary sets of arbitrary objects.

The following operations are specially defined for arbitrary indexes:

CREATE_ARB_INDEX

Creates an arbitrary index. Any number of arbitrary indexes may be created. Typically the same index is used for all attributename::value ID lists for a single type of object. For example, all attributename::value ID lists for employees are kept in the same index in the example used above. However, a different arbitrary index would be used for a different type of object. For example, all attributename::value ID lists for parts would be kept in a different index. This allows overlap of the ID numbers without conflict; and provides simplified operations (either index may be destroyed or reorganized without affecting the other index).

Note that arbitrary indexes are specifically created, because there is no table of records associated with the index. (For table indexes, the indexes for the data fields are automatically created when the table is created).

DESTROY_ARB_INDEX

Destroys an arbitrary index. Note that arbitrary indexes are specifically destroyed, because there is no table of records associated with the index. (For table indexes, the indexes for the data fields are automatically destroyed when the table is destroyed.)

INSERT_ARB_INDEX

Inserts an ID number into an attributename::value key within an arbitrary index. If no entry for the attributename::value key already exists in the index, such an entry is created. Then the bit number for the specified ID number is set in the index. This is done using the coarse and fine tables, slices, and bit vectors previously described.

Note that attributename::value keys with associated ID numbers are specifically inserted into arbitrary indexes, because there is no table of records associated with the index. (For table indexes, the keys with associated record numbers are automatically inserted into the data field indexes when records are created or modified.)

DELETE_ARB_INDEX

Deletes an ID number from an attributename::value key within an arbitrary index. The bit number for the specified ID number is reset in the index. If the entry for the attributename::value key becomes empty (no bits are set) the entry is deleted. This is done using the coarse and fine tables, slices, and bit vectors described above.

Note that attributename::value keys with associated ID numbers are specifically deleted from arbitrary indexes, because there is no table of records associated with the index. (For table indexes, the keys with associated record numbers are automatically removed from the data field indexes when records are deleted or modified.)

SHOW_ARB_INDEX_KEYS

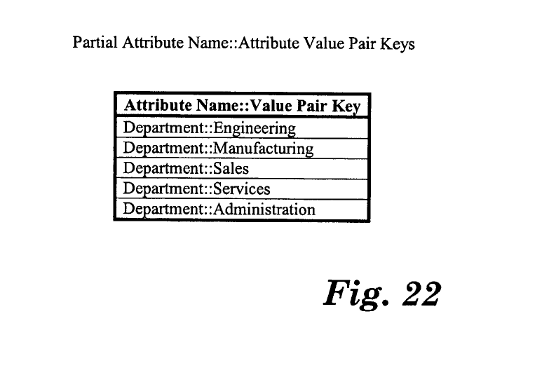

Shows all or some of the attributename::value keys contained within an arbitrary index. It is often useful to enumerate all of the keys contained within an index. In the example used above, it would be useful to see all of the attributename::value pairs assigned to employees. This operation would produce a result like the table in FIG. 21.

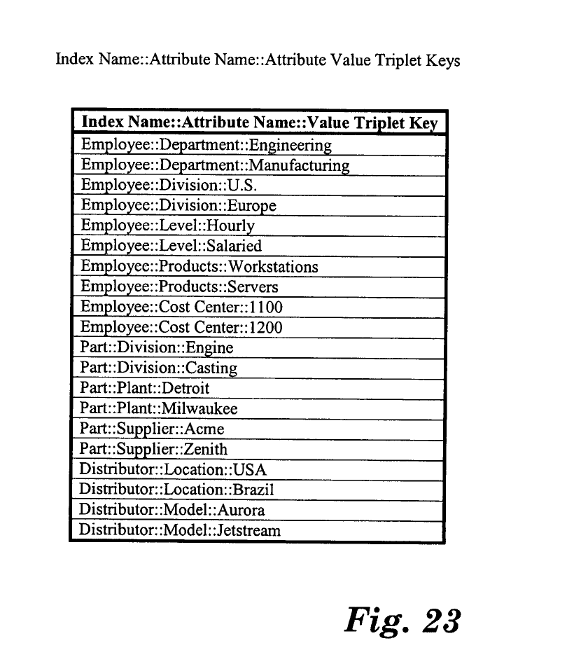

It is also useful to enumerate all of the values associated with a specified attributename. In the example used above, it would be useful to see all of the departments containing employees. This is performed by enumerating all of the keys starting with a specified value that are contained within an index. Performing this operation with the key starting value of ‘Department::’ would produce a result like the table in FIG. 22.

Note that since there is no table of records associated with the index, this information is retrieved from the index itself. Because the organization of the index tables is highly compact, in ascending order, this operation can execute extremely rapidly and efficiently. Only the coarse keys within the index need to be examined, since every unique key value within an index will have a coarse key. Since a coarse key covers 32,000,000 ID numbers, this operation executes very rapidly even on very large indexes. (For table indexes, the values for data fields are retrieved from the data records.)

FIND_ARB_INDEX_IDS

Executes a query against the specified index. This query returns a list of ID numbers satisfying the query criteria.

This operates exactly like the query processing described above in connection with FIG. 14, except for the final step. When set bits are found in the resulting bit vectors they are converted into ID numbers, using the same calculation method as that used to compute an absolute records number. These ID numbers are then returned in a list as the result of the query. (The bits are not converted to record numbers, nor are records returned, because there is no table of records associated with the index.) The result list of ID numbers is then used by the application for whatever purposes are desired.

For example, suppose the query criteria was

(Division=U.S.) AND

((Products=Workstations) OR (Products=Consulting Services))

This would produce the following result list of ID numbers:

0,2, 4

This could then be used to look up these employees by ID number (Peter, Mary, and Nancy), and perform whatever further processing was desired.

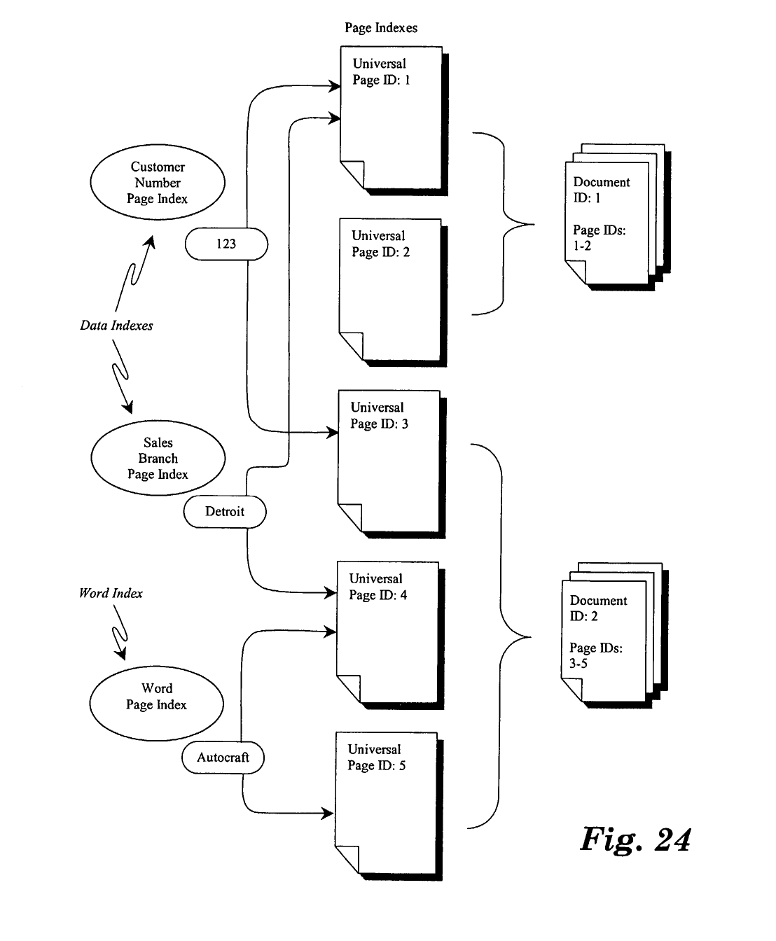

FIG. 23 shows an alternative to creating multiple indexes described above. An arbitrary index for employee could also be created, or another arbitrary index for part, etc. This would operate the way that the database was described earlier operates in the sense that if there was an employee record it would have its separate index tables for each field in the record; for a part record it would have its separate index fields. However, FIG. 23 shows that there can exist multiple logical indexes even though there is really only one index. And there are several reasons for doing this, and they mainly apply to the arbitrary index. For the record indexes before, since separate indexes are created and there is a limited number of fields per record, there is a limited number of indexes. It is not necessary to make records or delete them too often, since each field within each table has its own index. However, for indexing the page data for retrieval (which will be described below) there are going to be a lot of indexes and the indexes will come and go. In the case of full text indexes there will be indexes of different word lengths and so on. So there is some overhead involved with creating an arbitrary index and deleting it. When arbitrary index is created, the file has to be allocated on disk, the entries built in the database dictionary for it, and one should make sure that's all locked down onto disk and recoverable and so forth, and then one can start indexing it. When an index is deleted, the opposite occurs. The efficiency is higher if multiple indexes are stored within one physical structure, so now when adding to an index instead of having to create a new index and allocate the disk space and create it within the database dictionary, If an existing index is taken and the data placed into it is tagged, or the keys that are put into it, that can be done much faster. In addition, it should provide better utilization of space. If there are separate indexes, then each index has its own B-tree and each B-tree is composed of its own block which may be partially full and every time a new index is started, a new set of blocks and a new file on disk will also be started, and that means that if there are a lot of indexes particularly if they are not very full, there will be a lot of half empty blocks and wasted space. Whereas, if all indexes are combined under one integrated index, it means that there is no real overhead other than the space of the single entry for having an index that doesn't have a lot of data associated with it. Since they are all combined within the same blocks.

Combining all indexes is done very simply, take the attributename::attributevalue pair defined earlier and make it a triplet and prepend or insert at front the name of the index. To better illustrate, see FIG. 23 showing a sample table. So, for the key that is used in the index structure now instead of just attributename::attribute value it becomes:

indexname::attributename::attributevalue

It therefore becomes a triplet and then just as in the earlier example one would associate any number of ID's with any one of these entries. So for the example shown here, there is the employee index, a part index, and a distributor index and they're all built within the same physical index. However, because when you look it up, you know what index name you are looking up so if you want to find all the parts that are in the engine division you would build a key that is part::division::engine or part is the index name, division is the attribute name, and engine is the attribute value, and then do a query finding all the ID's set for that key, in effect finding the bits that are set and so forth. So, looking at the example under the employee table, there is the attributes department, division, level and products and cost center. Under the part index there is the attributes division, plant and supplier. And under distribution index there is the attributes location and model. For example, looking at the employee under department is engineering and manufacturing. And under level there is hourly and salary, etc. Under parts division there is engine and casting. Under plant there is Detroit and Milwaukee, etc. Under distributor there is the location attribute that has the values U.S.A. and Brazil and the model attribute that has the values Aurora and Jetstream. Another benefit with this approach is that there is no conflict with ID numbers. In effect since the way that the index is implemented with the B-tree entries pointing to the bit vectors or containing a compressed bit vector it is not problem, if for instance, the ID numbers for the part index conflict with or overlap the ID numbers from the employee index or distributor index since within each key there is a separate set of ID numbers. So again it provides a very nice effective, efficient and concise way to have an arbitrary number of indexes within the simple physical implementation of a single integrated index.

Page Indexing

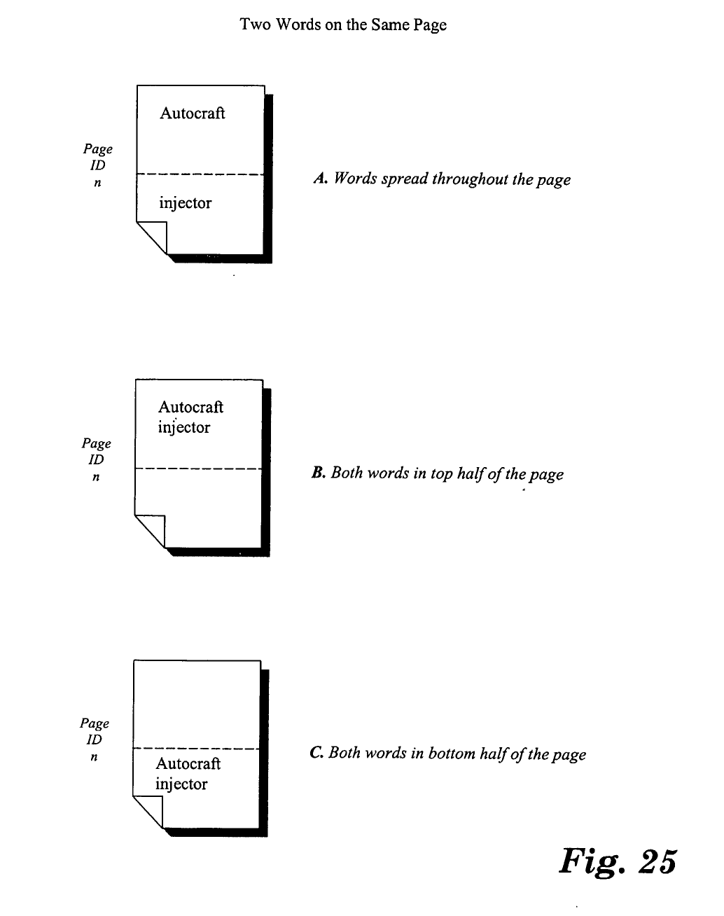

Turning now to page indexing, FIG. 24 gives a basic layout of the page indexing mechanism. A database that stores documents or pages, can store a lot of pages, maybe millions, or possibly billions of pages stored in this database and it is very useful to be able to go in and find pages that have needed information. For instance: customer numbers, it might be desirable to look-up information for a given customer number to be able to take that customer number and find the pages that have information for that customer number. Alternatively, it might be desirable to look at it a different way, there might be a sales branch and it might be desirable to to find all invoices generated by that sales branch. These two are called data indexes.

When the data was captured, it was identified what the customer number was associated with that page or what the sales branch was associated with that page and then use them to build an index. Indexes are built for high-speed data retrieval. Without an index every page would have to be examined, which would be very slow. So the index is built ahead of time. Again, the customer number and the sales branch are examples of what are called data indexes. However, it might also be desirable to want to retrieve pages based on just the contents of that page using the text or the words on the page. This is referred to as a word index. It might be desirable to find all of the pages that contain a given word or set of words and again search through all the documents and all of the pages but because of the volume that would be very slow. To make it much more efficient, one would generate an index ahead of time. These indexes, the data indexes and the word indexes, are versions of the index structure and bit vector structure already defined above. However, there are some additional enhancements to provide the facilities unique to this application that will now be addressed.

The page indexes are really an example of the arbitrary index discussed above. The arbitrary index consists of an attribute name and an attribute value pair key and an associated list of ID numbers. Looking at FIG. 24, the index name is actually the attribute name of the arbitrary index. Customer number is one attribute name. Sales brand is another attribute name. Word is another attribute name. So that would be 3 different attributes. The attribute values for the first index would be the various customer numbers and this example shows customer number 123. So the key would be customer number::123 for the customer number page index. For the sales branch page index the key would include the attribute name sales branch::, and in this case the sales branch value was shown as Detroit so the key would be sales branch::Detroit. And in the word index the key attribute name is word and the value as shown Autocraft, resulting in a key of word::Autocraft.

The final part of the an arbitrary index is the list of ID numbers associated with the attribute name::attribute value pair key and in this case arbitrary ID numbers are generated that are assigned to each page, and this will be called the universal page ID In this example universal page ID's 1, 2, 3, 4, and 5 are shown. So customer number 123 key that has ID's 1 and 3 associated with it. The sales branch Detroit key that has ID numbers 1 and 4 associated. The word index Autocraft key that has ID numbers 4 and 5 associated with that. This allows quick retrieval of the data because it can be indexed using the mechanism where the ID numbers really become bit numbers within the B-tree index and this also allows one to do all of the Boolean combinations. So in this example for a query that states “Find pages where customer number equals 123 and branch equals Detroit,” the ID number 1 will be returned, because that's the only one with both search terms and that will execute very quickly using the query mechanism discussed above. OR's or NOT's and other such Boolean operations can be done as well. So “Find everything where sales branch equals Detroit or containing the word Autocraft,” and ID numbers 1, 4 and 5 will be returned. The universal page ID's are assigned after the document is captured so in this case document ID 1, the entire document was captured and broken down into pages and at the end of that process the first page was assigned the next available universal ID number, in this case 1 and the second page was assigned 2. When the second document, when document ID number 2 was captured at the end of that it had three pages and then the three pages were then assigned staring with the next available universal page ID number which is 3, they were assigned 3, 4 and 5.

The approach of sequentially assigning the ID numbers works well within the framework of the arbitrary indexes and the bit vectors since it involves the use of a unique number for each page that allows each page to be individually retrieved so that one can index to the page level instead of just indexing to the document level. The numbers are contiguous within a document so, for example, in document number 2 the universal page ID's are 3, 4, 5, there will never be a skip like 3, 4, 7, or 3, 400, etc. Again they're assigned in one block to make it contiguous that again improves the efficiency of the operations and indexing and retrieving this document and pages within this document. It also makes it easy to automatically index all pages, for instance in the example here, it has been shown that the sales branch page index has Detroit on two pages in document 2. It's only on page 4 but it is desirable to have an index all of those pages with the title of the document, which was Monthly Inventory Summary, because the universal page ID's are allocated sequentially in a block, which can be accomplished by turning on a string of bits in the bit vector.

It is not necessary to actually go in and index each individual bit separately. The numbers are never reused and that provides an absolutely universal identification for every page. So as new documents are added the pages of the document are automatically assigned the next sequential block of universal page ID's. As documents are deleted, the page ID's are no longer used. They are deleted from the document repository and from the indexes and the number chosen. The size of the number chosen for the page ID is large enough that they will never run out of universal page ID's. Finally, the page ID's are closely packed between documents. That means that the first universal page ID for a new document is the next sequential number after the last page ID for the previous. In this case notice that document ID number 2 starts with page ID number 4 the very next item or number after page ID number 3 and document ID number 1, and by packing them closely that maximizes the efficiency of storage and speed of processing of the index and retrieval operations. One final item to note on this figure is that in the documents themselves, on the right side of the page where document ID 1 appears, there is also stored the first and last page ID in each document. So on document ID 1 the page ID's start with 1 and end with 2. On document ID number 2 the page ID's start with 3 and end with 5. This allows querying to a page level although one may want to view the whole document. For instance, in this case if the query finds customer number equal to 123, universal page ID 1 and universal page ID 3 will be retrieved. That's just a single page from each of two documents but maybe retrieval of the whole document that contains anywhere a page with customer number 123 is desirable. In this example, for the first document universal page ID 1 is returned and one can then go to the structure that has the information about the document and find the document that has a page ID in that range. Find document ID 1 where the page ID ranges from 1 to 2 and retrieve universal page 1 and 2 and that will show the whole document. Similarly, looking-up customer number 123 would have returned universal page ID 3 from which it is easy to find document ID 2, the information document header that says that it has page ID's 3-5. Pages 3-5 can be loaded, and then displayed to the person making the query the entire document. So this mechanism gives the ability to do a query and retrieve just pages or to retrieve whole documents or any combination.

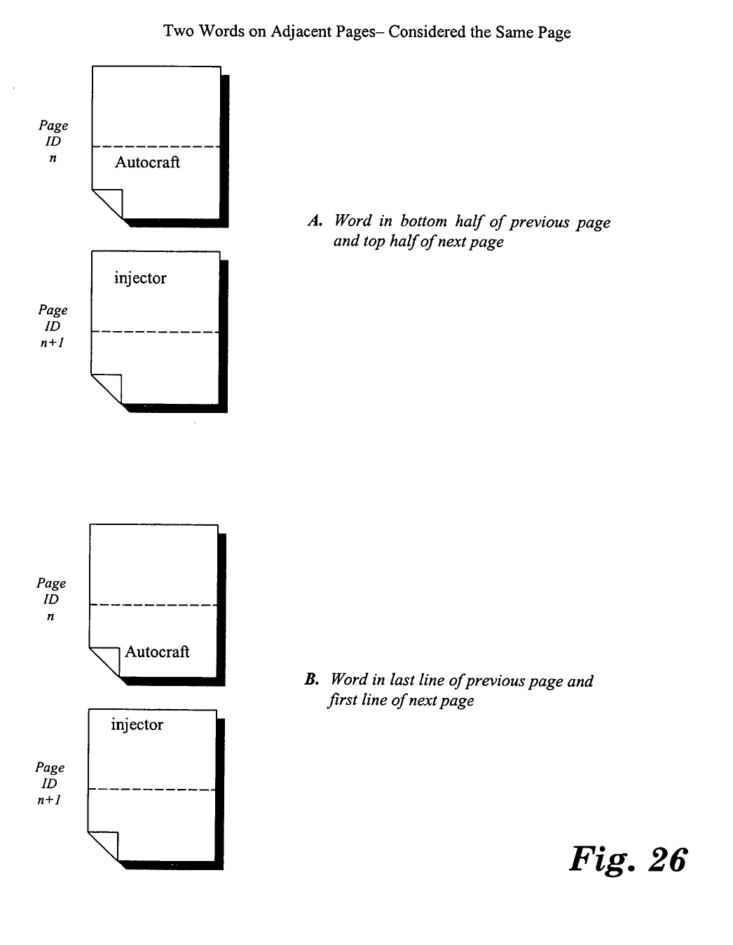

Following is a discussion related to the rationale for the way in which one can index and retrieve a combination of words on the same page. FIG. 25 this shows several ways to place two words on the same page. For example, one might be looking for pages with the word “Autocraft” and the word “injector” and there are several ways in which those can be placed on the same page for this. The following figures have taken the page and divided it in half, as indicated with the dotted line across the middle. In FIG. 25 under picture A, is the word spread throughout the page. “Autocraft” is at the top half and “injector” is on the bottom half. In example B both words are on the top half of the page “Autocraft” and “injector” are on the top half. And in example C both words are on the bottom half. However, in the case of all three of these examples, we consider them on the same page so we want a query to say “Find all pages that have both Autocraft and injector on them.” We want them to return each of these pages.

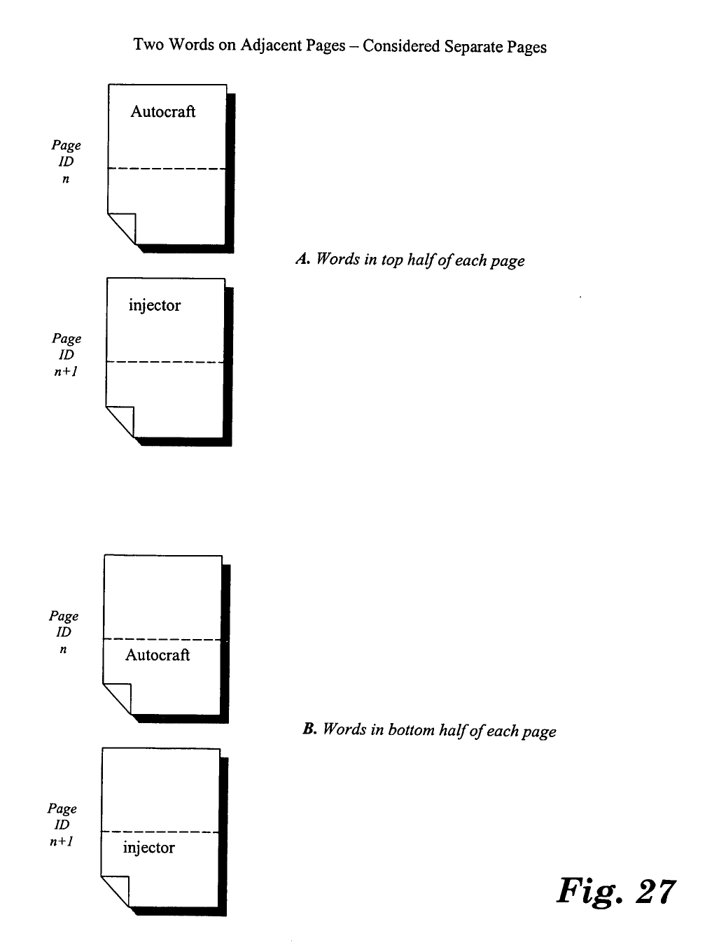

Looking now at FIG. 26, there are two words on adjacent pages but, for the word indexing approach being described herein, they are considered the same page. Looking at example A, it shows one word at the bottom half of the previous page and the next word in the top half of the next page. In this case “Autocraft” is in the bottom half of the previous page and injector is in the top half of the next page. If you did the query on the index “Find all pages that have both Autocraft and injector,” it will return this page. And the reason we want to return this page is typically a document is a free flowing stream of text of one or more columns typically one column that has page breaks only to handle the limited size of the page, but when it is desirable to find a page that has “Autocraft” and injector, that translates to wanting to find “Autocraft” and injector roughly on the same page. Looking at example B in FIG. 26 to illustrate the worst case. “Autocraft” could be the last word on the previous page and could be the first word on the next page. If you just did things by actual page “Autocraft” is on a different page as injector, so a query to say find me all pages that have “Autocraft” and injector on them would not return either of these pages where what it desirable is to see both of these pages. So it is preferable to design things such that a query for “Autocraft” and injector or any two words or multiple words will succeed or will consider the pages to have the words if they're near within a half of page to a page of each other.

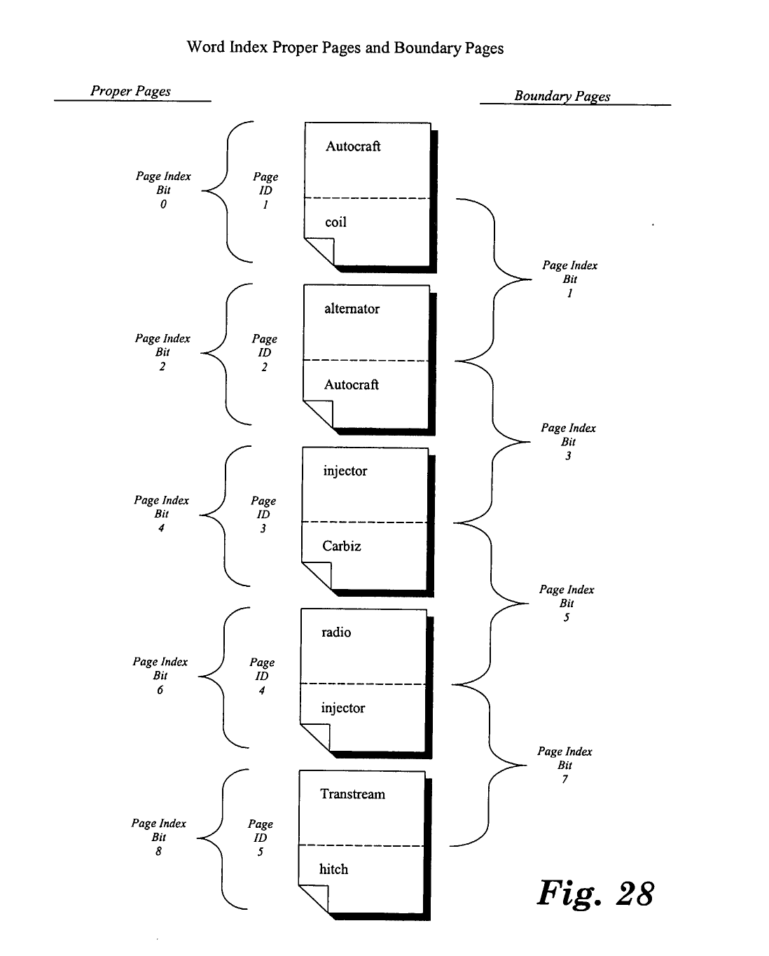

Turning now to FIG. 27 there is shown examples of two words on adjacent pages. They are not considered separate pages. And under example A, the words are in the top half of each page that Autocraft is in the top half of the previous page and injector is in the top half of the following pages so there really more than a half a page apart so they are separate. In example B the words are at the bottom half of each page. Autocraft is in the bottom of the previous page the bottom half and injector is in the bottom half of the next page. So again, they're more than a half of page apart and based on the design decision, if they are physically on the same page then they are considered on the same page in all cases. If they are on adjacent pages, they are considered on the same page if they are within a half of page of each other, specifically within between half a page to just under a page of each other. If they're more than half a page they're considered separate depending on what half they work. For speed of operation rather than doing the exact computation the pages have been divided into half in the example shown here. If it is in the bottom half of a previous page and the top half of the next, they are considered within the same page for the purpose of the query. If they are on adjacent pages but both on the top or both on the bottom they're considered different pages.

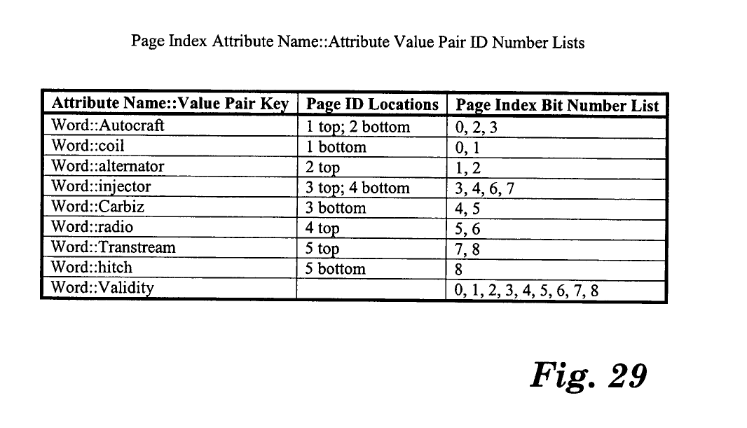

FIG. 28 illustrates how the word index or full text index is organized showing the actual pages called proper pages and boundary pages. In this figure, there is a single document that has 5 pages and down the center of each page is assigned a page ID discussed earlier. The first page is page ID 1 then 2, 3, 4 and 5. As previously discussed the desire to keep track of data that is within roughly a half page of each other to use two bits for each page. One bit is the proper page, shown on the left, and the second bit is for the boundary page, shown on the right. Illustrating word page bit number calculations, this shows how to convert the page ID and the word on the page into both the bit number for the proper page and the bit number for the boundary page.

For Proper Pages:

Page Index Bit Number=((Page ID)−1)·2

For Top-Half Boundary Pages (not used on first page):

Page Index Bit Number=(((Page ID)−1)·2)−1)

For Bottom-Half Boundary Pages (not used on last page):

Page Index Bit Number=(((Page ID)−1)·2)+1)

For the proper page, the page index bit number is equal to the page ID minus 1 times 2. Subtract 1 because page ID's start with 1. The value 0 for a page ID is reserved to indicate no page ID or no page. And then multiply by 2 because there are 2 bits per page. So again every word is indexed with the page index bit number that reflects its proper page. In this example the words on page ID 1 the words Autocraft and coil are indexed with proper page index bit 0 because 1 minus 1 is 0 times 2 is 0. The words alternator and Autocraft are indexed with the proper page bit number 2 because the page ID of 2 minus 1 is 1 times 2 is 2 and so forth throughout the page. Then for the bit that reflects the boundary page it depends on whether the word is in the top half or the bottom half and if you look at FIG. 28 it shows that the boundary page actually includes the bottom half of one page and the top half of the next page. So for instance the boundary page reflected by page index bit 1 is the bottom half of page ID 1 and the top half of page ID 2 and so forth. If a word is in the top half of a page then its indexed in with the page index bit number for the boundary page that is the expression page ID minus 1 times 2 minus 1.

In other words, the bit value for a word in the top half the boundary page bit value is 1 minus the bit value for the proper page. For the bottom half boundary page, if a word is in the bottom half of a page the bit number for the boundary page index is the page ID minus 1 times 2 plus 1 or, in other words, one more then the bit number for the proper page. So in this example the word on page ID 1, the word coil, is in the bottom half of the page so it's indexed with page index bit number 1. For the word alternator on page ID 2, it's in the top half of the page that's also indexed with page index bit 1 because that's the page index bit 2 minus I and so forth. There is a special case that, for the first page of the document, do not index the top half of that on the boundary page and for the last page of the document you do not index the bottom of the boundary page. Because the top or the first page is not considered to be part of whatever document came previously and the bottom of the last page really is not considered to be part of whatever document follows it. So again, looking at FIG. 28 that shows the layout and looking for the word “injector,” it is on page ID 3. Now looking on the right it is indexed because it is on the top and indexed with bit number 3 in the page index and on the left it is indexed with bit number 4. Also the word “injector” is on the bottom of page ID 4 on the left it is indexed with proper page index bit 6 and on the right it is indexed in the boundary page with index bit 7. So in effect every word except the first half page and the last half page is indexed into two bits; namely, the bits that reflect its proper page and the bit that reflects is boundary page.

For another example, if it was desirable to find pages that contain the word Autocraft and injector, in that case they're on different page ID's, Autocraft is on page ID 1 and page ID 2, injector is on page ID 3 and page ID 4. However, there is one bit that includes both of them and that is page index bit 3 which shows the boundary page. It has Autocraft on the bottom half and injector on the top half. Searching for injector and Carbiz together, they are on the same proper page and it happens to be one place that there is a bit set for both of them on the same bit, that's page index bit 4.

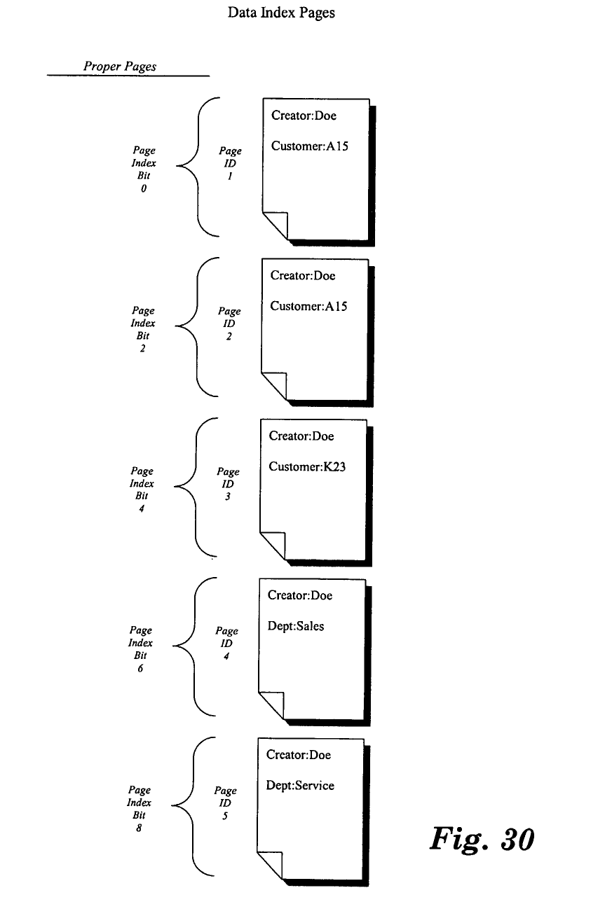

FIG. 29 shows the data from FIG. 28 previously discussed, but now arranged in a table. The page index attribute name::attribute value pair ID number list. And this is the way that the table would be created within the B-tree and bit vectors. So under the attribute name value pair key used for the full word or text index, the attribute name is “word.” So word::Autocraft is the key for the word Autocraft anywhere on the page. Next is the page ID locations. It is on page 1 top and page 2 bottom and then the page index bit number list, which is the bit vector, it shows that that's bit 0, 2 and 3. Bit 0 is set because it's on page ID 1 the proper page bit number 2 is set for it being on page ID 2 proper page and on the bottom in bit number 3 is set on the boundary page for page ID 2 and so forth. The word coil is on page 1 on the bottom and that's references or indexed as bits number 0, 1. The word injector is on page 3 at the top, page 4 at the bottom and that becomes bits 3, 4, 6 and 7 and so forth. So this table shows all of the keys that are built and then indexed with the resulting bit vector or bit number list. The last item in that table, the last row needs a little extra discussion and that's validity.

And in this case the word validity does not actually appear, but there is a special key that is the validity key for this index, for the word index. And that key has a bit set in the page index bit number list for every either proper or boundary page that was indexed using words. So in this case, all five pages were indexed with a word index that starts with page index bit 0 and runs sequentially through page index bit number 8, for example the list is 0, 1, 2, 3, 4, 5, 6, 7, 8. If there was another document, it could even be a single page, it would be page ID 6. There would not be any bits referencing that in the word validity key if that was not indexed with a full word. The purpose of the page index validity keys are very simple. If it was desirable to “Find all pages that have the word coil in it,” we don't need validity keys. So it's very simple just to go through the word::coil key and see its bit number 0 and 1, and from that, figure out that it's page ID 1.

But what happens if it is desirable to find all pages that don't have the word coil on it. Then take the bit vector from the key for word::coil and NOT it or compliment it and that would give us all the bits for pages that don't have the word coil. However, there is a problem in that the system should know the difference between a page that does not have the word coil and a page that was never indexed with the word index, so in this case if there were a page ID 6 that was not indexed with the word index, it would not be in the word::coil bit vector. So when that was NOT-ed that page would show up. However, it is not necessary to know whether it has or doesn't have the coil because it was not indexed. So the way the page index key validity or the index name validity works is that they are always AND-ed with any expression. So if it was desirable to “Find all the pages that don't have the word coil” the preferred embodiment would find the pages that do have the word coil take that bit vector, compliment it and then AND in the word::validity bit vector. That would turn off page ID 6 or any other page ID that wasn't index, preventing an incorrect answer. So the way to operate whenever using indexes or page indexes is that any query that uses an index, either a word index or a data index, will only return pages that were indexed with that index or indexes.

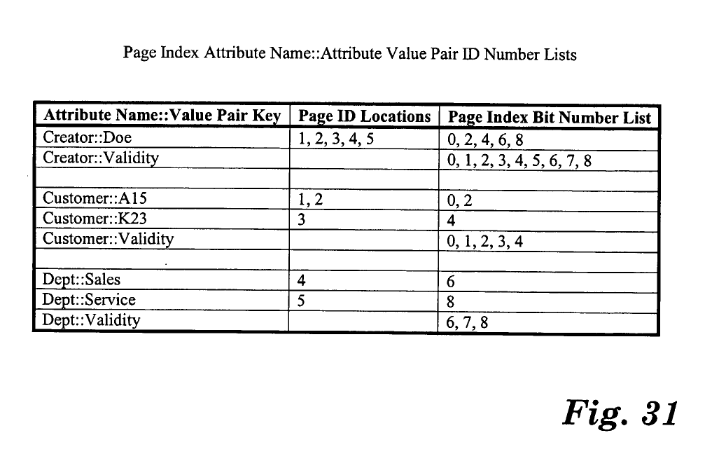

FIG. 30 illustrates an example in pages for data indexing. Data indexing is different than whole word indexing. Data index means a field on the page has been taken so that it is of a known data type and that is a more specific than knowing it is a word. According to this figure, there is a document with 5 pages, page ID's 1, 2, 3, 4 and 5. And on the pages there are some sample data indexes. On page 1 the creator field is Doe and the customer is A15. On page 2 the creator is Doe, actually all 5 pages are indexed with the creator Doe because every page has the same creator. The customer is A15 on page 1 and page 2, on page 3 the customer number K23, page 4 and 5 don't have customer numbers, instead they have a department. Page 4 is Dept::Sales and page 5 is Dept::Service. The difference between a data index and a page index, there are two differences, the data index we know that it actually is the item that it references. For instance in this case, the customer A15 because it is known that in that position on the page it is a customer number. If a search was conducted to “Find all pages were the customer number is equal to A15,” the preferred embodiment would only find those pages, in this case page ID 1 and 2 that have that in customer number field. Pages that had A15 in a part number or in an item or text or anywhere else would not be retrieved.

Where as with the word index if it was desirable to “Find all pages that have the word A15” these two would return, but you would also find pages that A15 on it where it doesn't reference a customer number but references something else. So the data indexes are very advantageous and actually the best implementation is what we have is to have both data and word indexes. The data indexes you can set them up to provide more accurate retrieval, however, you don't always know the items you want to index sometimes the data floats and is hard to index, so having the full word index it provides the ability to always search and a little more filtering may have to occur to find the data, even if it was not set up ahead of time with the data index. Data indexes are only indexed on the proper page. They are not indexed on the boundary page because the concept of finding, for instance, if it was desirable to find documents with creator Doe and the customer number K23, because the data index is specifically set or applied on a page or a set of pages it only makes sense if they're on the same page. In this case, it would not be desirable to have the bottom half of one page that has the right creator and the top half of the next page that has the right customer number. So again for data indexes, only index the pages with the proper page and not the boundary page. In this case, look at page ID 1 the page index bit is 0. So Creator::Doe and Customer::A15 have bit 0 on also have bit 2 on, bit 4 is also on for Creator::Doe, but it is in Customer::K23, bit 6 is Creator::Doe and Dept::Sales and bit 8 is Creator::Doe and Dept::Service.

For Proper Pages:

Page Index Bit Number=((Page ID)−1)·2

the data page index bit number calculations that shows the simple case that for every proper page the page index bit number is the page ID minus 1 times 2. So on every page all the data index values are indexed using this.

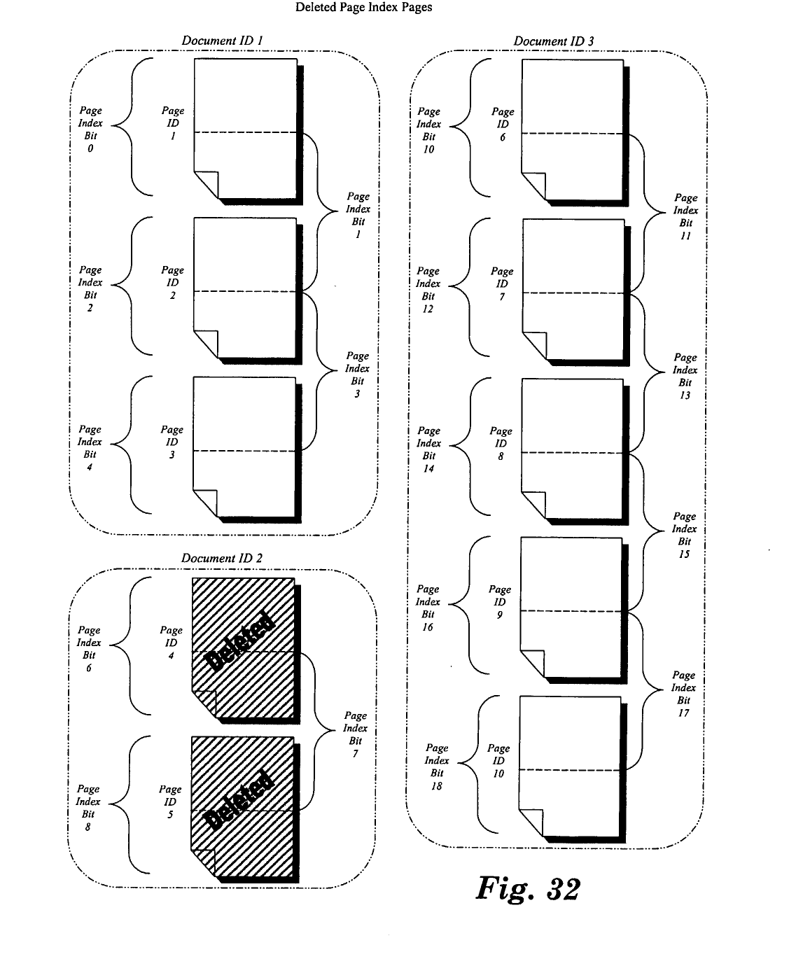

In FIG. 31, the page index attribute name::attribute value pair ID number list shows the way that the index table entries will be set up for the data indexes is shown in the example from FIG. 29. In this case there is the attribute name as the data index name and the attribute value is the value of that item. So the attribute name creator there is the value Doe, the page ID locations are 1, 2, 3, 4, and 5 and that shows then what would give the page index bit number list of 0, 2, 4, 6 and 8. The customer, there are two entries, customer A15 on page ID's 1 and 2 that converts into bit number 0 and 2, and the customer number K23 is page ID 3 that converts into page index bit number 4. There are two department, sales on page ID 4 which is bit 6, and service is on page ID 5 which is bit 8. Also shown is the validity and again every data index has a validity bit vector. In this case the creator validity bit vector is bits 0, 1, 2, 3, 4, 5, 6, 7 and 8. In other words, it's every bit starting with the first bit, the first proper page and ending with the last proper page including both the proper and boundary pages in the middle. And that the reason that the boundary pages are included in the validity bit vector even though they are not included in the data index page indexes is because it's possible to do a query that combines both forward indexes and data indexes. For example, it could be desirable to find all documents that contain the word Autocraft and are for Department Sales. In that example, there will have to be a combination of full words that were indexed on both proper and boundary pages and in data index which is indexed only in data page so when validity bit vectors are AND-ed, ensure those validity bit vectors clear not only the proper pages that were not indexed with an index but also the boundary pages and also retain the proper pages and boundary pages that were within the index. So looking at the validity bit vector for customer with bits 0, 1, 2, 3 and 4 and the validity bit vector for department has bits 6, 7 and 8.

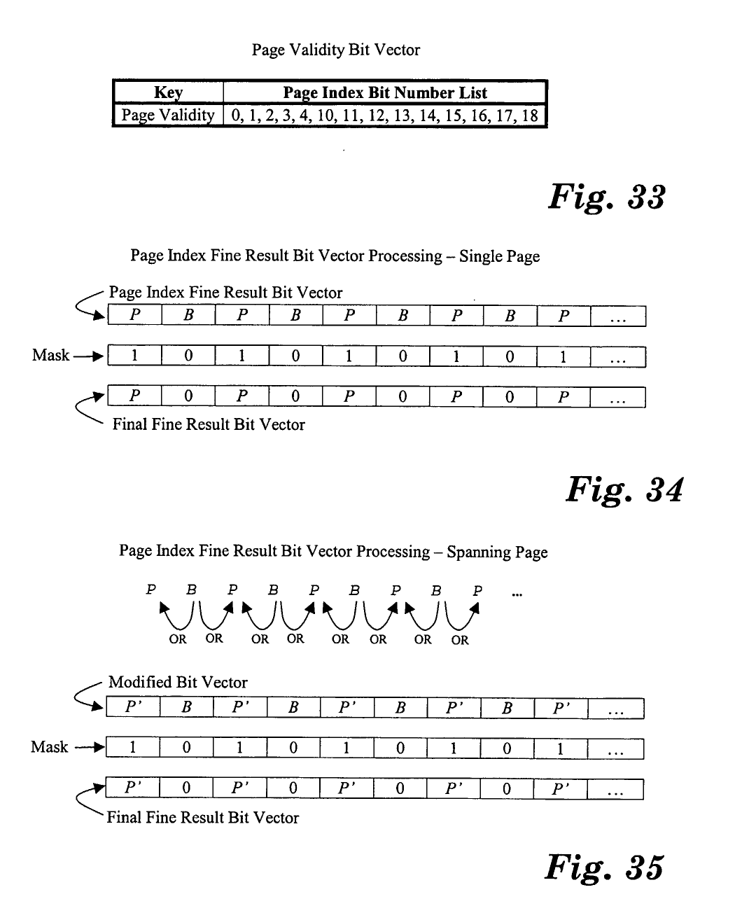

Turning now to FIG. 32, one of the issues which has to be handled is the fact that documents can be deleted at any time. And when a document is deleted all of the pages for that document are deleted. This deletion should be processed as efficiently as possible so that documents are deleted when requested. However, it is desirable to still maintain integrity of the searching mechanism. In this example of FIG. 32 there are three documents. Document ID 1, 2 and 3. Document ID 1 has 3 pages with the page ID's 1-3. Document ID 2 had 2 pages with page ID's 4 and 5 and document ID 3 has 5 pages page ID 6, 7, 8, 9 and 10 and on this is shown the page index bits that are assigned to both the proper and the boundary pages for these documents. Document ID number 2 has been deleted, so that document should not be be returned by any queries that reference data that was in that document. On the face of it, the simplest approach would be to do the opposite of the indexing. So say when document ID 2 is deleted, which is page ID's 4 and 5 to go through and delete it from all the page indexes. But that means it would be desirable to find all the data indexes and, for each item in a data index on those pages, turn off the bits relating to page ID's 4 and 5. Then if this page was also indexed by a full text index it would be desirable to go through and find every word on the page again, as seen previously, find every word on that page, and then delete it. However, there is a better way to do it where the document can be quickly deleted, and then later in a batch process perform an efficient clean up. And that's by using a page validity bit vector. This is not to be confused with the page index validity bit vector discussed above. There is one page validity bit vector for all of the pages in the indexes and that's really the vector that says which pages are valid.

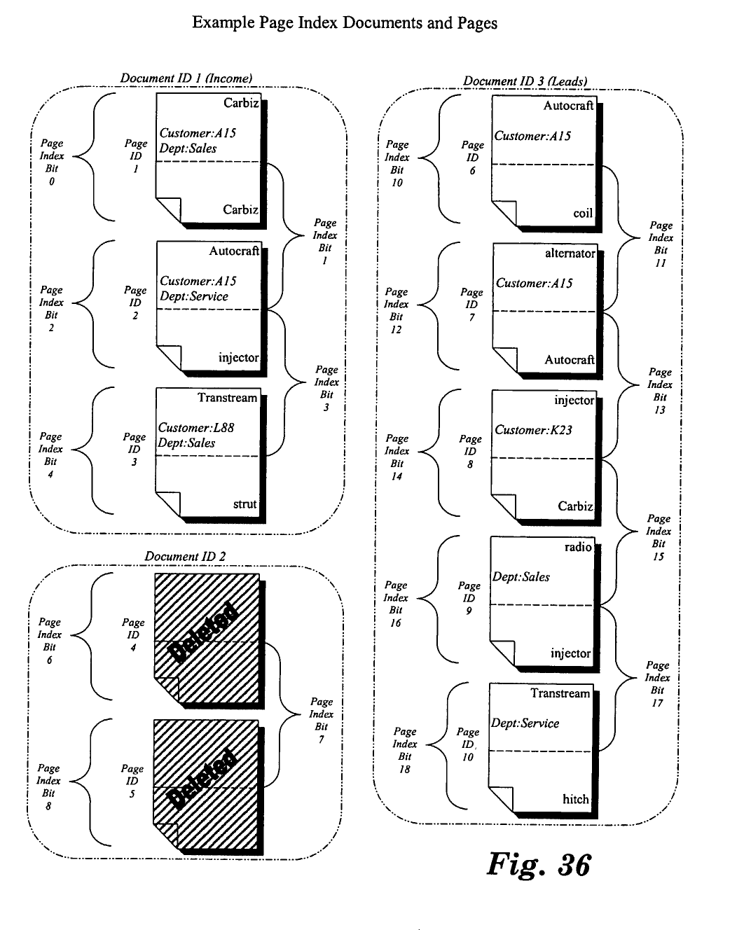

FIG. 33 illustrates the page validity bit vector for the documents shown in FIG. 32 and in this case the page validity bit vector there is a bit set for every page index bit that references a page that's still valid. The bits are reset or are not set for deleted pages. So in this case, the three documents have page index bit numbers 0-18. However, looking at document ID 2, page index bits 6, 7 and 8 reference that so they have been turned off. In other words the page validity bit number list in FIG. 33 goes from 0 through 4, 5 doesn't exist because it is between document 4 and 6. 7 and 8 don't exist in the list because those pages have been deleted, 9 doesn't exist because it's a boundary page between documents, and then 10 through 18 are in the list. What happens then is the page validity bit vector is always AND-ed in at the end of any operation before retrieving the pages. So in this case, when page ID's 4 and 5 in document ID 2 were deleted, the preferred embodiment accessed the page validity bit vector and turned off bit 6, 7 and 8. It was thus not necessary to go in and turn off the bits on all the other indexes and then from that point on all the queries worked properly. Eventually it is desirable to clean-up the bits from deleted documents because that does represent space that can be recovered. This clean-up can be done in a background process, or in a batch mode. For instance, that could be issued once a day, have a separate process that in the background goes through, finds all of the documents that were deleted, to be kept, if a record is kept when you delete them, all the documents that have been deleted since the last clean up and then for each document it runs through the index tables and cleans them up. Any efficient algorithm is can be used to accomplish the clean-up task.

Next, the discussion on how to process the bit vectors, which are the result of executing query commands, will begin. And there are two ways to process that. In one manner the process is called single page mode, which means the results only reflect data on a single page, completely within the page. The second mode is called the spanning mode, where the results span pages or occur on a boundary page. So the single mode is typically used for data indexing, where wanted data is only on the page. The spanning mode is typically used for word indexing where the searched words and if there is a combination of words on the page to be considered on the bottom of the previous and the top of the next. If word and page indexing are mixed any decision can be made. The decision to only use spanning mode should be made only if all of the indexes that are being used for retrieval are word indexes. If there is one or more data indexes involved in the expression then single page mode should be used.

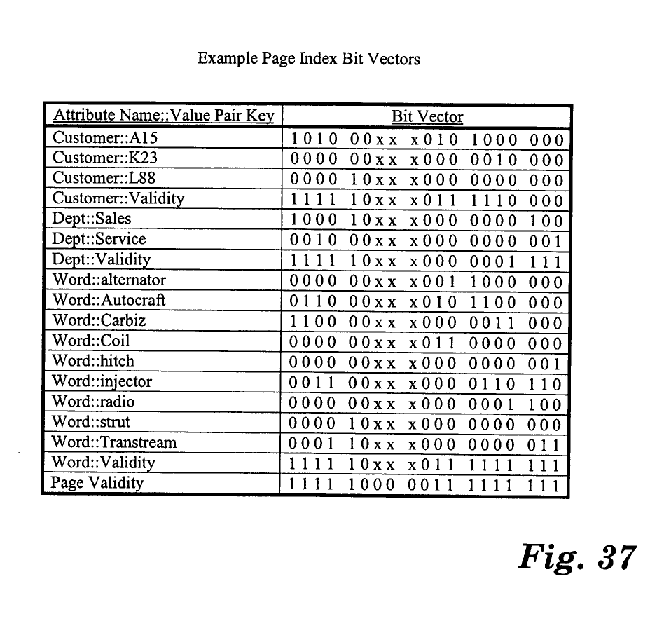

FIG. 34 depicts how a fine result bit vector is processed in single page mode. In this figure, P denotes a Proper page index bit; and B denotes a boundary page index bit. The fine result bit vector is ANDed with the mask, resulting in the final fine result bit vector. A count operation simply counts the number of set bits in this final fine result bit vector. A retrieval operation computes the Page ID number for each set bit in this final fine result bit vector; and then retrieves each of these result pages using the Page ID number. The Page ID number is computed as follows:

Page ID=((bit offset in bit vector)÷2)+1

The (bit offset in bit vector) is calculated as follows:

(afs·fsl)+(bit offset in fine slice)

Where afs is the Absolute Fine Slice number; and fsl is the Fine Slice Length. The resulting bit vector has the even bits which denote the proper page index bit and has the odd bits which denote a boundary page index bit. Since the only concern within single page mode are the proper pages, the resulting bit vector is taken and AND it with a mask which has a 1 in the position of the proper pages and a 0 in the position of the boundary pages. In other words, with a 10101010 . . . mask. And that produces the final result bit vector where the even bits are the proper page bits containing either a zero or a one, with a zero indicating that the query criteria is not satisfied by that proper page, and a one indicating that it is. The odd bits, the boundary bits, have all been set to 0 by ANDing with the mask. Then the number 1 bit's on can be counted or the relative position of the bits within the fine slice can be used to compute the actual page ID number for each page that met the criteria and can be retrieved.

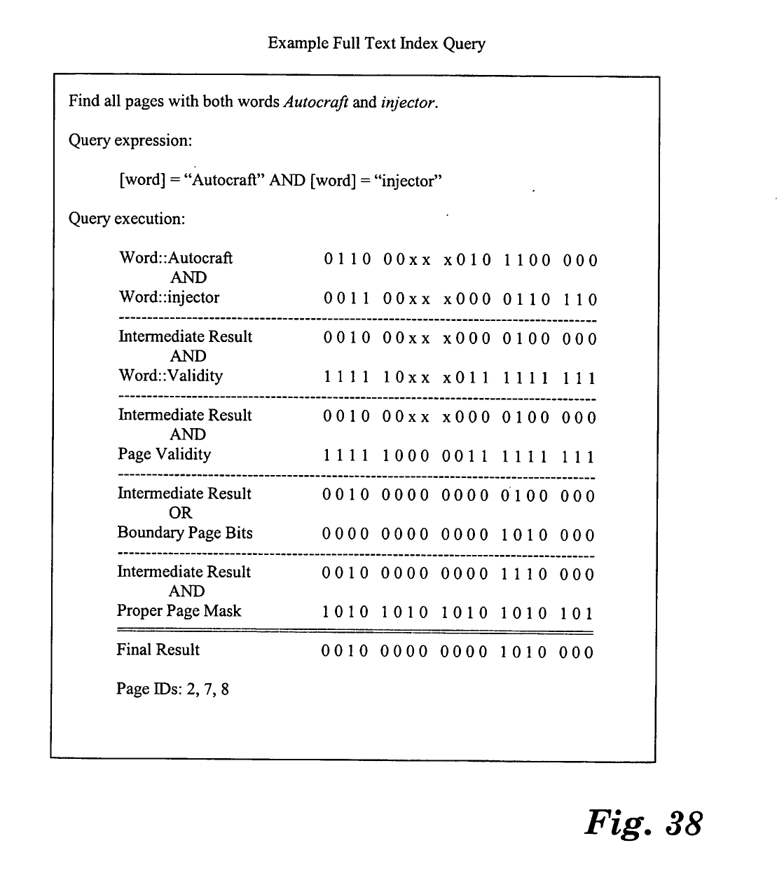

FIG. 35 illustrates the method in which the resulting fine bit vector is taken from a query and processed if one wants to retrieve spanning pages. In this figure, P denotes a Proper page index bit; and B denotes a boundary page index bit. Each boundary page index bit B of the page index fine result bit vector is OR-ed into its predecessor and successor proper page index bits P. Then, the modified bit vector is ANDED with the mask to produce the final fine result bit vector. A count operation simply counts the number of set bits in this final fine result bit vector. A retrieval operation computes the Page ID number for each set bit in this final fine result bit vector; and then retrieves each of these result pages using the Page ID number. The Page ID number is computed as follows:

Page ID=((bit offset in bit vector)÷2)+1

The (bit offset in bit vector) is calculated as follows:

(afs·fsl)+(bit offset in fine slice)

Where afs is the Absolute Fine Slice number; and fsl is the Fine Slice Length. In other words, in the case when doing a full word retrieval and finding two words on the same page is wanted, this will allow as described above to consider the bottom of one page and the top of the next as the same page. Basically, start with the same bit vector, because the same query process has been executed where the even bits reflect proper pages and the odd bits reflect the boundary pages within them. The first step of processing is to take, if there's any boundary bits that are set, the proper page should be set just before and just after that boundary bit. And that is done by taking each boundary bit and Oring it into the immediately preceding and immediately following proper page bit. And that is shown in the diagram. And when it is OR, that proper page bit is changed. If the proper page bit is already a 1 it doesn't matter—nothing's changed. If the proper page bit is a 0, then if the boundary page bit either after it or before it is a 1, then that proper page bit will be set to 1. That produces the modified bit vector shown, then AND with the same 10101010 . . . mask to clear up the bits reflecting boundary pages, and a final fine result bit vector is produced where the even bits represent proper pages. Anywhere that an even bit (a proper page bit) is on that indicates that that page, the page ID represented by that bit position, meets the query and should be processed. The odd bits are the boundary page bits have been set to 0 by ANDing with the mask. And again the number of bits can simply be counted to see how many pages meet the criteria or the relative position of the set bits can be used to convert that into a page ID number and retrieve the page of all the pages that meet the criteria.

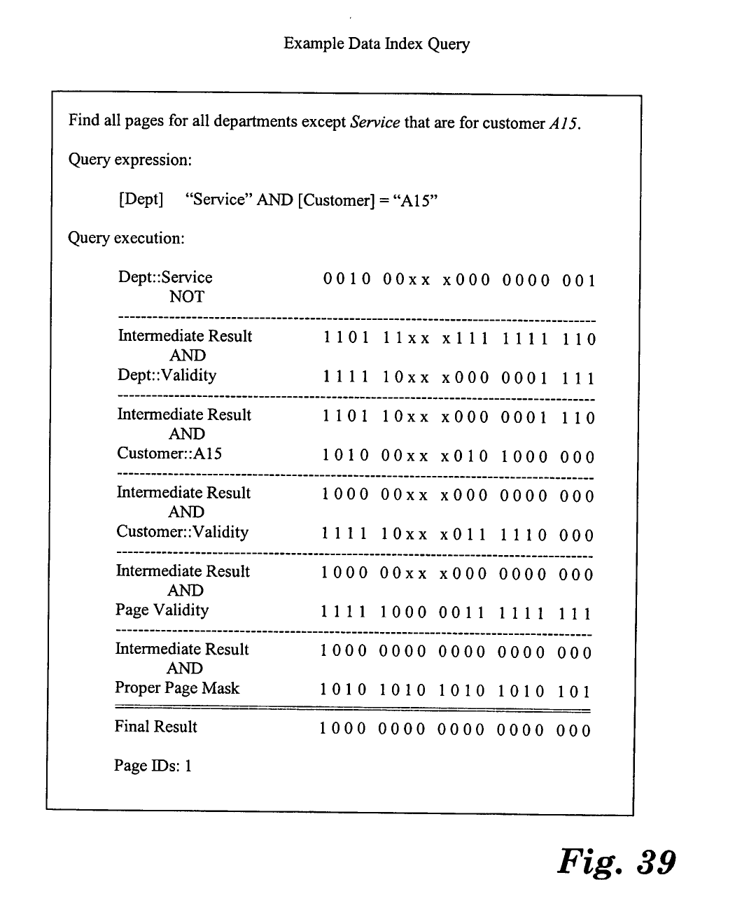

FIG. 36 shows a little bit more complete example where some sample data and a couple typical queries are shown along with how they're processed. In this example, there are 3 documents: document ID number 1, document ID number 2, and document ID number 3. Document ID number 2 has been deleted so that the processing of the page validity vector is shown for deleted entries and within the documents both words that have been indexed and data indexes are shown. The words are in the Roman type, right justified on the right side of the page. Data indexes are in Italic type, left justified on the left side of the page images. So for instance, in document ID 1 page ID 1 the words that are indexed is “Carbiz” which appears both in the top and the bottom of the page. On the second page the words are “Autocraft” and “injector” and so forth. For the data indexes, on the first page the customer ID is A15 and the department is sales and that's on the first page on the second page the customer ID is A15 and the department is service, and so on throughout the examples. In addition to the page ID's, the page index bits for both the proper pages and the boundary pages are shown. On the deleted pages in this figure none of the contents are shown since it doesn't really matter what the words were that were indexed or the data indexes because the page is deleted and that index data to retrieve the page is not used anymore.

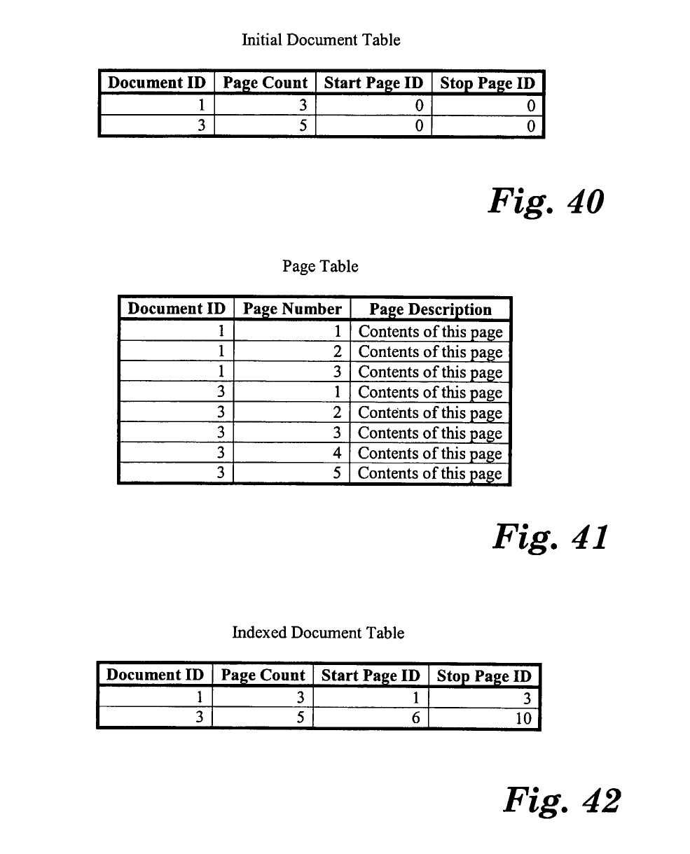

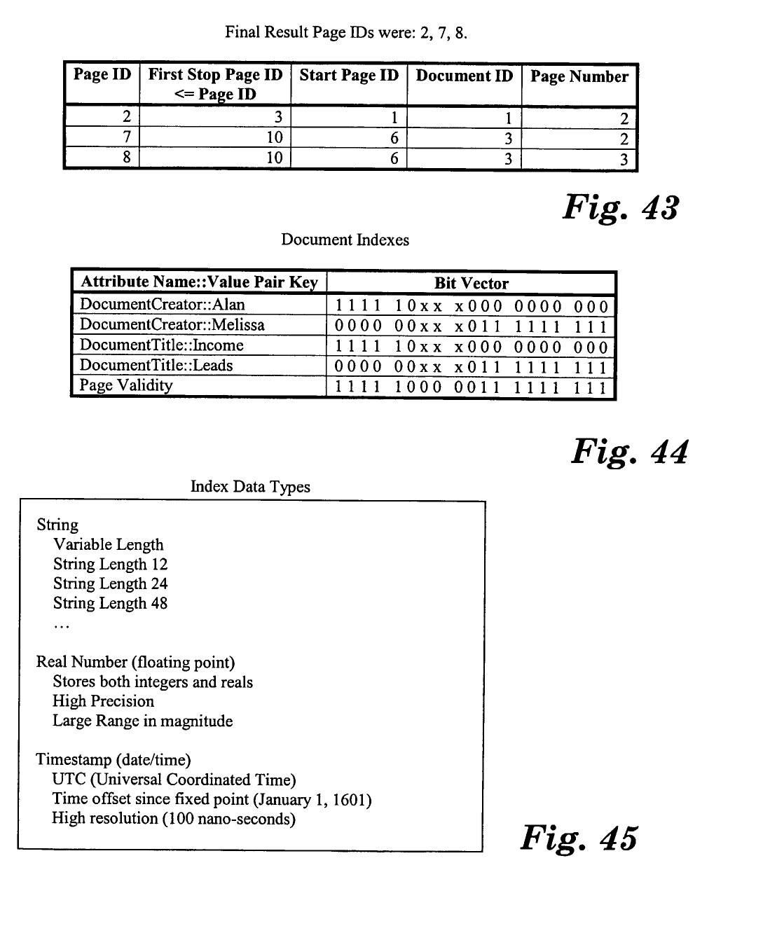

FIG. 37 is a table that shows, for this example, the page index bit vectors that would be produced by indexing. The first column is the Attribute name and value pair key. And shown, for instance, Customer::A15 is the entry for all the pages that have the data index of customer ID and the value A15. Next is K23 for a customer ID and so forth. After the three customers there is the Customer::Validity that is the page index validity bit vector that shows which pages were indexed with a customer data index. Followed by the department data index and then the word index or word::alternator is the list of page index bits that are set for the word alternator followed by all the other words followed by the page index validity bit vector for word. In effect that shows all the pages that were indexed with the full word index followed by the page validity bit vector and this is the special bit vector that indicates which pages are valid versus which pages have been deleted. In this table the keys have been shown in order. In some of the previous tables they were not shown in alphabetical order, they were shown in an order that made it a little easier to understand. In actuality, since the keys are stored within the B-tree they are in order as shown here and that order is what's used to help processing, particularly if doing ranges of values and so forth. Then on the right for each one of these the bit vector is shown. Each bit in that bit vector represents a single page index bit both proper page and boundary page. The position of the offset of the bit within the bit vector exactly maps into the bit number shown in FIG. 38 as the page index bit. A one means a set value. Zero is a reset value. The x's are bits that it really doesn't matter what the value is. And the x's for the page index bits are shown that reference pages either proper or boundary pages for the document that was deleted and by showing that it's x'd it means that whether it's a one or zero is not cared for because the page validity has zeros in those positions, this will be seen as these are processed whether it's a zero or a one where there is an x it'll end up being a zero in the final result.

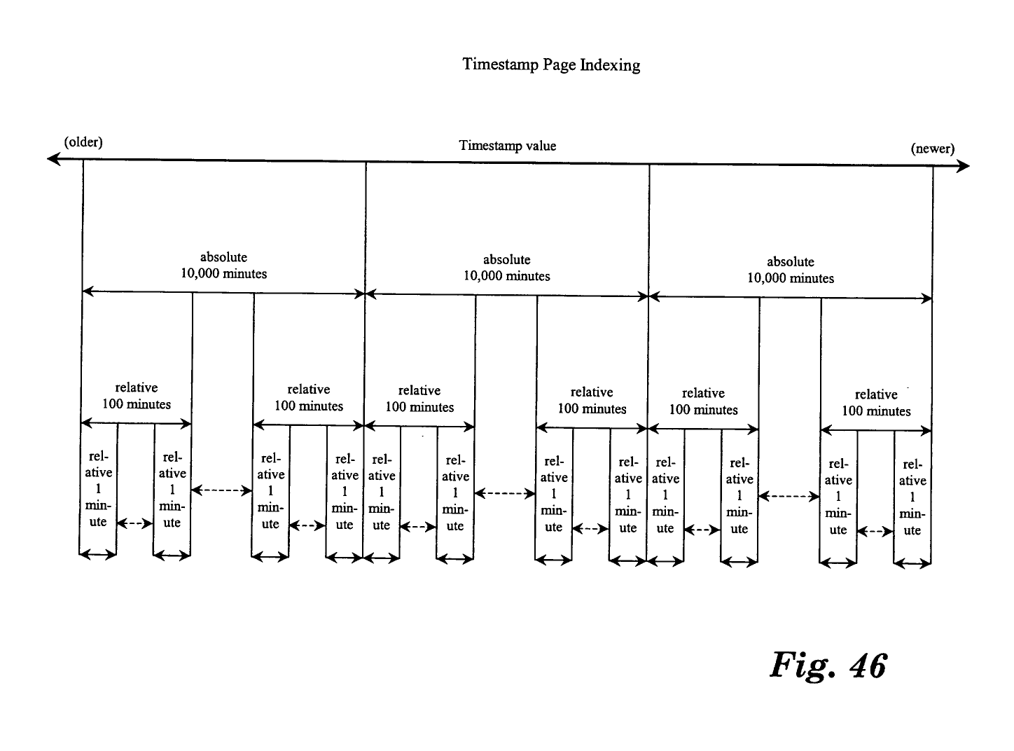

Now look at FIGS. 38 and 39 and these are examples of using the page index query to find the pages that have the data that wanted. For these examples, the sample data is going to be used that is shown in FIGS. 36 and 37. Look at FIG. 38 and notice a full text index query is wanted. All of the pages that have both words “Autocraft” and “injector” are wanted. And looking at the query expression it can be written that as a query expression of finding all pages where the index word is equal to Autocraft and the index word is equal to injector and put the index in square brackets and put the actual text looked for in quotes. Then the next thing shown is the execution of this query. And it is going to be shown with the single bit vector or a single slice that then operates within the previously described course and fine level operation. So in this case it is found to go to the index which is shown in FIG. 37 and get the index containing the list of bits for word::Autocraft. Then make the key—the attribute name is word and the attribute value is Autocraft, and combine that into the word::Autocraft key and then get the bit vector shown there, which indicates where that word is in the pages in terms of universal page numbers. These universal page numbers are the page ID's. Thus, all the page ID's are found as a bit vector that have the word Autocraft in it. Now, going back to FIG. 37 find the key word::injector and retrieve the bits associated with that, which is shown in the example. And then AND the two bit vectors together and that's the first intermediate result. And so that first intermediate result has basically ended up with l's in the position of pages, either proper or boundary pages, that have both words in them. Now wanted is to AND it with the validity, the page index validity bit vector for the word index, and that way all pages will be eliminated that weren't indexed with the full text index.

In this case all the pages were indexed with the full text index so that word validity has a one for all pages in the document repository. And that gives the intermediate results shown there. It was then ANDed with the page validity key bit vector and that's the validity that shows which pages still exist and have not been deleted. And this is where it will be seen that the page validity has zeros that reference the two page ID's that were deleted in document ID 2 which is actually 3 X's —two proper page bits and one boundary page bit and this is where the X's are disposed because they are ANDed in with zero's from the page validity bit vector, and this gives the next intermediate result that shown there. And then needed is to OR in the boundary page bits and this is done using the procedure used previously in FIG. 35 taking each boundary page index bit and ORing it into it's predecessor and successor proper page bits. So shown here is the boundary page bits for this example. That gives another intermediate result and finally end that with the proper page mask which gets rid of all the boundary bits and leaves just the bits that refer to proper pages and that gives the final results. And if the formula is used for converting bits into proper page numbers, the bits in that final results reflect page ID 2, 7 and 8 and looking back at the example in FIG. 36 it will be shown that page 2 has both Autocraft and injector in it. Page 7 has Autocraft on the bottom half, page 8 had injector on the top half so those 2 pages will be retrieved since it was considered that Autocraft and injector to be logically on the same page.

FIG. 39 shows a sample Data Index Query in this case, to find all pages is wanted for all departments except service that are for customer A15. For purposes of notation, the Query expression is written that is shown here [Dept]≠“Service” AND [Customer]=“A15”. So to do the “not equal” the bit vector is basically retrieved and NOT it or compliment it. So at the start of the query execution the bit vector is shown for the key Dept::Service where the dept is the index name and services is the data value. Then it is NOTed and that gives the first intermediate result shown. So those are all the pages in the document repository that were not indexed under Dept::Service. However, if the sample data in FIG. 38 is looked at it will be shown that some pages weren't indexed with the Dept. at all—they don't have the concept of the Dept. so now it is ANDed in with the Dept::Validity which is the page index validity key and bit vector for the pages that were indexed with Dept and it will be seen that it has a string of zeros referencing the pages of document ID 3 the first page ID 6, 7 and 8 which did not have an index department in it. So when it is ANDed in then the intermediate result is given that shows only those pages that were not department services but were indexed with Dept. Now the key and bit vector is retrieved for Customer::A15, it is ANDed in and that gives that intermediate result. Now again needed is to AND that with the validity flag, the validity key and bit vector for the customer index and that is shown as Customer::Validity. That is ANDed in and intermediate result is given and then it is ANDed with the page validity to get rid of the X's, the pages that have been deleted. And our last intermediate result is given and then it is needed to AND with the proper page mask and once it is ANDed with the proper page mask to insure that only proper (not boundary) pages come out. In this case there weren't any but if there had been included terms that mixed a work query with a data index query then there would be some boundary pages there so ending with the proper page mask eliminate those and then use the same calculations used in the previous example for converting the bit number to a page ID and find in this case that the final result is Page ID 1. Thus, page ID 1 is the only page that is a department other than service and customer A15.

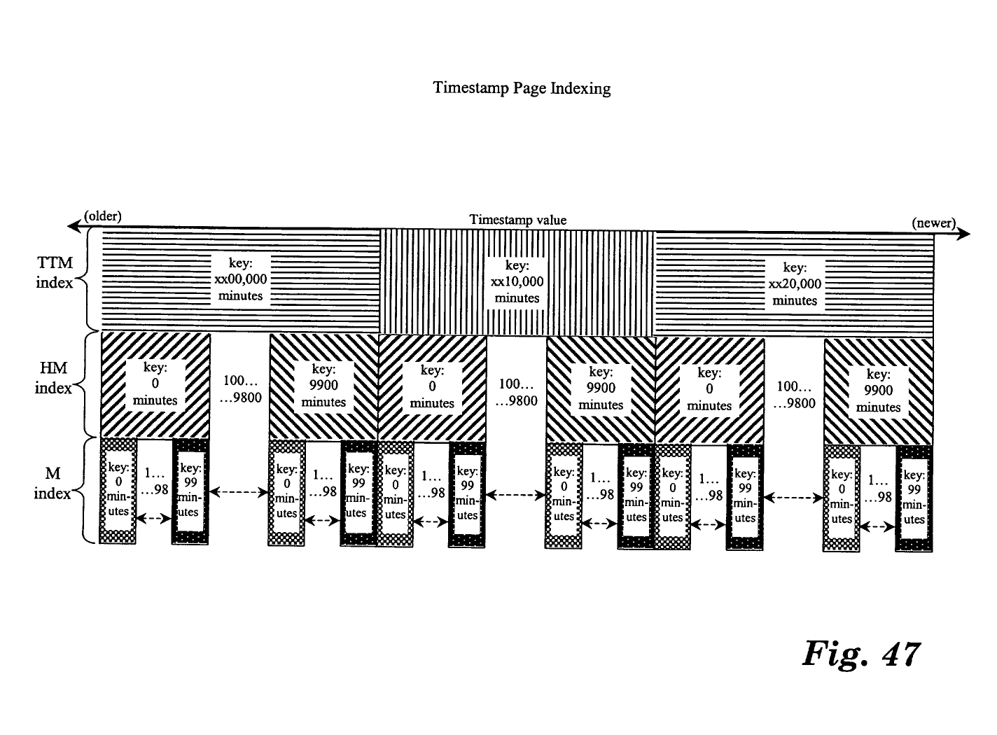

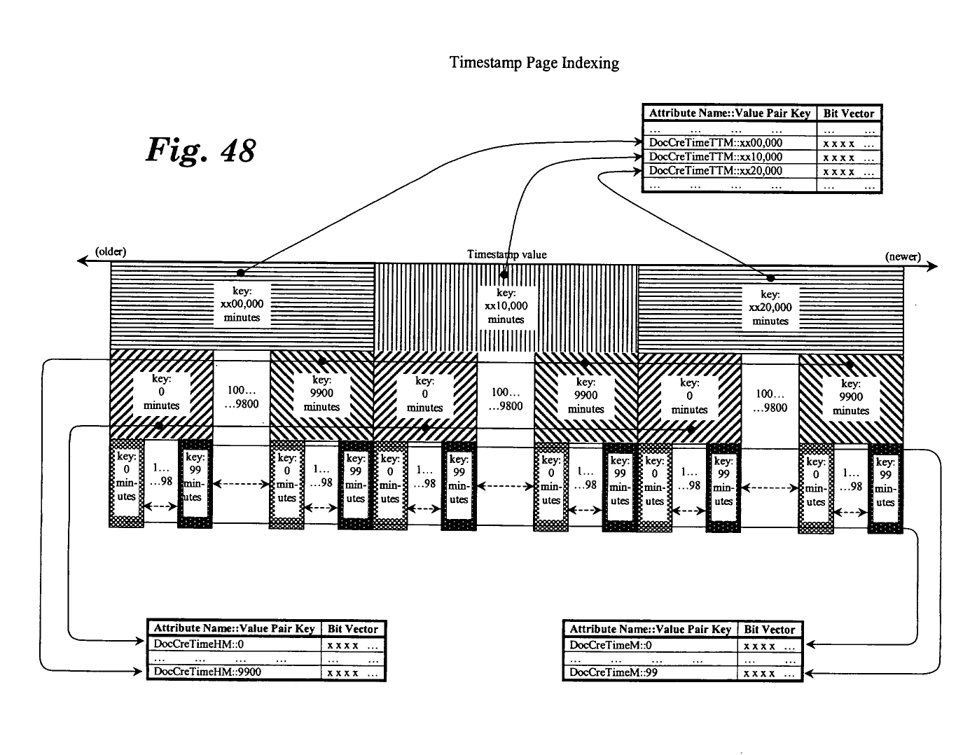

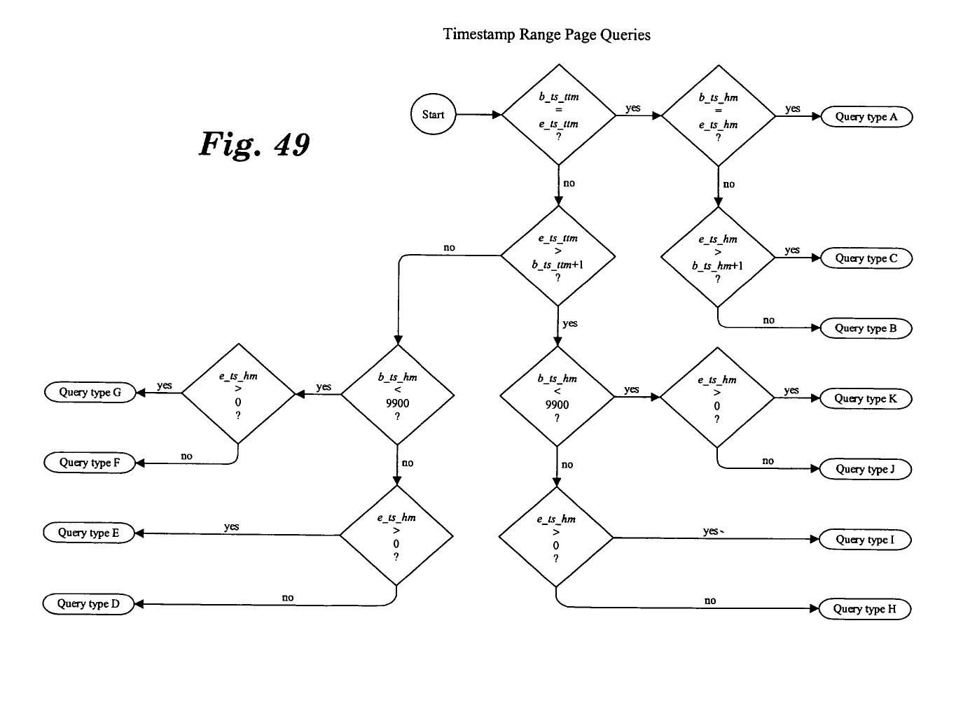

There will now be described a technique to convert from the page ID or the universal page ID's gotten as a result of processing the queries into an actual document number and page number or relative page number within that document. FIG. 40 shows the initial document table and this is a table that has an entry or record for every document that is being captured or that has been captured and among other fields that has the document ID, the page count that has the number of pages, the starting page ID assigned to this document, and the ending or the page ID assigned to this document. When the document is captured the Start Page ID and the Stop Page ID are zero and this is done because the numbers have to be continuous but it is possible for multiple documents to be captured at the same time so that it could get a page for document ID 1 then 10 pages for document ID 3 then a couple more pages for document ID 1 and it is impossible to assign contiguous page IDs in that process. So as a result, looking at FIG. 41 which shows the page table that will be seen in the page table, which is where the pages are being stored as they are being captured, for each page there is a record in this table and among other fields we have a document ID and the page number, not the page ID, but the page number which is the relative page number within that document. And again, as just mentioned, it would be impossible to assign contiguous page ID's to a given document because the pages for multiple documents are all coming in interleaved. So again, if going back to FIG. 40 it will show that when the document is initially captured the document ID is assigned and the page count is determined at the end of the capture, but the Start Page ID and the Stop Page ID are left set to zero. And then FIG. 41, the page table, shows that when the pages are captured they are stored with the document ID and the relative page number in that document, not with the page ID. Then once the document has been indexed part of the indexing process and actually one of the very early steps to the process in indexing the document is to assign the Start Page ID and the Stop Page ID since at the point that this is done, the document has been completely captured and it is very easy to do this and the document table is looked up and the page count can be looked at and the next available Start Page ID is given or assigned and there is a sequential counter kept in the system and then the Stop Page ID is equal to that. Stop Page ID is equal to the Start Page ID plus the page count minus 1. FIG. 42 shows the Indexed Document Table which includes sample data based on the sample documents of FIG. 36. This shows that document ID 1 has a page count of 3, a Start Page ID 1 and a Stop Page ID 3. And document ID 3 has a page count 5, Start Page ID 6 and a Stop Page ID 10. And document ID 2 doesn't exist because it has been deleted.

Mapping from the Page ID to a document page ID/page number can preferably be accomplished by the following steps:

1. Take the Target Page ID, and use it to search the Stop Page ID index of the Document Table.

2. Find the first Stop Page ID key entry where the Stop Page ID is greater than or equal to the Target Page ID. This can be implemented very efficiently using the B-tree structure of the index.

3. Retrieve the Target Document Record associated with this key entry.

4. Compute the Target Page Number:

Target Page Number=Target Page ID−Start Page ID+1

5. Retrieve the page contents from the Page Table using the Target Document ID from the Target Document Record and the computed Target Page Number.

6. The previous page within this document can be easily accessed by simply subtracting 1 from the Target Page Number.

7. The next page within this document can be easily accessed by simply adding 1 to the Target Page Number.

8. Any page or all pages of the document can be easily accessed using the combination of Target Document ID and Page Number. The Page Count field of the Target Document Record indicates the number of pages available within the document.

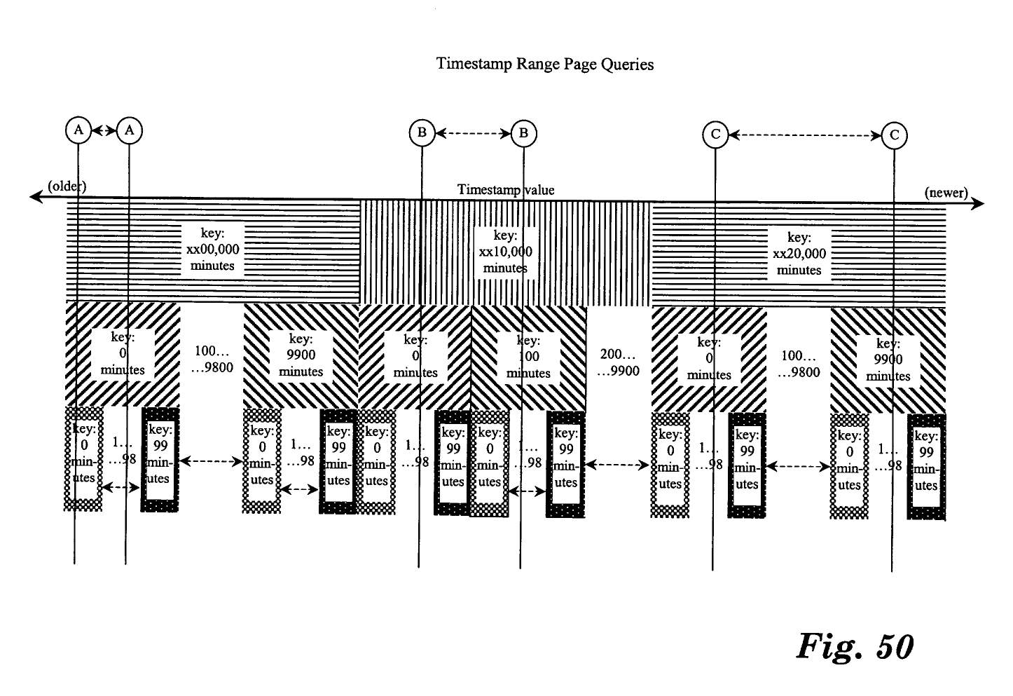

FIG. 43 shows the Final Results Page ID's, using data from FIG. 38, were: 2, 7, and 8. To process Page ID 2, Document ID 1 Page Number 2 is processed from the Page Table. To process Page ID 7, Document ID 3 Page Number 2 is processed from the Page Table. To process Page ID 8, Document ID 3 Page Number 3 is processed from the Page Table. The table in FIG. 43 shows the results of converting those logical page ID's to document ID and page numbers. And it will be seen from the table that page ID 2 is really document ID 1 page number 2, page ID 7 is document ID 3 page number 2 and page ID 8 is document ID 3, page number 3. And that is all done based on calculations given in the eight-step mapping algorithm listed above.

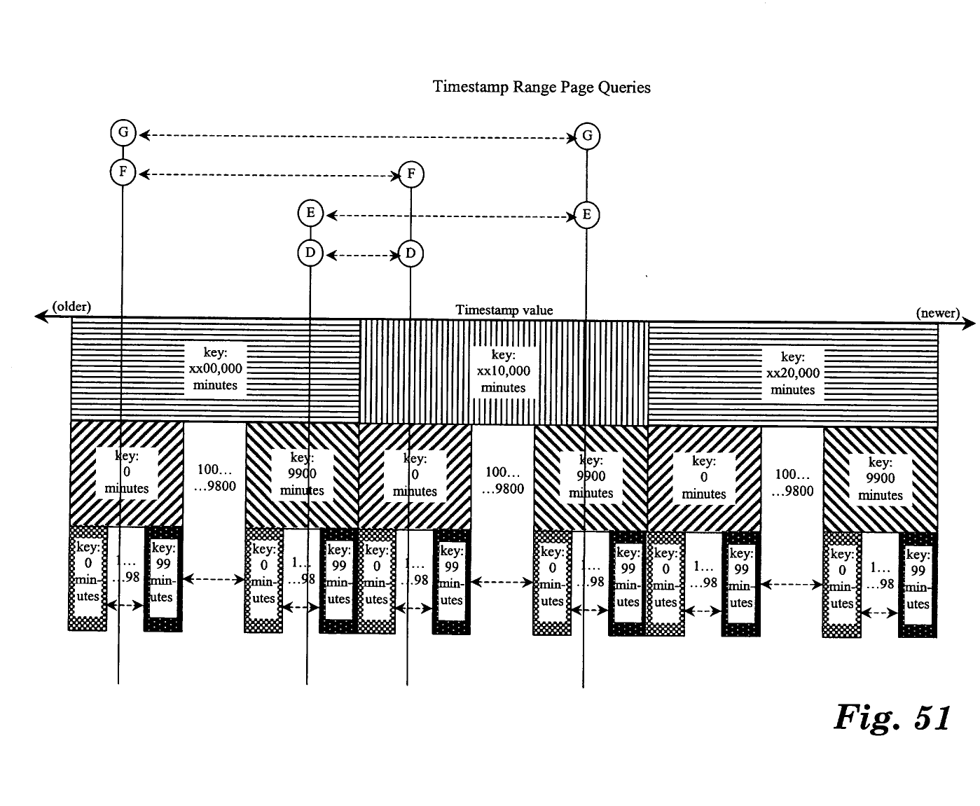

FIG. 44 shows the document indexes: Document Title, Document Creation Time, Document Creator, Document Page Count, Etc. And document indexes are indexes to refer to documents as a whole rather than individual pages and some examples have been shown of documents indexes here. We have Document Title, Document Creation Time, Document Creator, and Document Page Count. And for instance, looking at Document Title, since the title is the same for every page within the document then to index the documents is needed. So, in the example, if looking back to FIG. 36 document ID 1 the title is “Income” and the document ID 3 the title is “Leads” so if it is wanted to say find the document whose title is “Income” what is wanted is all the documents not individual pages. However, for purposes of efficiency, both in storage and in processing and simplicity there is not a separate set of document indexes, the page index method is used, simply turn on a bit for every page index bit for every page in the document. So in this case, a table is shown there and the attribute name for the document index is just a name that refers to that index so in this case in the table the two indexes are showing—Document Creator and Document Title. For the title, the attribute name is Document Title and the value in one case is Income and it will be shown that the bits turned on for the page index bits that refer to every page and document ID number 1. For title “Income”, the page index bits are set 0-4 and then looking at the document title “Leads” in document ID 3 that's page index bits 10-18 and those bits are turned on there. And although it looks like a lot of bits they are infact very compact because they are a string of contiguous one bits they will compress very well using a compression algorithm detailed above and they are very fast to set because it is known how many pages are in the document and also the start page ID from which the string of bits can be computed and just it is very simple as a single operation to turn all those bits on in a row. It is also shown in this table the document creator. If it is said that the document ID 1 was created by Alan than this shows the bit vector for Alan and if it is said that document ID 3 was created by Melissa this shows the bit vector for that document. There is no need for a index validity bit vector for these document indexes because they are applied to every page and they are automatically generated and there is no choice on the part of the user whether he/she wants to index these documents by these values or not, it is automatically done. So in that case, there is no need to have for each one of these documents indexes and index validity instead the page validity is used and the same bit vector that shown before that keeps track of which pages are present and not deleted and this is shown in that table, which is the same page validity bit vector from earlier just to show how it fits in with these document indexes. For purposes of retrieval these indexes are treated exactly the same as the data indexes shown above and a query expression can combine any sort of document index, data index and word or full text index.

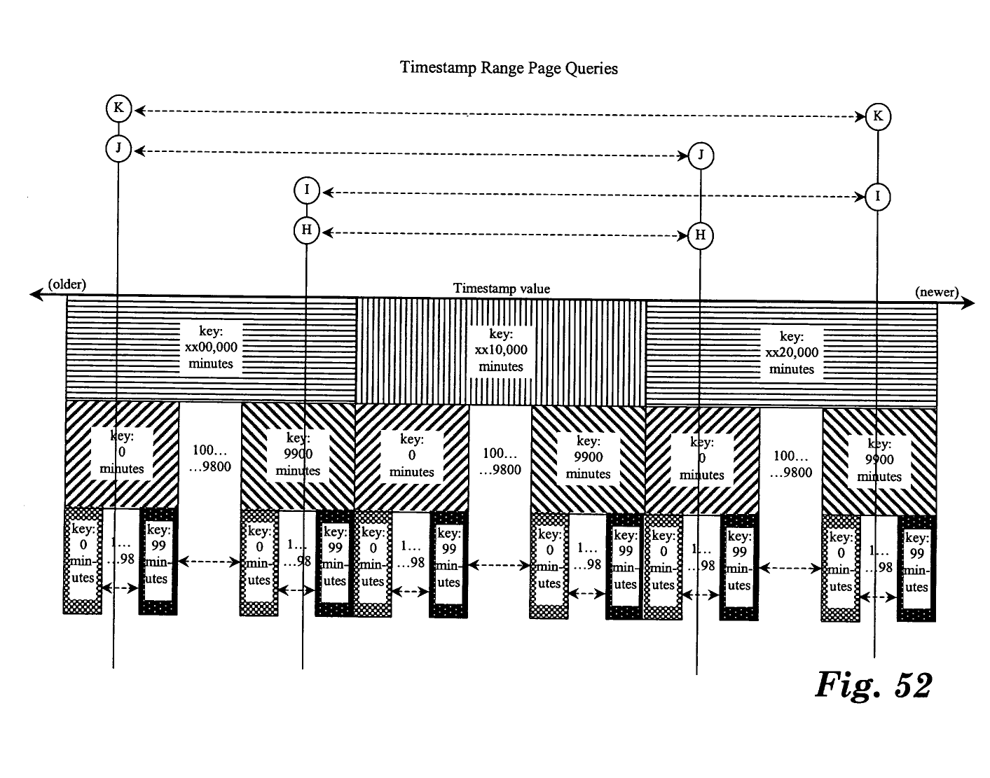

FIG. 45 shows the index data types. These are the index data types of the items that can be indexed and there are currently three types. Sting, number (which is a real number) and time stamp (which is a date in time). String are examples like document Title, the words that were indexed, if there is a data index field that has a numeric character—all of these would be string indexes. And if the B-Tree structure can handle variable length key entries then there would be a single string index which is variable length. If the B-tree structure handles only fixed lengths which for instance since it has been done in current implementation in order to provide the maximum reliability and simplicity of operation and speed of operation, then the issue is that the item being indexed could range from very short to very long and the solution to that is to have multiple types of string indexes. And it is shown here is that there is a string index data type who's length is up to 12 so that would be 0-12 characters long a length of 24 which really would be 13-24 a length of 48 which would be 25-48 characters long and they could be arranged in any manner and to any maximum size based on the data seen. That makes sense if the approach is taken that there really are multiple index data types each of which are strings with different lengths. They are a separate type but they can be grouped for processing so they'll process the same for comparison, insertion, deletion and query processing and so forth, and they will all execute the same code except with the different length of strength.

The second type is a real number. Rather than have separate integer and floating point type we a single type is drawn which is a real number which is storing floating point. It stores both integers and reals and integer just has a zero exponent. This gives simplicity because it gives a single number type, it also gives high precision. Typically, floating point on the machines today gives 52 bits of precision which is more than the typical 32 bit integer precision. But it also gives a large range because its foating point the numbers can range from very small or close to zero in magnitude to very large, with a very large exponent.

The final index data type is a time stamp which is a combination date and time. The time is stored in UCT or Universal Coordinated Time that is similar to Greenwich Mean Time that means being used is the same 24 hour clock regardless of where around the world. It is the time at the Prime Meridian. So this makes it very easy for distributor organizations that have operations in different time zones to operate in a coordinated method. In addition to being stored in UCT it is also stored in a time offset since a fix point in time (Jan. 1, 1601), rather than as a month, day, year, hour, minute and second. And the advantage of storing it as the time offset is that is makes it very easy to do calculations such as adding times, to add an hour just add an hour in, to add a year, just add however many days wanted in that year, no need to worry about a leap year. If one wants to see how far apart items occurred, just subtract it and it will give the amount of time. Since it isn't this time offset, it is basically X-amount of ticks since the fixed starting point, it cannot be viewed or it isn't really month to year however there are standard conversion routines that can convert from this time offset format in the month to year and convert back. It is a very high resolution, the time stamp is a 64 bit number and it stores the time to a unit of 100 nano-seconds, which gives a very high resolution.

Time Stamps

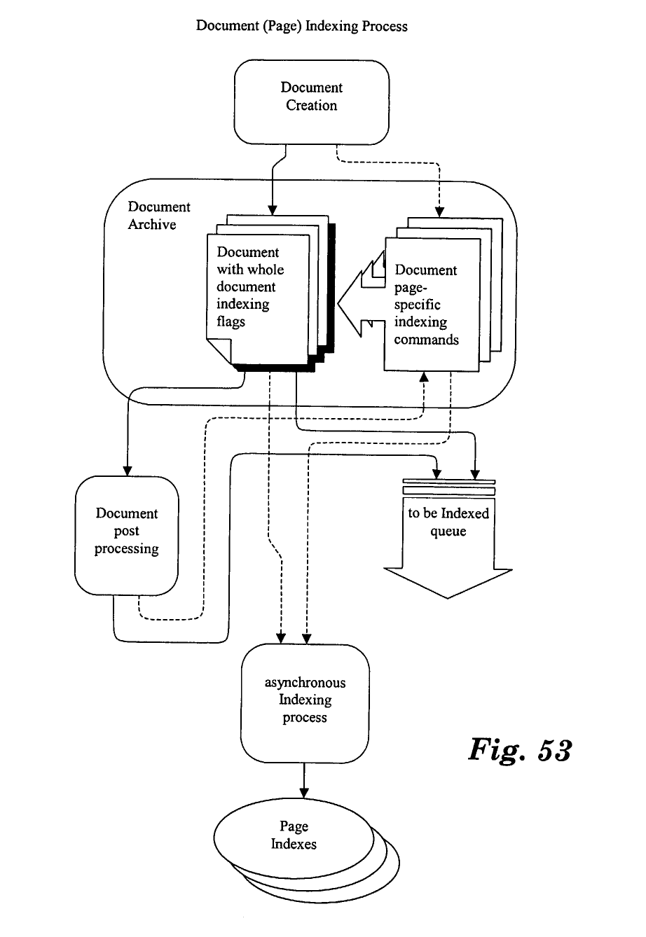

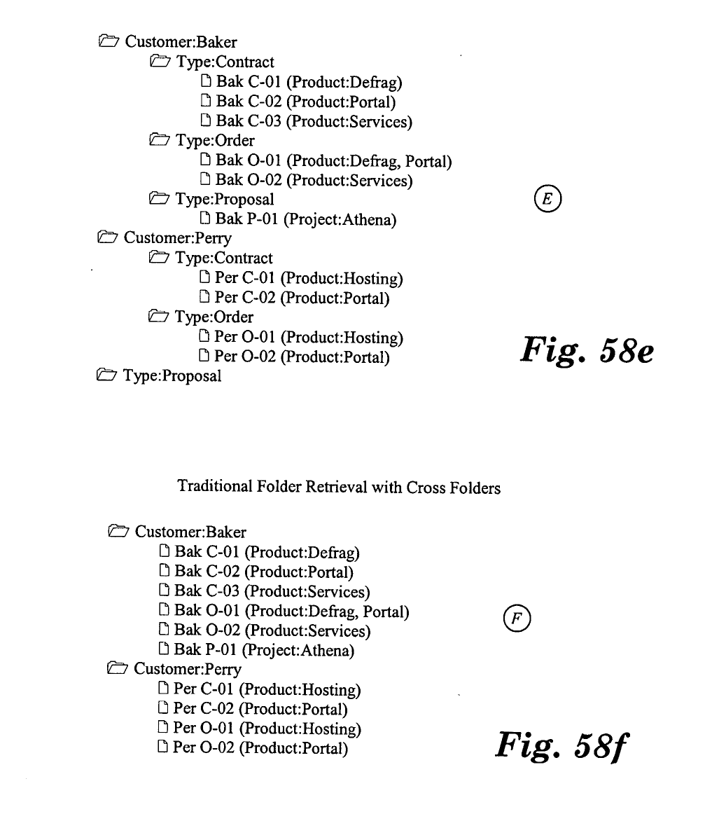

The following is a discussion of about how the time stamps are indexed, starting with FIG. 46 and going on through FIG. 52. And the issue with indexing a time stamp is really an issue of how best to handle two conflicting requirements. On the one hand a high resolution is wanted and finding all of the documents created, in just one given day, a given hour, or a given minute. A high resolution is wanted, but on the other hand the indexes should be compact as possible, and the system should provide the ability to do queries and cover a large time range very rapidly. For instance, if it was commanded to find all documents that were created between 1990 and 2000, that covers a ten year period and it is needed fairly quickly yet at the same time it may be needed to find documents created on Jan. 1 1995 between 10:15 and 10:30 in the morning so that is a small time period. Since the time stamp has such a high resolution down to the unit of 100 nano-seconds in effect almost every time stamp is unique it is very unusual to have two documents created within a 100 nano-seconds period of each other. And with the B-tree organization of the tables that really would mean that probably a very compact index would not be generated. Every document would have its own unique time stamp value which would be a separate key on the table and there might be some use of the bit vector if it had more than one page that meets that time stamp criteria. There would not be the ability to take multiple documents and multiple pages and have them all share the same key entry. In addition, if every document had its own unique time stamp value that would mean for instance the ten year query from 1990 to 2000 it would be necessary to look through as many time stamp key entries as there were documents created in that 10 year period in order to find them which could be a very large number and take a large amount of time. So the inventor has developed a method for taking that time stamp index and breaking it up into separate components and making multiple indexes out of it that can provide a resolution of a high degree and in this case provide resolution down to a single minute. Yet at the same time, providing a very compact index and a very fast query processing.

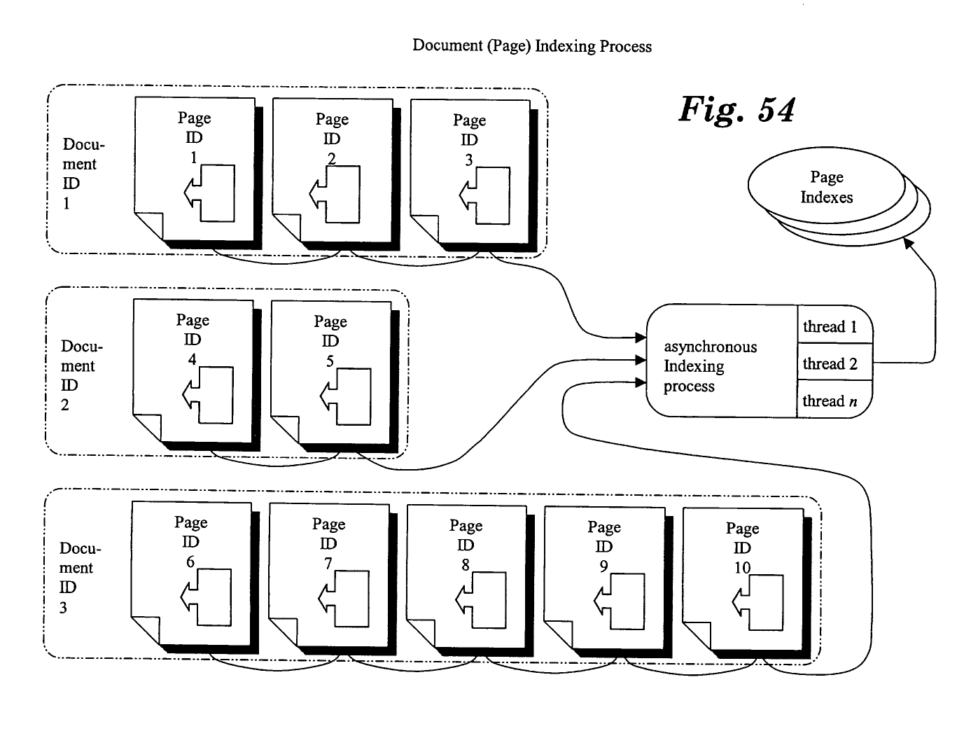

Starting with FIG. 46, it is shown how to divide up the time line and at the top to have the time line and the time stamp value to the left to show the older values and to the right the newer values and time is continuous. And again that starts with Jan. 1, 1601 and it just goes on to whatever time in the future. And what was done was to break it up into chunks or pieces of time and on the top the first division it is shown in units of 10,000 minutes and picked are 10,000 minutes, 100 minutes and 1 minutes because they are each a power or a factor of one hundred to each so they are consistent in their relationship and in addition starting with one minute that gives us the resolution down to a minute, which is more than accurate enough for all the requests being made in documents and it ends at 10,000 minutes which is roughly one week in time. Which is again a decent size, for instance, a whole year would only be 52 units of 10,000 minutes, 10 years would be 520, well within the range of ability of today's hardware to able to process very rapidly. So basically what FIG. 47 is showing is how the time line is divided. It has first been divided into units of 10,000 minutes and those are absolute and absolute means that every 10,000 minutes you start a new piece it is different and distinct from all the others just like the absolute slices. Within each absolute 10,000 minute chunk, that is broken down into relative 100 minute chunks and there are 100 of these 100 minutes chunks in each 10,000 minute chunk and they are called relative because they start with the first 100 minutes up to the last 100 minutes in a 10,000 minute absolute chunk and then in the next absolute chunk they start again with the same first 100 minutes through the last 100 minutes the next chart will make this clearer; and then finally at the third level of sub dividing this each 100 minute chunk or piece is divided into a one minute piece so there are 100 one minute pieces in each 100 direct minute piece and these are also relative so that they range from minute 0 through minute 99 and then in the next 100 minute piece again they go from 0 through 99 and the purpose of this is so that instead of indexing it with one absolute time stamp value it will break the time stamp into one absolute and two relative values—an absolute 10,000 minute value, a relative 100 minute value, and a relative one minute value.

FIG. 47 shows how these three indexes are associated with the way the time line is broken up, on the left there are the three indexes from the top, the bottom the TTM is the 10,000 minute index, the HM is the 100 minute index and the M is the minute index, so anytime in the database where there is a key which is a time stamp index on page indexes its really implemented as three indexes and at the point that it is created or index a page or set of pages with the time stamp page index, it will take that time stamp value and actually index those pages in all three of the indexes. Looking at the top the TTM index, from left to right the time line sections are filled in, the 10,000 absolute minutes to give an idea of what the key values might be. The first one has some value xx00.000 so the next key then is xx10,000 minutes and the next key will be xx20,000 minutes and what happens is any time stamp that occurs anywhere between the start on the time line of the xx00,000 minutes and the end of that will be indexed with value xx00,000 minutes. In the next chunk on the TTM index anything indexed in that 10,000 minute period will be indexed with the single key value xx10,000 and in the next chunk xx20,000 and as can be seen in both the older and newer directions that each time a boundary is crossed into a 10,000 minute section a new key value is given which is basically that time stamped value for the starting 10,000 minute period. The next index HM or the 100 minute is different and remember they are relative, so within the first 10,000 minute period any time stamp that occurs within the first 100 minutes will be indexed with the key 0 minutes, and what is shown here is that it does not matter if its in the first 10,000 minutes or the second 10,000 or the third in other words whether xx00,000 or xx10,000 or xx20,000 minutes. Anything that occurs within the first 100 minutes of any one of those chunks will be indexed with the key 0 minutes. The next key value is 100 minutes on up through 9800 minutes and then the last the key for the last 100 minute index is 9900 minutes and then everything that occurs within that 100 minute period is indexed in the HM index with the time stamp of the starting of the 100 minute period it is in. And then finally the last index the M or the minute index again it takes every time stamp 100 minute period breaks it up in 101 minute periods and then everything occurring within that one minute period is indexed with a key equal to the minute number so everything in the first minute of the 100 minute period is indexed with key 0 minutes the next minute is one minute up to 98 minutes and the last minute in each 100 minute period the key is 99 minutes and then on the next 100 minute period it is started again with the key of 0 minutes and that continues on to every 100 minutes and obviously every 100 minutes repeats for every 10,000 minutes.

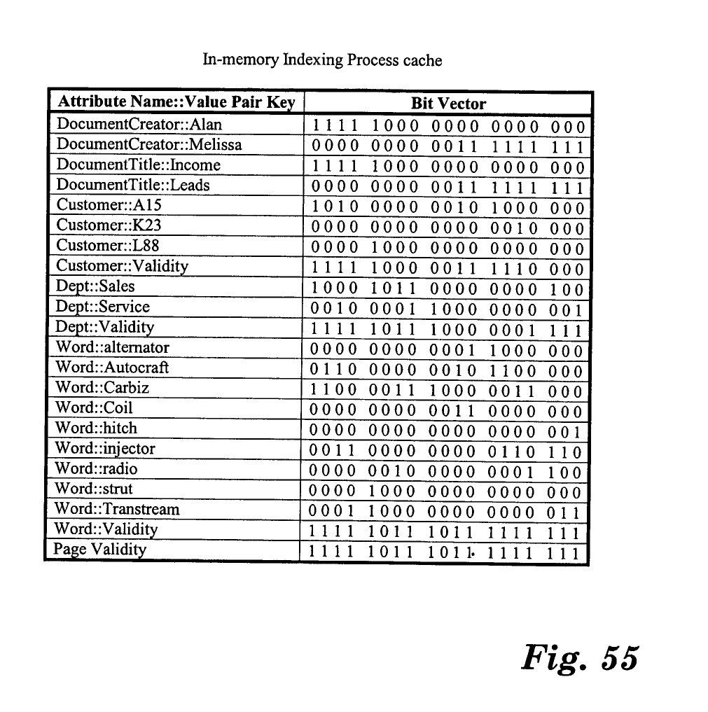

FIG. 48 shows how the various parts of the time lines are then mapped into entries in bit vector index tables. Starting at the top it shows for the TTM table there is a separate key entry if the key is document creation time used in this example, then there will be a key entry of document creation time TTM and that's the Attribute Name, doc creation time TTM and the absolute value is xx0000 and then associated with that will be bit vector of all the pages that are indexed in that 10,000 unit period. The next entry is doc creation TTM::xx10,000 and it has the bit vector of all the documents that are created in that 10,000 minute period and so forth with document creation time TTM:: xx20,000 and on. The next area to look at on the lower left is the index for the 100 minutes and there is another table and another index and it shows that this table will only have 100 entries in it, where as the table up above (the TTM table) will have an arbitrary number of entries. Every 10,000 minutes there will be a new entry and, in the table on the lower left, the 100 minute table only has 100 entries because there are 100, 100 minute chunks in every 10,000 minute chunks, and it shows if the line is followed the first key there is document creation time HM::0 that's everything in the zero hundred minutes and if the line is followed back that shows that every key in the drawing up above, every forth hundredth minutes of every 10,000 minute period is indexed in that so that it has one key with a bit vector of all the documents that were stored in that relative 100 minute period all the way up through doc creation time HM::9900, which is the bit vector of everything occurred in the 9900 minutes, 100 minutes piece. Finally, in the lower right is the index table for the minute and again there are only 100 entries in this table because there are only 100 minutes in a 100 minute period and it starts with a key doc creation time M::0 and goes through the key doc creation time M99 and again the lines show which chunks of the time line are indexed in which item.

The following details the process by which a time stamp is indexed into these three fields.

tstamp_minutes(ts)={the number of timestamp units in ts minutes}

If the timestamp unit is 100 nanoseconds, there are 10,000,000 units in one second, and 600,000,000 units in one minute. Thus, tstamp_minutes(1) is equal to 600,000,000; tstamp_minutes(2) is equal to 1,200,000,000; and so forth.

The three timestamp indexes:

TTM: Ten Thousand Minutes (absolute)

HM: Hundred Minutes (relative within TTM)

M: Minutes (relative within HM)

To index a given timestamp ts:

1. Truncate the timestamp to a minute value:

ts=(ts DIV tstamp_minutes(1))·tstamp_minutes(1)

2. Calculate and index the TTM key:

ts_ttm=(ts DIV tstamp_minutes(10000))·tstamp_minutes(10000)

3. Calculate and index the HM key:

ts_hm=((ts MOD tstamp_minutes(10000)) DIV tstamp_minutes(100))·tstamp_minutes(1100)

4. Calculate and index the M key:

ts_m=ts MOD tstamp_minutes(100)

Thus, there is 1 TTM key/bit vector for every 10,000 minutes (approximately 1 week); 100 HM keys/bit vectors; and 100 M key/bit vectors. This provides very compact storage and fast processing over a wide range of time scales, while yielding resolution down to 1 minute.

The following are the time stamp relation page queries along with an explanation of how to do queries to find all pages that equal a given time stamps or are less than, or less than or equal to, or not equal to, or greater than a given time stamp. These queries include all of the standard relations except for range which is a special operator for efficiency again, there is no need to discuss this since the following provides all the detail needed. Referring back to method above for indexing the time stamp, the basic algorithm uses the TTM index as much possible since every entry in that index represents 10,000 minutes or almost one week, and if there is a five or ten year that will be used for the bulk of the query and then on the end points either the beginning or the ending of the query it will then be necessary to use the particular 100 minute keys that are needed on that end point or boundary and again within that boundary 100 minute period use the minute keys needed so that reduces the total number of keys and runs very quickly.

To find all pages where a timestamp-valued key bears a relationship to a given timestamp ts:

1. Truncate the timestamp to a minute value:

ts=(ts DIV tstamp_minutes(1))·tstamp_minutes(1)

2. Calculate the TTM retrieval key:

ts_ttm =(ts DIV tstamp_minutes(10000))·tstamp_minutes(10000)

3. Calculate the HM retrieval key:

ts_hm=((ts MOD tstamp_minutes(10000)) DIV tstamp_minutes(100))·tstamp_minutes(100)

4. Calculate the M retrieval key:

ts_m=ts MOD tstamp_minutes(100)

To find all pages where the timestamp is equal to the given timestamp ts, execute the retrieval query:

(TTM=ts_ttm) AND (HM=ts_hm) AND (M=ts_m)

To find all pages where the timestamp is not equal to the given timestamp ts, execute the retrieval query:

NOT ((TTM =ts_ttm) AND (HM=ts_hm) AND (M=ts_m))

To find all pages where the timestamp is less than the given timestamp ts, execute the retrieval query:

(TTM<ts_ttm) OR ((TTM=ts_ttm) AND ((HM<ts_hm) OR ((HM=ts_hm) AND (M<ts_m))))

To find all pages where the timestamp is less than or equal to the given timestamp ts, execute the retrieval query:

(TTM<ts_ttm) OR ((TTM=ts_ttm) AND ((HM<ts_hm) OR ((HM=ts_hm) AND (M≦ts_m))))

To find all pages where the timestamp is greater than the given timestamp ts, execute the retrieval query:

(TTM>ts_ttm) OR ((TTM=s_ttm) AND ((HM>ts_hm) OR ((HM=ts_hm) AND (M>ts_m))))

To find all pages where the timestamp is greater than or equal to the given timestamp ts, execute the retrieval query:

(TTM>ts_ttm) OR ((TTM=ts_ttm) AND ((HM>ts_hm) OR ((HM=ts_hm) AND (M≧ts_m))))

The following steps provide an efficient way to perform a time stamp range page query. For example this is if there is a need to say, find all pages created between Jun. 1, 1990 and Dec. 10, 1998, then it would be necessary to do a range. Now this could be done by querying to find all pages whose time stamp is greater than or equal Jun. 1, 1990 and less or equal Dec. 10, 1998. However, doing that would process many more entries than needed, in other words when said find all of these greater than given time stamp, found would be all the entries from that point forward, and when said find all entries less than another time stamp, found are all entries from that point backward so the fact is that there would be a need to run through all of the TTM keys in the database. However, by coding a special range operator it can be optimized that where it does not matter how much time is spanned in the time line for the whole database of pages, there is only need to process as much of it as is contained within the range specified. The following steps also show some initial definitions and calculations that are performed at the start of a range page request.

To find all pages where a timestamp-valued key ranges in value from a given beginning timestamp b_ts through a given ending timestamp e_ts:

1. Truncate the beginning and ending timestamps to a minute value:

b_ts=(b_ts DIV tstamp_minutes(1))·tstamp_minutes(1)

e_ts=(e_ts DIV tstamp_minutes(1))·tstamp_minutes(1)

2. Calculate the beginning and ending TTM retrieval keys:

b_ts_ttm =(b_ts DIV tstamp_minutes(10000))·tstamp_minutes(10000)

e_ts_ttm =(e_ts DIV tstamp_minutes(10000))·tstamp_minutes(10000)

3. Calculate the beginning and ending HM retrieval keys:

b_ts_hm=((b_ts MOD tstamp_minutes(10000)) DIV tstamp_minutes(100))·tstamp_minutes(100)

e_ts_hm=((e_ts MOD tstamp_minutes(10000)) DIV tstamp_minutes(100))·tstamp_minutes(100)

4. Calculate the beginning and ending M retrieval keys:

b_ts_m=b_ts MOD tstamp_minutes(100)

e_ts_m=e_ts MOD tstamp_minutes(100)

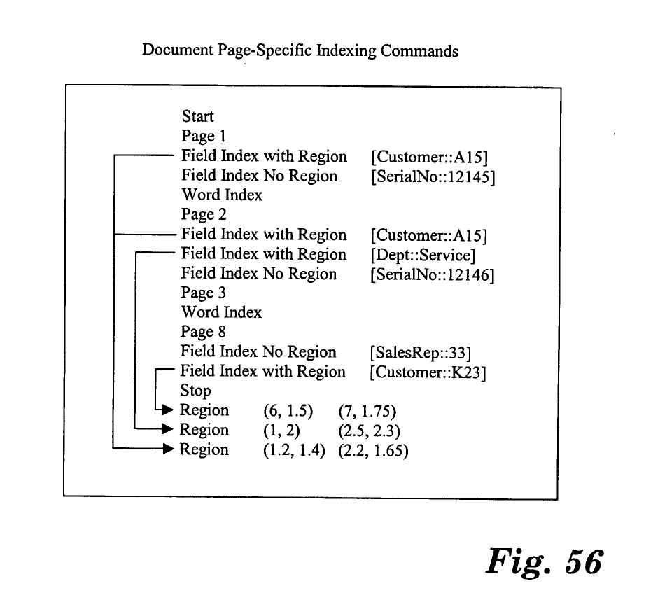

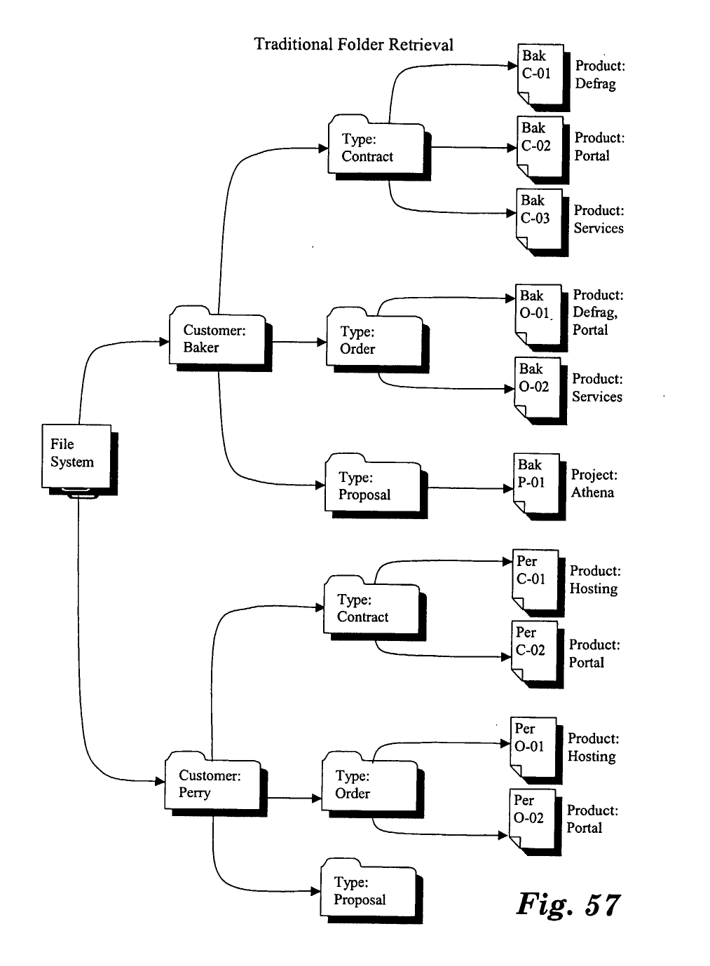

FIG. 49 is a flow chart of the algorithm used and there are 11 different algorithms to use to find the pages within a range based on where the starting and ending time period for the range fit and how they relate to each other. FIG. 49 is the flowchart that shows how to decide what algorithm to use. Starting with FIG. 50, it is illustrating some of these 11 algorithms. Query type A is a case where both the starting and ending point are in the same TTM chunk and the same HM chunk, and in that case it is needed to find items in that TTM and HM chunk and in the range of minutes or M chunks from the start and to the end of the relative minute. Query type B shows the starting and the ending point in that way to look for those two items. Query type C shows in the same TTM trunk and non-adjacent HM trunks, there are one or more HM chunks between the starting and ending HM chunk; so FIG. 50, all of these are in the same TTM chunk but with different combinations than of the sub-divisions within that.

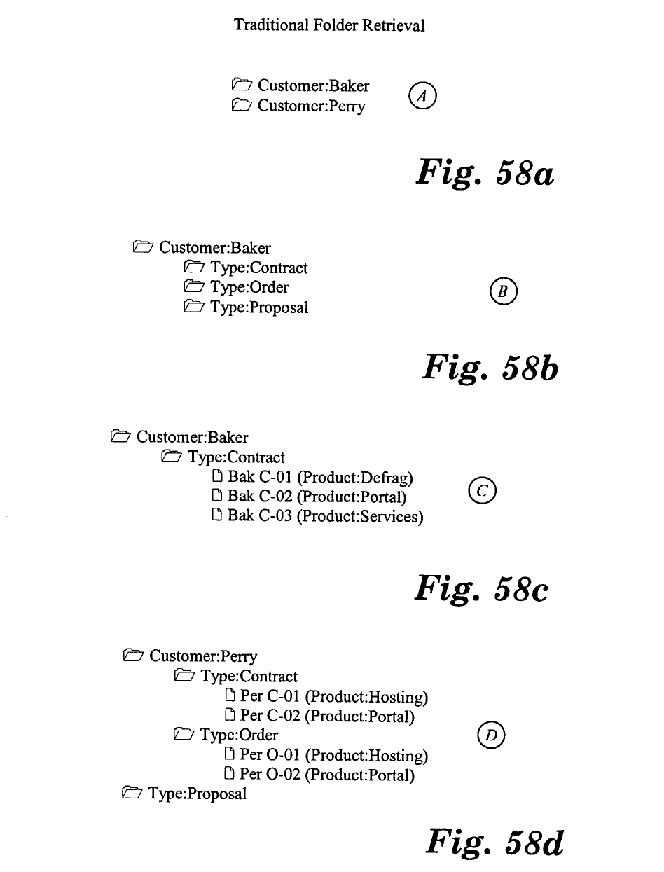

FIG. 51 shows four more query types, and in each of these query types the beginning and the ending time are in adjacent TTM chunk so query type TD the starting and ending time are in the adjacent TTM chunk, they are also in adjacent HM 100 minute chunks. Query type E they are in again adjacent HM or 100 minute chunks. Query type E they are in again adjacent TTM chunks the beginning time period is in the last HM or 100 minute chunk, but the ending time is not in the first 100 minute chunk; query type F shows that the ending time is in the first 100 minute chunk but the beginning time is not in the last 100 minute chunk, so in both query types E and F, the 100 minute period is not adjacent but one of them is in the first or the last 100 minute chunk, in query type G shows that both the beginning and ending time are not adjacent and the beginning time is not in the last 100 minute chunk, the ending time is not in the first 100 minute chunk.

FIG. 52 shows the same combinations of 100 minute locations with a non-adjacent TTM in 10,000 minute intervals so that there are one or more TTM chunks in between them so query type H has the beginning queries and the last 100 minute chunk in the ending queries and the first 100 minute chunk; query type I the beginning period is in the last 100 minute chunk, but the ending period is not in the first 100 minute chunk; query type J, the beginning period is not in the last 100 minute chunk, but the beginning time is in the first 100 minute chunk, in query type K the beginning time is not in the last 100 minute chunk and the ending time is not in the first 100 minute chunk. The following are the actual queries along with the code or algorithm that could be used to perform each of the queries A through K.

Query type A

(TTM=b_ts_ttm) AND RANGE(b_ts_m≧M≦e_ts_m)

Query type B

(TTM=b_ts_ttm)

AND (((HM=b_ts_hm) AND RANGE(b_ts_m≧M≦99))

OR ((HM=e_ts_hm) AND RANGE(0≧M≦e_ts_m)))

Query type C

(TTM=b_ts_ttm)

AND (((HM=b_ts_hm) AND RANGE(b_ts_m≧M≦99))

OR RANGE(b_ts_hm+100≧HM≦e_ts_hm-100)

OR ((HM=e_ts_hm) AND RANGE(0≧M≦e_ts_m)))

Query type D

((TTM=b_ts_ttm) AND (HM=9900) AND RANGE(b_ts_m≧M≦99))

OR

((TTM =e_ts_ttm) AND (HM=0) AND RANGE(0≧M≦b_ts_m))

Query type E

((TTM=b_ts_ttm) AND (HM=9900) AND RANGE(b_ts_m≧M≦99))

OR

((TTM=e_ts_ttm) AND (RANGE(0≧HM≦e_ts_hm-100)

OR ((HM=e_ts_hm) AND RANGE(0≧M≦e_ts_m))))

Query type F

((TTM=b_ts_ttm) AND (((HM=b_ts_hm) AND RANGE(b_ts_m≧M≦99))

OR RANGE(b_ts_hm+100≧HM≦9900)))

OR

((TTM =e_ts_ttm) AND (HM=0) AND RANGE(0≧M≦e_ts_m))

Query type G

((TTM=b_ts_ttm) AND (((HM=b_ts_hm) AND RANGE(b_ts_m≧M≦99))

OR RANGE(b_ts_hm+100≧HM≦9900)))

OR

((TTM=e_ts_ttm) AND (RANGE(0≧HM≦e_ts_hm-100)

OR ((HM=e_ts_hm) AND RANGE(0≧M≦e_ts_m))))

Query type H

((TTM =b_ts_ttm) AND (HM=9900) AND RANGE(b_ts_m≧M≦99))

OR

RANGE(b_ts_ttm+10000≧TTM ≦e_ts_ttm-10000)

OR

((TTM=e_ts_ttm) AND (HM=0) AND RANGE(0≧M≦b_ts_m))

Query type I

((TTM=b_ts_ttm) AND (HM=9900) AND RANGE(b_ts_m≧M≦99))

OR

RANGE(b_ts_ttm+10000≧TTM ≦e_ts_ttm-10000)

OR

((TTM=e_ts_ttm) AND (RANGE(0≧HM≦e_ts_hm-100)

OR ((HM=e_ts_hm) AND RANGE(0≧M≦e_ts_m))))

Query type J

((TTM =b_ts_ttm) AND (((HM=b_ts_hm) AND RANGE(b_ts_m≧M≦99))

OR RANGE(b_ts_hm+100≧HM≦9900)))

OR

RANGE(b_ts_ttm+10000≧TTM ≦e_ts_ttm-10000)

OR

((TTM=e_ts_ttm) AND (HM=0) AND RANGE(0≧M≦b_ts_m))

Query type K

((TTM =b_ts_ttm) AND (((HM=b_ts_hm) AND RANGE(b_ts_m≧M≦99))

OR RANGE(b_ts_hm+100≧HM≦9900)))

OR

RANGE(b_ts_ttm+10000≧TTM ≦e_ts_ttm-10000)

OR

((TTM =e_ts_ttm) AND (RANGE(0≧HM≦e_ts_hm-100)

OR ((HM=e_ts_hm) AND RANGE(0≧M≦e_ts_m))))

This is the end of the time stamp indexing and query, which in summary provides very accurate down to the minute level accuracy for indexing and retrieving of pages but it also provides very, very fast query over large time stamp ranges with this one minute accuracy.

Document End Page Indexing Process

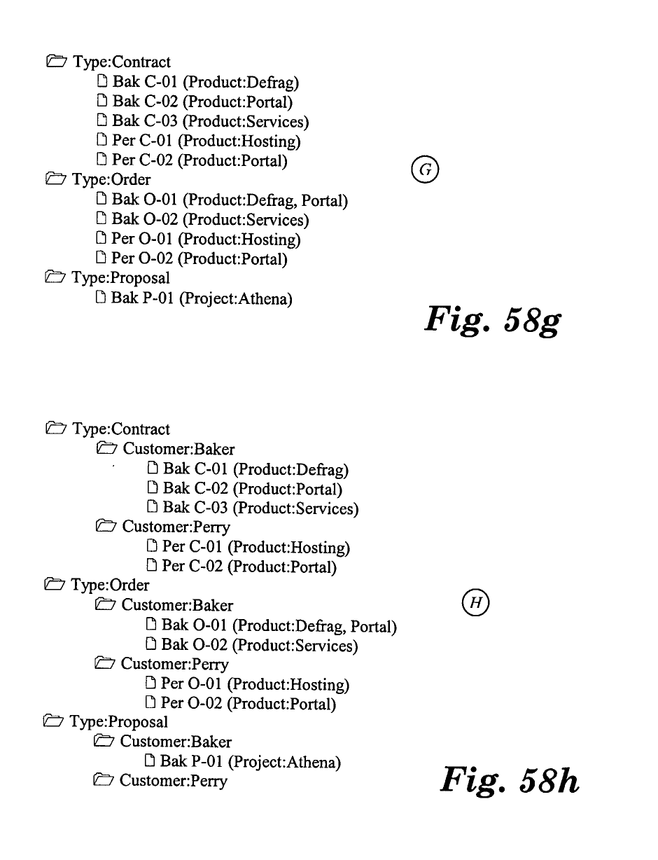

A schematic of the page indexing process is shown in FIG. 53. The flow of a document throughout the indexing process is shown by solid lines, whereas the flow of data and information is shown by dotted lines. Thus, when a document is created, it's immediately created within the document archive. Located at the left side of the document archive box, the entire document is available with document indexing flags. As soon as a document is placed in the archive, it is available for viewing, printing, etc. The document is also then available to be indexed, or for other purposes before it is indexed. The document indexing flags indicate the type of document indexing to be applied to the whole document. For instance, if every page is to be indexed with full text or the full page indexing, a flag will be placed at that point stating that the document is intended to be indexed with full text indexing. Another flag is available that states that the document must be indexed with general document indexes that apply to all documents, such as document title, or document creator.

The right hand side of the archive box shows how the document creation process can also create any number of document page specific indexing commands. These commands do not apply to the entire document, but rather to a specific page. For example, you may want to index page one with department sales and page three and ten with a customer name or customer number. There is a set of page specific indexing commands that are separately stored. This is because these commands are not a part of the document and, thus, can be created by the person who creates the document. Furthermore, these commands can be added and created by document post processing.

Following the solid line in FIG. 53, the document, from the document archive, can be queued directly into the “to be indexed queue,” which is the queue that contains a list of all documents that need to be indexed. A queue is used here because more documents may be created in an abundance of activity and thus, can be indexed at the same time, which provides a queue with a list of everything that must be indexed. That queue is processed near the bottom of the document by the asynchronous indexing process as quickly as it is processed. This is so that the document, when created, can be immediately queued to be indexed.

A dashed line running from the left hand side of FIG. 53 to the document post processing box shows the document post processing. Sometimes the document creator does not specify what must be indexed as the document is created. The document post process, which are programs built by the user's site, process individual pages or portions of documents to decide what else should be indexed. A dotted line, in the document post processing, shows that the document page specific indexing commands will build a set of commands. Either the first set of page indexing commands for this document, or a new set, is created. These commands follow the solid line when it has completed post processing. Thereafter, it goes to the index queue where it is queued for indexing. Thus, a document is produced that developed through the creation process and can immediately be queued for indexing. Additional indexing can also be added upon going to a document post processing process. The document can also be queued for the “to be indexed” queue.

In the “to be indexed” queue, the queue is processed by an asynchronous indexing process, which is a task that runs asynchronously from the rest of the process. This indexing process reads the task list from the “to be indexed” queue, which identifies the documents that need to be indexed, and it also retrieves information from the document itself, as shown by the dotted lines in FIG. 53. The asynchronous indexing process also forces document flags, located on the document, to index the whole document as well. Similar to full page indexing, the indexing process retrieves the words from each page of the document and, via the dotted line, retrieves information from the document page specific indexing commands and builds the page index, shown on the bottom of the diagram in FIG. 53.

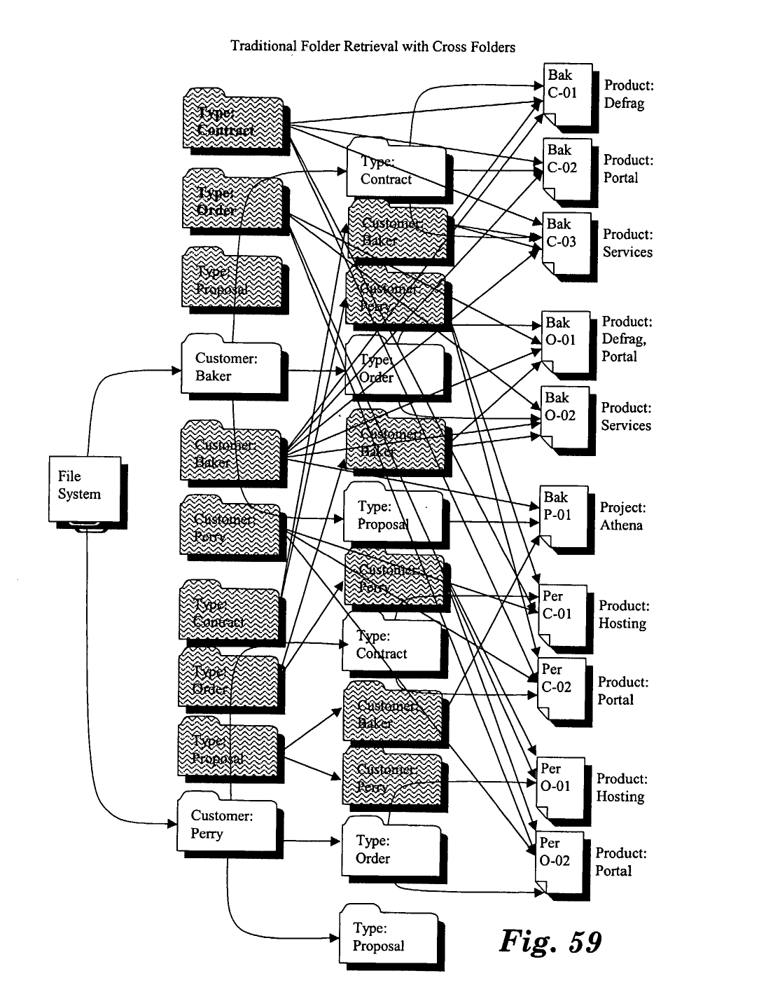

The asynchronous indexing process is shown in more detail in FIG. 54. The asynchronous process, shown on the right hand side of the Figure, is broken into multiple threads, in variable numbers. By using threads, more than one document can be indexed at a time, which provides a greater throughput and is capable of adjusting itself according to the capacity of the machine based on how many threads it is running. As shown in FIG. 54, thread one, thread two, and through thread N is given, where each thread processes one document. Thus, three documents will be indexed in parallel; document ID 1, document ID 2 and document ID 3. The indexing process reads a document, page by page, as well as the associated document page specific indexing commands to build the page indexes. If there is full text indexing, the actual document pages will be read. Otherwise, the pages need not be read. Furthermore, the presence of any document page specific indexing will allow the process to read those commands for each page. Again, if there is no document page specific indexing, the document is not read. This, essentially, is document level processing (i.e., indexing the name of the document and the creator). In these cases, the process does not have to read the pages, it just knows how many pages there are and assigns, for example, the document creator to every page ID in the document range, etc. Generally, however, the process does both full text and document page specific indexing. Each page is read, as well as the related document page specific indexing commands, in order to form the lowest page ID to the highest page ID They are then built into the page indexes. This process should be made as quickly as possible because a large number of pages are going to be indexed.

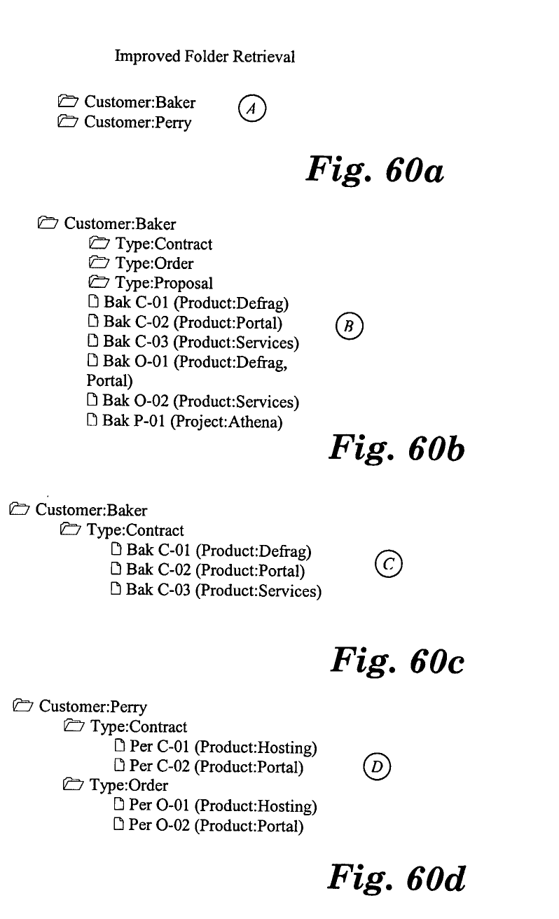

Caching, which contributes proficiency and speed, and implemented within the asynchronous indexing process of FIG. 54. FIGS. 36 and 44 provide the data used to build the process in FIG. 54. The “In-memory” indexing process cache is shown in the table shown in FIG. 55. The In-memory indexing process cache is an internal memory cache built and maintained by the indexing process program while processing the documents and building the indexes. In this case, the attribute name and value pair keys are those that were shown in FIGS. 36 and 44, where the associate bit vectors are the bit vectors that were built in these foregoing examples. An example having two document indexes, the document creator and two cases, one being Alan and the other Melissa, there are various bit vectors associated with each one, as well as the document title attribute name, such as the document title of Income and the document title of Leads, where the associated bits references those pages. As discussed previously, no validity bit vector is available for document indexes because they used page validity bit vectors.

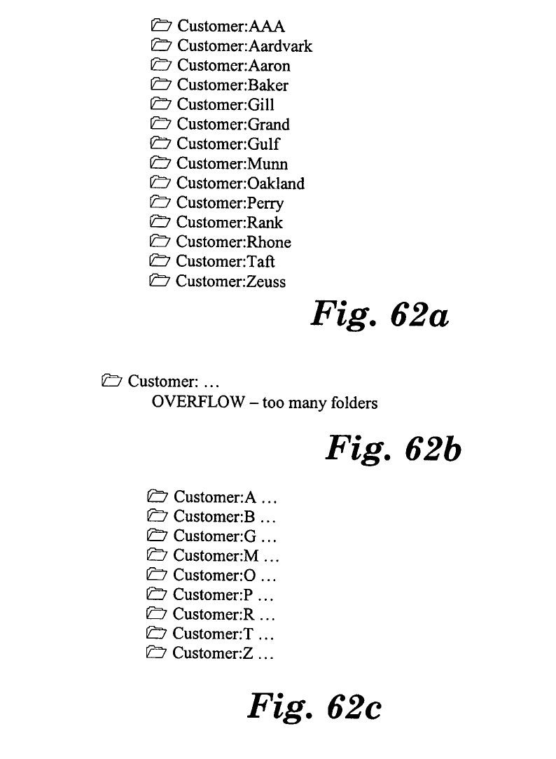

Data indexes are also provided. For these customer data indexes, four values (A15, K23 and L88) are given along with the index validity bit vectors for the customer data index that identifies which pages were indexed for that specific attribute. Also provided is the department data index, with the value of sales and service, as well as the index validity for the department. Furthermore, various word indexes and the word alternator (as shown in this example, are provided as well. Thus, the word Autocraft, Carbiz, etc. up to the word Transtream, followed by the index validity bit vectors for the word index, will be provided. At the end of the process, the page validity bit vectors for all of these indexes are given. These bit vectors are, actually, for the documents that are being processed and this is where the page validity bit vectors is built. For purposes of speed, these vectors are kept in memory, but for table provided for in FIG. 61, each one bit, traditionally, would be a separate update to the database. Using that bit, the key associated with it would have to be found and then search through the index available in the database. A transaction would then be started, but to initiate that, more speed would be required.

The present invention keeps all bit vectors in memory and are not flushed until any of the four cases is used. Cache entries flushed when:

1. At end of slice (8000 bits/4000 pages).

2. To-be-Indexed queue is emptied.

3. Attribute Name::Value Pair Key is untouched for a period of time.

4. Cache memory becomes exhausted.

The Page Validity entry is flushed last, only after all other indexes are flushed and an entire document is indexed. Since the Page Validity bit vector is ANDed in with all query results, this prevents queries from operating on partially indexed documents. The first case is found at the end of a slice, where the slice is 8,000 bits, or 4,000 pages, since 2 bits per page are being used. In the case of a large document and a slice boundary is crossed, the document will be flushed due to the design of the page IDs. Once a slice boundary has been crossed, the bit vectors for the previous slice will never have to be changed.

In the second case, if the “to be indexed” queue is empty and if the asynchronous indexing process has processed all of the entries and emptied the queue, the documents will be flushed right away.

The third case focuses on when an individual attribute name value pair key is untouched for a period of time. For example, there may be a customer number, such as customer L88, and some pages may have specified customer number L88 is a key, and then the bit is turned on. However, if a large number of documents started indexing that do not have the customer key or do not have customer L88, the asynchronous indexing process, after a while, will no longer allow the entries to be active and, thus, will flush it out to make room for other new entries.

In the fourth case, if the cache memory becomes exhausted, the indexing process configures a certain amount of memory based on system size and capacity for this cache. Once that memory becomes exhausted, the process will then start flushing entries to make room for new entries, the page validity index, however, is flushed only after all other indexes for the documents within the page validity bit vector are flushed. This eliminates the possibility of a user doing a query based upon partially completed indexing because either the indexing has not been completed and only some of the entries have been flushed, or the index is completed but not all entries have been flushed. A query should be done until indexing on a document has been completed and all of the indexes have been flushed. As a separate last step, the page of validity bit vector would then be flushed. Because the page validity bit vector is “AND”ed in with all query results, queries from operating on partially indexed documents is prevented until the page validity bit vector is flushed. None of the other bits will be turned on because they are “AND”ed with a zero bit for the page validity bit vector.

Cache entries can be flushed by performing a four-step index merge operation:

1. The basic unit being merged is the Attribute Name::Value Pair Key with its associated bit vector

2. Multiple basic units are combined into one index merge operation for increased efficiency.

3. If the Attribute Name::Value Pair Key does not exist in the page indexes it is created, along with the bit vector from the Indexing Process cache.

4. If the Attribute Name::Value Pair Key does exist in the page indexes the bit vector from the Indexing Process cache is ORed into the existing bit vector in the page indexes. This merges the indexing results from the pages currently being indexed with the results from pages already indexed with the same Attribute Name::Value Pair Key.

For all steps, the basic unit being merged is the attribute name::value pair key with its associated bit vector. Multiple basic units are combined in the one index merge operation for increased efficiency, where the words are strung together into one command that then goes to the database indexing machine. For the database update machine, if a new attribute name value pair key is used (e.g., if this is the first time Customer::A15 has been seen for this slice), this entry is created in the B-tree with its associated bit vector. If this attribute name value pair key already exists, then the new bit vector is simply “OR”ed in from the cache with the existing bit vector already in the database. Thus, for example, if an entry is already in the database in the page indexes for Customer::L88, this slice would include it and then that bit vector would be loaded. The new bit vector would be taken from this indexing process and then be “OR”ed in. Typically, these bits will be one bits in the cache, whereas there are zero bits in the page index and zero bits in the page index. There will also be zero bits in the cache where one bits already exist. Thus, new pages, that have not been indexed before (that portion of the bit vector in the database in the page index will be null), are being indexed.

The process also allows re-indexing of anything at any time. A document can be taken to the viewer and told to “re-index it” with full page index. Although it may not known that the person has already been indexed in that fashion, or the document post processing, as shown in FIG. 53, can be run any time at a later date. The post processing can be initiated, either manually or automatically, tore-index a document that has already been indexed. So long as the bits are already set, nothing will be effected if new items that were indexed in different way. They will simply be added to the page index so that the new attribute, as well as what exited beforehand, can be searched.

Advantages Of This Document Page Indexing Process

There are several advantages to the document page indexing process:

1. No indexing delay before processing, viewing, printing, or distributing the document.

2. Indexing Process is a background task running at lower priority than foreground tasks.

3. Indexing process is highly scalable.

4. Indexing process is re-doable any number of times, providing a very robust index. Corrupted or damaged page indexes can be deleted and rebuilt at any time without loss of any indexing. Page indexes can be rebuilt online in parallel with other processing.

5. Page indexes are built by slice, not document or page, providing very efficient processing tuned to the organization of the page indexes.

6. Page index updates from different documents are consolidated into single bit vector updates for very high speed and efficient processing of large numbers of documents and pages.

Elaborating on these advantages, first, there is no indexing delay before processing, viewing, printing or distributing the document. As shown in FIG. 53, the document is first placed into the document archive, the place where the document is processed, viewed, printed, and distributed from. Since the document enters the document archive the instant it is created, the steps take place even before the document is indexed. This prevents other people from being able to view, distribute or print their documents when a large number of large number of indexes specifying a lot of full text indexing is taking place and the indexing task falls behind.

Second, the indexing process is a background task running at lower priority than foreground tasks and, again, this prevents heavy indexing load from hurting performance for printing, viewing, and querying. Furthermore, the indexing process can run at a lower priority because it is a background task. It will use whatever processing time is available on the machine.

Third, the design of the indexing process is highly scaleable. Based on the processor capability, any number of threads can be used that can take advantage of the processing to actually execute the indexing. As such, more and more documents can be made in parallel. The size of the memory on the system is used to determine the In-memory indexing process task and the more memory that is available, the faster it will index, a fewer number of databases will have to be indexed, and number of multiple documents indexed together increases as more processor and memory is made available. This then further increases the efficiency.

Fourth, the indexing processing can be re-done at any number of times, which provides a very robust index. If an index needs to be re-built, the documents can simply be re-run through the asynchronous indexing process, where they will be indexed again without any loss of information. Thus, neither the document creation process nor the document post processing will have to be re-run. Actually, neither of the processes may be able to re-run. For example, the document creation process is the execution process of the program. It may have updated the database in a way that cannot be updated again. In another example, the indexing may have been run manually and it may be desired to exclude other people from having the manually running end. The same is true for post processing, where indexing may not be easily looped again and it may not be known which steps were invoked during the process, i.e., the post process step may have been changed. It does not matter whether it was month end processing that has changed in the years since the document was originally run through it because all of the information needed to re-build the index is contained within the document itself with whole document indexing flags and within the associated document page specific indexing commands. Those are stored in the archive and are not affected by anything that happens to the creation or post processing steps. Furthermore, corrupted or damaged page indexes can be deleted and re-built at any time without loss of any indexing page. Moreover, indexes can be re-built on-line in parallel with other processing.

Fifth, page indexes are built by slice, not by document or page index, resulting in very efficient processing. The page indexes are tuned to the organization of the entire process of the present invention to the way the page indexes, bit vectors, and the B-tree work. They operate most efficiently on a slice level and the page indexes are actually being built on a slice level.

Sixth, the page index updates, from different documents, are consolidated into single bit vector updates for very high speed and efficient processing of large numbers of documents and pages. A large number of individual documents may be generated, but they are not treated as individual steps that are separately examined and indexed. They are, instead, pulled into one indexing process, specifically the memory indexing processing cache, which provides a very high speed. They are then consolidate and placed into one update to the database. This is actually inserting the results of indexing of many documents and many pages.

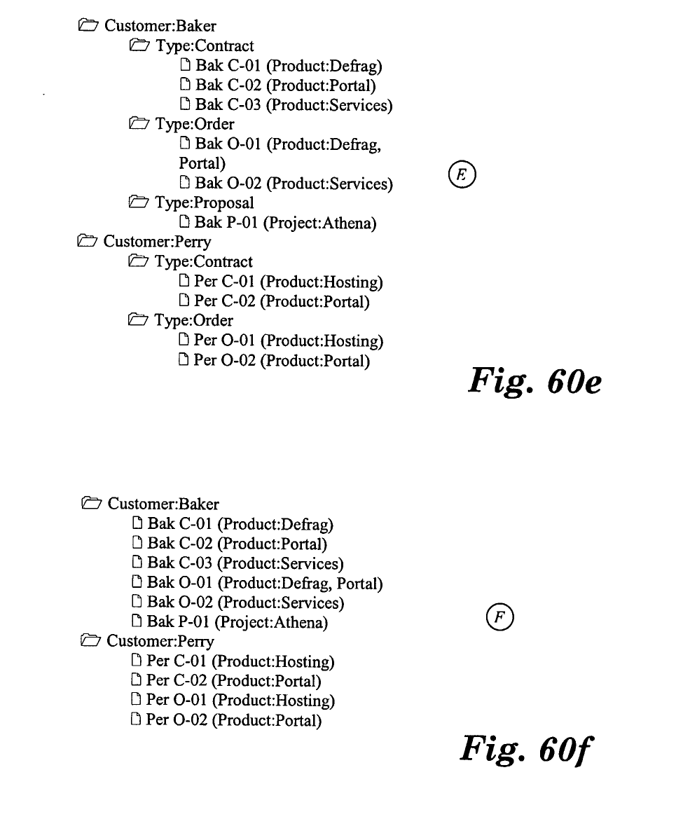

The document page specific indexing commands are shown in FIG. 56. These are created either as part of the document creation process or as part of the document post processing processes. As seen in FIG. 53, there is one set of document page specific indexing commands for each document. FIG. 56 shows how within each document, the contents of these commands are broken down by page. This is the data that is then taken in to the asynchronous indexing process, along with the document, for full text indexing to create page indexes. This process is basically a series of micro op codes or commands. Using a start command first, a command is provided that indicates what page you are working on. In this example, page one, two, three and eight is given and then a stop command. Following the stop command, there are a set of regions that identifies regions on the pages where data indexes were used. On page one, there are three kinds of sub-commands within a page, a field index with regions. In the first example, it is shown, using the customer field index, the value is A15 that stores the name of the index and the value is stored with this op code. Because this is a field index with region, there is a pointer to the end of the table where the region where the customer number was taken from on the page is stored. The region is a rectangle, and in this case, it is shown with the co-ordinates of the upper left and the lower right corner, assuming that the origins are in the upper left hand side of the page. For example, if the customer was taken from a region on pages one and two, the customer would be taken from a region that the upper left corner was on one point two units across and one point four down from the top of the page. The inch length is assumed, as well as the lower right being two point two inches over and one point six five inches over. Multiple pages can share the same region location to optimize if you are picking the same location off multiple pages it uses the same region in the document page specific indexing commands. Referring to page two, a field index is shown with a region for customer A15 that points to the same region. On page eight, there is a field index with a region for customer number K23. This region, however, came from a different spot on the page so that it points to a different region entry in the table. Referring again to page one and to the field index with region, a field index with no region is given. This is for data that has not been taken from the page, but is passed as metadata (i.e., data that the document creator or the document post processing has said should be indexed on this page but is not really taken from the page). A field index with no region is provided and, in this case, it has the serial number 12145. A word index command is also given, which says that the page to be indexed with the full text indexed is desired. This is only necessary only if a decision is made on a page by page basis. For the whole document full text index, a separate command to the document header that just says index the whole document is provided.

Referring again to page two, a couple of field indexes with regions for customers and department number provided and then a field index no region for serial number is given. On page three, there is only the word index command. On page eight, there is a field index no region for sales rep and a field index with region for customer. Finally, there is the stop command and then all the regions that were used in this document are provided.

The purpose of the regions is so that when a page is viewed, regions that were used as indexes can be hi-lighted so that when the page is loaded, e.g., page two of this document, the document page specific indexing commands can be used. This method is very easy and organized so that the page can be easily located. For two sub-commands, the two field indexes with regions would be found in the region part of the table by obtaining the co-ordinates there and then either draw a box around or hi-light that part of the page. That gives the in-views or the feedback as to what are the indexes or what indexes were used for that data for that page.

As described earlier, all of the information necessary to index the document is created in this document page specific indexing commands entry so that, regardless of what happens to the post processing steps, the original document can be used to rebuild the indexes. These could have been indexes that were done manually by a person viewing the document by hi-lighting the area. Indexing it could be built be any number of ways, but once they are captured in this entry, they are then permanent and can be rebuilt at any time. They could also be processed asynchronously by the indexing process.

Special Retrieval Topics

Special kinds of retrieval and retrieval methods are: Combined data and full-word index queries, Wild Card, Synonyms, Word Stemming, Phrases, Near, Noise Words, and Natural Language. The first of these is the use of combined data and full-word index queries. For example, a customer number may be known and it is desired to look up only pages for that customer number. A data index for customer number is available but, within the set of pages, those pages that have the name of a city on it may be desired. But that city was not indexed, so retrieval with a combined data and forward index would be required. It would be commanded to retrieve all the pages where the customer number index equals the specific customer number sought by stating the word of the city, e.g., Detroit. This method is better than only using a forward index because if the customer number was A15, any page that had A15 in it would be found whether it was a customer number or a part number or a department, etc. that included that text. Thus, more pages would be retrieved than needed. Combining data indexes with a forward index allows a much more precise and accurate number of hits in your retrieval. The data in the forward index are implemented in the same method. It is, thus, simply a matter of ANDing the two bit vectors together to combine the data indexes. If retrieval of all pages was commanded where customer number equals A15 and the full text word equals Detroit, it would work the same as any other index.

Wild carding is a method of retrieving items where the full key is not specified that an index is to be retrieved. Rather a partial key is specified. For example, if all parts whose part number start with the letter X is desired, an index on part number may be available. However, that would have the full part number like X001, X002, A023, Q123 and so forth. Part number equal X123 could be found using the method described above, but only if all of the X's are desired. Specifically, it should be said to find all the items where part number matches and then give a pattern like X* typically used. This means that it starts with an X and then anything can follow that. The standard syntax for that typically used is * and ? marks, but any sort of syntax can be developed or other regular expressions. This would be implemented by identifying the lowest possible key value and the highest possible key value so that there is a range of key values. For example, if it is desired to find anything that starts with the letter X, the part number would range from X inclusive through Y exclusive. Thus, it starts with X followed by nothing and then you can have X with any sequence of characters until the first item in this key sequence that would not be included would be a one character key starting with the letter Z, which is the next value after X. The range operators that can be used to perform access on a key is provided above. A range left inclusive right exclusive of part number of X to Z can be done and they quickly will return everything that matches the pattern X *. Within this a fancier pattern, for example X *1 and that would say all part numbers that start with X and end with 1 and have any number of characters between them, can be made. Because the key is ordered in descending order, the entries in the key cannot include do the range or any sort of special look-up on the 1 that the matching pattern ends with because they are going to be spread. There will be A and then some sequence of characters 1, B1, C1, etc. so they will be spread throughout the whole range of keys. However, just starting with the letter X, the minimum and the maximum possible values is found and, in this case, it would be the same (i.e., it would range from left inclusive X to right exclusive Y). All of those keys would be found, but a filtering process would be added for every key that is found. It would then be checked to see if it matches the pattern. In this case, it does end with the digit one and so would be processed; otherwise it would not. The Wild card process will run very fast if the range or the number of entries that can be processed with the range operators fairly reasonably in size. This is because the range operator uses the key structure and runs very quickly. If several characters are used at the beginning like XYZ*, it will run very quickly; if there are not a lot of unique characters or, in the worse case, if it starts with a *, for instance, if the pattern you are looking for is find the part numbers that match pattern *1, the whole index will be scanned, which will take longer. For this reason, systems that allow searches restrict which search characters can be used at the start of the pattern, such as an * or a ? mark. And they may have various rules, such as requiring two or three characters before the first wildcard character so that the search has a limited potential range.

Sometimes the use of wild cards can be eliminated by special indexes, for instance, if a part number had two fields, a prefix and a suffix, and maybe a lot of wildcard searches on the suffix are desired. There is no reason why additional indexes cannot be made. For example, for an index, which is the part number as a whole, and an index, which is the part number suffix, a very rapid search for all parts that match the given suffix without having to do the wildcard search through the whole part number index can be made. A search can sometimes be made for a word that has synonyms, for instance, “sink” and “founder” (i.e., a boat can either sink or it can founder). Thus, the search is for a meaning, not the specific word.

The design of the indexing is that the document is always indexed in the exact way as they are found and then the query is produced to handle cases such as synonyms. So, if a search, with synonyms, is made, the query builder the part of the system would utilize the dictionary and when all documents are requested with the word sink and maybe the name of a lake, it would internally search up its dictionary and, in addition to the word sink, it would also say founder or synonyms and those would become part of the search. If all document or pages with the word sink and the word Edmund Fitzgerald is desired, the dictionary would request, without your knowing it, to find all pages with either of the word sink or with the word founder and the word Edmund Fitzgerald and then it would execute as a normal query.

Similarly, word stemming allows part of the word, which is really the root part of the word, and is used in many other variations. For example, for the root word mine, several variations, such as mining, mind, minor, etc. are all based off of the same root and again, the same approach would be taken to word stemming by utilizing the dictionary. The query processor would analyze the words, calculate and find the root, find the related words built off the same root, and again put them as a series of word conditions in the search. The root can also be used as a wildcard search but that would not be nearly as accurate. For example, the word mine would match the word miner. It would also match “mine field” in a wildcard search but it is really not a related word. Thus, the best approach is to use the dictionary.

Phrases are full text queries that contain more than one word. For example, a query could be done that requests all pages that have the phrase “exception handler.”That means that not only all the pages that have both the word exception and the word handler, but have them right next to them in that order. This is handled again by the query processor. However, this is not done at the point of indexing because it is unknown how many words in a row people might potentially use as a phrase. In this example, two words are provided, but it could be a three or four or five word phrases, or more. The indexer indexes each individual word separately to give the most flexibility so the retrieval by phrases is handled again by the query processor with some filtering. So, if it is desired to find all pages with the phrase “exception handler,” it would really execute as a query that finds all pages that just have the word exception and the word handler anywhere together on the same page and each page that have both of these words would be loaded and processed to locate the words on the page and then checked to see if they are next to each other. If they are next to each other, then that would be considered as a hit and a page to be returned by the query. It turns out that in most cases this runs very quickly because of the number of pages that would have both words on them is fairly low so that the number of false hits pages that would have the word exception and the word handler next to each other would be fairly low. Thus, in most cases, this executes very quickly and it preserves the flexibility that phrases of any size can be used and that there is no limit to the kind of phrases that were indexed. It also limits the index size so that each individual word is indexed once there is no indexing of one word alone and in combination with the word ahead of it and the word behind it or in two words ahead of it and the five words starting three words back and so forth.

Near retrieval is similar to a phrase, it is just a little more relaxed. For example, if it is desired to find all pages with the word exception near handler that would return exception handler, it could also return exception process handler it may also return a sentence if you receive an exception you should provide a handler and so forth. The definition of near is something the user performing the query defines whether it is in a certain number of words, a certain amount of space number of inches, a certain column inches, or distance, etc. from each other. Again, the system indexes each word individually, so in this case it would operate almost like the phrase retrieval. All pages would found that have both the word exception and handler. The words would then be located on the page and determined how close they were to each other by loading those pages with both words. If they met the near criteria as close or closer than the near specification, that page would be returned as a hit for the retrieval query, otherwise, it would not. Again, this should run in most cases very quickly because the number of pages that have both words on them should be fairly small in most cases.

Noise words are common words and are typically articles, prepositions, etc. In many cases, retrieval of the word it, the, and, or and so forth may not be desired. Those are handled by the query processor. A lot of systems remove those words when they are indexed, the word and, or, the and so forth will not be indexed in order to save space. This system does not do that. All words are indexed because, in some cases, the word that one user may consider a noise word, another user does not. For example, the word “and” is a part of programming languages and if all documents are requested that talked about how the “and” operator works, if that was eliminated as a noise word during indexing process, it would be impossible to find a query. Therefore, this process of the present invention does not do this. All words are indexed and the query processor has an option or can have an option to say remove noise or do not remove noise words. If removal of noise words is desired, if the words are used, it would just be removed and would not be part of the executed retrieval criteria this allows the noise words to be tailored by the user based on their query and to be removed at any point so that there are no noise words and any word can be retrieved.

Natural language is the ability to use natural language to perform retrievals rather than a computer language, or query language more of a mathematical sort of language which is typically used. The implementation of natural language is outside of the scope of the present invention because that is a process that would take a natural language and convert it to a standard computerized query and filter process, It is mentioned only as a related topic but, the way a natural language query would be implemented is by having a pre-processor that takes that natural language query and converts it into a standard computer syntax and then executes that query.

Folder Retrieval

The indexing techniques described above can be utilized to index properties of documents and other files stored on a computer system or in a document archive. For documents, such properties include information concerning the type of document (for example, whether it is a purchase order, proposal, or contract), information concerning the contents of the document (for example, what products the contract or proposal document relates to), as well as other information associated with the document (for example, the customer whom the contract is for). The folder retrieval techniques discussed herein are implemented by creating indexes of this information, such as was described above in connection with the arbitrary index techniques that permit indexing and retrieval of data and relationships without the need for an underlying database. An index of employee attributes was used in the example provided earlier above and, just as that indexing technique was extended to word indexing of documents for text queries, so too can it be used for indexing the document properties for processing of queries on the basis of the different properties and then enumeration of the results using the hierarchical folder paradigm that will now be described.

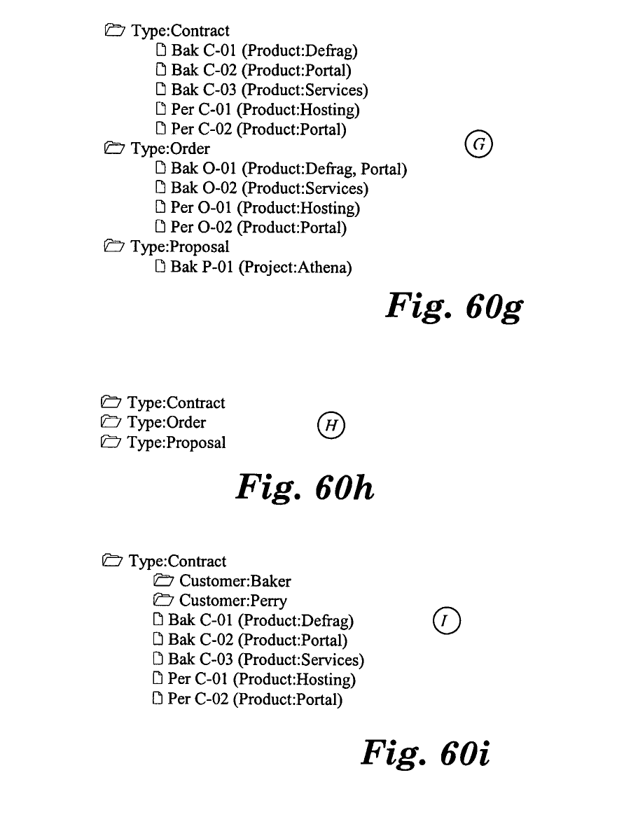

Before discussing the improved folder retrieval capabilities provided by the index structure, there will be provided a discussion of traditional folder retrieval techniques. FIG. 57 depicts a standard folder hierarchy for handling of files, wherein each folder may represent a directory or subdirectory on magnetic disk storage. At the top is the file systems, that's the part of the operating system that keeps tracks of folders and files within folders. From the root level of the file system, there is a hierarchy of folders, beginning with a first tier of customer folders that includes a folder for each customer. The illustrated example includes a folder for customer Baker, and a folder for customer Perry. Then within each customer, the next level of folder is for type; that is, type of document ultimately stored within the “type” folders. So under customer Baker, the types of folders include contract, order, and proposal. Under Perry there are the same three types. In this example, customer Perry has no documents that go under the proposal folder, but typically one would still have the folder. It happens to be an empty folder, but it would still show up on a directory listing off your system. The actual files, in this case documents, are then located within the appropriate ones of each one of these second level folders. Under customer Baker and type “Contract”, there are three documents. They are labelled C-01, C-02 and C-03, for contract 1, 2 and 3. And there are Baker files under “Order”. There are two them, 0-01 and 0-02, for order 1 and order 2. And for “Proposal”, there is one, P-01. And the same is true for customer Perry. And then finally, to the right, the figure shows some information concerning products or projects that the document relates to, and it is to be assumed that the document has pages within it. And the first case, under the Baker C-01, the product is “Defrag.” So that contains pages about the “Defrag” product. Farther down, under customer Baker, type order, under the document O-01, the product is “Defrag and Portal”. So that particular document contains pages that some of them are for the Defrag product and some for the Portal. This document content information is being included in the example for purposes of illustrating the improved folder retrieval techniques that will be described susbsequently.

So again in summary, this FIG. 57 is a picture of the traditional folder retrieval, its hierarchy and its order from the top down. So with this system one can look up information for Baker by looking in that folder and then into the subfolder related to the type of document of interest.

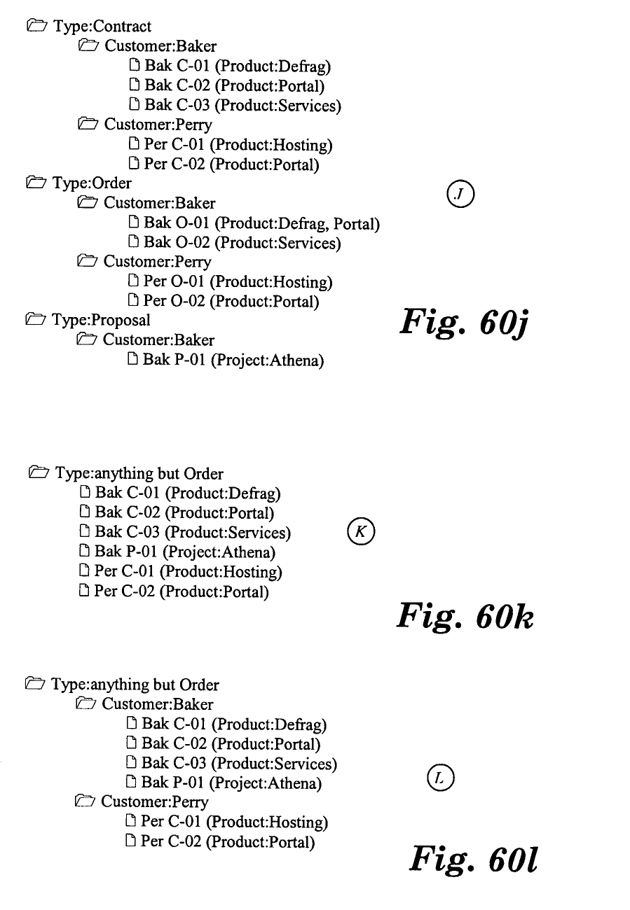

Referring next to FIG. 58 there is shown samples of traditional folder retrieval using this data. So, for instance, under example FIG. 58a, there is shown a listing of the root level folders, and it is very easy with a traditional folder to get a listing of folders that are at the top level. In example FIG. 58b, the folder for customer Baker has been expanded and it shows its subfolders at the next tier which is the document type folders. This is shown in FIG. 57 by the arrows coming from the Baker folder. And there is type contract, type order and type proposal. This again can be expanded the next level down, which is shown in example FIG. 58c. That figure shows customer Baker and with the contract folder expanded to show the three documents contained therein, Baker C-01, Baker C-02 and Baker C-03. The associated product information is shown in parenthesis, but one would not normally know that from the folders. Example FIG. 58d shows a case where multiple subfolders of the tree are being expanded for Perry. This shows under the contract folder the Per C-01 and Per C-02 documents. Under order it has the Per O-01 and Per O-02 documents. It also shows the proposal folder, because the folder's there, but its empty underneath it, so that there are no contents. Again, these are examples of conventional folder displays on a computer screen.

FIG. 58e shows all of the customers expanded and thus is really a full expansion of the folder hierarchy shown in FIG. 57. This hierarchy of the folders is set when they are created. So again if we look in example FIG. 58e, the folders are organized by customer name first, then by type, and then by document. The limitation of this traditional folder relationship is in enumerating the files or documents by other than the hierarchy originally established. For example, there is no folder that includes all contracts, because Baker's contracts are under a different branch than Perry's because of the hierarchy established that organizes documents by customer first, then type. To find all the contracts, one has to look under Baker, under type contract, to find the Bak C-01, C-02 and C-03, and then one has to move down to customer Perry and also under type contract to obtain the Per C-01 and C-02 documents. This can be burdensome where there are many more customers, as there would typically be. So, basically one of the major problems with the traditional folder retrieval is it has a single hierarchy, and the hierarchy is inflexible. That hierarchy is built ahead of time. The folders are built and then the documents are placed in a folder which cements its position within that hierarchy, so that they can only be easily retrieved efficiently in the same order as the hierarchy.

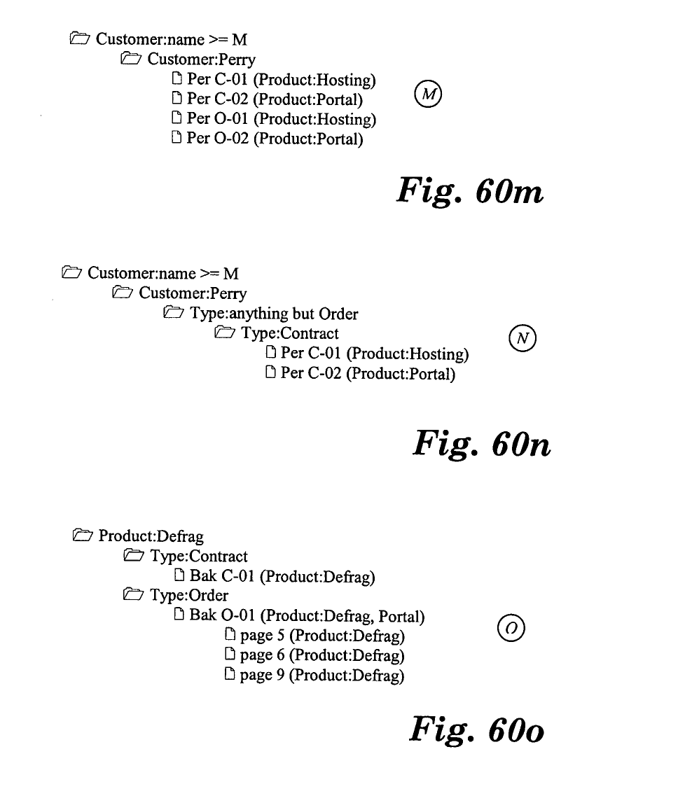

FIG. 59 depicts the same traditional folder retrieval as shown in FIG. 57 along with the use of cross folders in order to try to circumvent this problem; that is, to have a document available under more than one folder, or more than one hierarchy. These cross folder connections are also sometimes referred to as links, or it they may be called symbolic links. The idea is that a file has a symbolic link from other folders pointing to the file. So obviously this is a very complex drawing even though in this case it includes a fairly simple hierarchy. This diagram shows that even with two levels of folders how complicated it gets, and very quickly it gets more complicated as one tries to have more ways of accessing it, more than just the two. Looking at FIG. 59 in greater detail, it will be seen that the traditional folders are the white folders, and the folders with the crosshatching are the additional cross folders that have been added to try to make it so that one can access it from the top level by type of document. So if one looks on the very top of that, there a shaded a folder on the first level, it is in line right at the first level off the file system, and that is called “type contract” that points to all the files that are of a type contract, so that it points to Baker C-01 and Baker C-02 and Baker C-03, it also points to Perry C-01 and Perry C-02 as the other contracts. In order to do that one would normally have to manually make those links, so that when Baker C-01 as created, for example, one needs to know where the different places that it should be stored. For example, one would then store it in the level 1 (root level) type contract folder, store it in the level 2 type contract folder, which is a subsidiary a level 1 customer Baker folder, and it gets very complicated. In addition, if this is done and everything is stored multiple times in folders, then there are three type folders in the top, plus the original customer folders. However, perhaps the user wants to show all the files for a given customer without having to break them up by type. A good example of this is in FIG. 58e, where under a given customer Baker all the documents can be seen eventually, but there are grouped, first by type contract, then by type order, then by type proposal. The user instead may want to see all the documents for customer Baker, and again there could be any number of folders in between. Looking back to FIG. 59, right below the white customer Baker folder on the left, there is another customer, shaded customer Baker folder, only that one instead of pointing to the next level to the type field that's got the line that points directly to the documents. So in the first level where as before there were two folders, the two white folders, there are now 10 folders because the type folders and customer folders have been added. On the second level, where as before there were 6 folders, there are now 12. And again this is just with the two level hierarchy and this is all done so that the user can see all the documents of a given type or all of the documents associated with a customer, or type first and then customer. It can therefore become very unwieldy. It is inefficient and very difficult to do even though it is a very useful method of retrieving relationships and adds flexibility for the user.

FIGS. 58f-58h show some examples of what can be done with this cross folder example. Example FIG. 58f shows that documents can be retrieved by customer. For example, under customer Baker is all of the documents that are associated with customer Baker regardless of the actual folder in which they are placed. This is also shown for customer Perry. This allows retrieval of documents associated with a customer irrespective of the type of document.

In FIG. 58g, enumeration of the documents by type is shown. Thus, all contract documents regardless of which customer are shown under the type contract folder, all of the orders regardless of customer are shown under the type order folder, and the lone proposal is shown under the type proposal folder. This enumeration is accomplished at great cost in terms of complexity and the processing time and if this example where to be expanded to say five or ten levels it would add a great deal of complexity. It also makes the actual clearing or retrieval of folders difficult, because now when the user wants to see everything under customer Baker, the user has to make a choice as to whether the user wants the customer Baker that points directly to the files, that folder, or the customer Baker that points to the type of files or whatever. So again, it is not very workable, and in reality and real life people only do the cross folder or symbolic links in a very small way, with some very special purposes and is typically done by hand.

Finally, example FIG. 58h depicts that, with the extra cross folders the user can now show the documents by customer type first. Thus, they can look under contracts, and then decide whether to look under Baker or Perry to see the contracts specific to just that customer. Again, however, this was only achieved by using all of these extra cross folders.

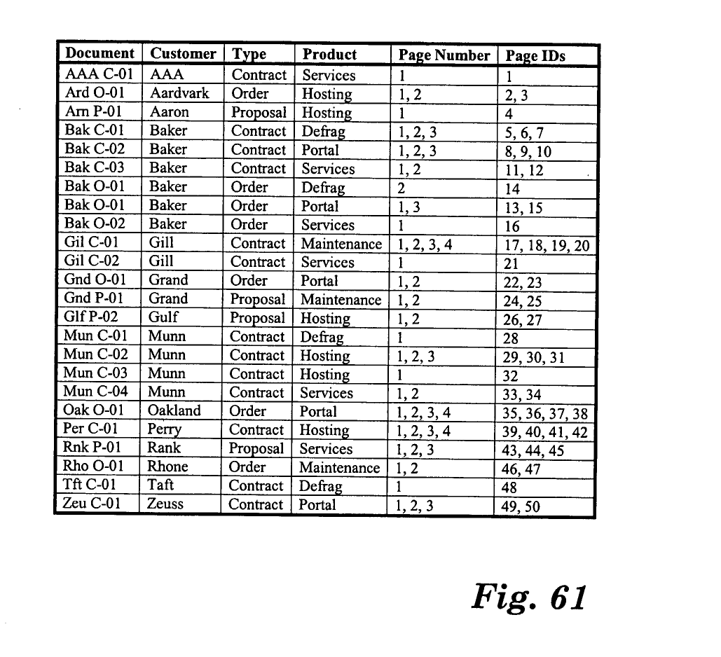

Turning now to FIG. 60, the following explains the use of an improved folder retrieval technique that overcomes these difficulties of the traditional approach described above. First, there will be shown examples of the kind of improved retrieval that can be done and then the methodology for achieving the improved retrieval. In FIG. 60a, there is shown a top level. In this case the user is selecting the top level to be customer and is enumerating all of the customers. And that is similar to the traditional folder retrieval because the improved folder retrieval can do everything in the traditional folder retrieval plus more.

Now in example FIG. 60b, lets show what happens if we take a look at a single one of those. Lets pick customer Baker and then lets show everything that is under Baker. Referring back to example FIG. 58b earlier with the traditional folder retrieval, when looking under Baker, all that could be seen was the next level and the next level was the various types, type contract, type order and type proposal. However, one the advantages of the improved folder retrieval, is that it can show not just the contents one level down of all the subsumed contents. So in this case the user sees that under customer Baker its got three subfolders, the type folder (type contract, type order and type proposal) and that either directly under customer Baker or under any of the subfolders, the type folders, its got the following list of documents, and all the documents for customer Baker are shown there. So the user can actually see everything from this point in the hierarchy or in the tree on down. That is a major advantage over the traditional folders.

FIG. 60c shows an example of looking under one of the subfolders, and again that gives the user the same thing as the traditional folder. So, for customer Baker, under that the user selected type contract to expand, under that there are three files that are customer Baker, type contract.

Example FIG. 60d again is following the traditional file folder. It is similar to example FIG. 58d the difference however, is that with the improved folder the system can automatically eliminate empty folders. So it turns out that under customer Perry there are no documents types of proposal. With the traditional method the user would typically see the folder there, whether it was empty or not since they are made manually ahead of time and then documents are place in or removed from them. But as documents are removed from a folder leaving it empty, the folder remains. Whereas with the improved method, since the folders are manufactured from indexes, they don't really exist unless there are documents indexed with them. So this has a nice advantage as shown in example FIG. 60d, that the user does not have to manually keep track of empty folders, they are automatically eliminated.

FIG. 60e shows a complete tree expansion similar to FIG. 58e on traditional folders. It shows the same hierarchy within the root node of all the customers, within each customer all the document types, and within each document type all of the documents. And again it has the main advantage over the traditional system of not showing the empty type proposal folder under the customer Perry.

Now example FIG. 60f depicts the kind of query that one could get on a traditional system only by the use of cross folders. In particular, it shows a listing of all documents associated with a given customer, without being broken out by type. This is shown for both customer Baker and Perry. Again, this can be achieved using the improved folder retrieval techniques that will be described below without the need for any cross folders.

FIG. 60g shows the documents enumerated in a different order; in particular, by type regardless of which customer. Thus, there is a single folder for type contract, one for type order, and one for type proposal. Again this is done without any cross folders or linking. FIG. 60h is similar except that the user just wants to look at the document types that exist, and not any individual documents under them. In a graphical user interface, this may be the type of graphical depiction shown when the user clicks on an upper level “Type” folder, which then expands to show the three types. The user could then click on any of these three type folder shown in FIG. 60h and obtain an expanded listing of the documents subsumed under that folder, as in FIG. 60i. So the next level down it shows the folders called customer Baker and customer Perry and then it is showing all of the documents underneath are the Baker C-01, C-02 and C-03 and the Perry C-01 and C-02. So in this example, the user has clicked on the “Type:Contract” folder of FIG. 60h and is given an expanded list of documents and folders that are associated with that type regardless of how far down in the hierarchy they are. In this regard, it is worth noting that the discussion herein is directed to the use and implementation of indexes and queries to permit these folder operations and not to the programming involved in implementing them or in establishing an appropriate graphical user interface display since such programming is well within the level of skill in the art.

FIG. 60j is similar to FIG. 58h. It shows the full tree starting with document type, then customer name and then document, and again this shows the advantage of the improved retrieval in that it doesn't show the empty folders. On the traditional method under the type of proposal it shows customer Perry, even thought that customer currently doesn't have any proposal type documents.

In addition to providing an improvement over traditional folder retrieval, FIG. 60k shows how the indexed document properties can be used to extend the folder retrieval to Boolean type retrievals. Again, this capability exists because the folder retrieval is on the basis of an index of the document properties, thereby allowing all of the types of queries discussed above in connection with the detailed descriptions of the arbitrary and record-based index structures. In the example of FIG. 60k, the user is requesting folders concerning documents of any type except orders. This folder therefore contains all documents whose type is contract, proposal, or whatever other types might exist, such as memorandum, email, etc. If desired, the folder results can include subfolders underneath this, such as is shown in FIG. 601

FIG. 60m shows an ordering relation. Here, the user is requesting a folder that consists of all customers whose name is greater or equal to M; that is, whose name starts with the letter M or later in the alphabet. In the illustrated example, that includes only customer Perry. Therefore, the query returns a folder for customer Perry and within that folder it can shows the documents for that customer. Again, the results need not be expanded all the way to the documents, as shown, rather only the first level folders under the query may be shown with the user then being able to click on an individual customer to further expand the folder contents.

As shown in FIG. 60n, the folders can be nested representing Boolean combinations of queries. These folders can also consist of ranges of values. In this example the user requests a folder for everybody whose customer name is greater than or equal to M and underneath that is shows customer Perry. The user may also want to make a folder underneath that for all documents whose type are anything but order, and then that shows under that for customer Perry the only document type other than order is contract, and it shows type contract and it shows the two documents there, Perry C-01 and Perry C-02. Again the folders displayed are virtual folders and this is done without making any actual folders on the computer system's physical storage device. If this would be done with either traditional folders or with cross folders, one would have folders for any kind of combination with ranges. For example, customers names greater than A, greater than B, greater than C. Types anything but order. Type equals order only. Types equals order and proposal, and so forth.

Finally, FIG. 60o shows that the improved folder retrieval can go beyond just listing documents down to showing individual pages of the document where properties concerning the content or even the text content itself is indexed. So in this case the user selects the Product Defrag. And with reference back to FIG. 57, that is not even a folder, it is just something that is on certain pages. Underneath that can be the individual files or, as shown, folders for each of the types of documents, with the actual documents being shown within those folders. For type contract, there is one document called Bak C-01 and in that case the user did not request that it be expanded to any deeper level—it just shows the name of the document. Under type order though, there is the Bak O-01, that has both product Defrag and product Portal in it, and there the user has expanded it down another level which shows the page numbers within the document where the Defrag product is mentioned. Again, this can be achieved using the word indexing techniques described above.

In any of these examples, the displayed documents (i.e., their icons or the document name) can be linked to the actual document stored in an archive or database so that clicking on the document brings up an appropriate application to display the document for reading, editing, etc. Similarly, the pages returned in example 60o could be linked to those individual pages from the document which are retrieved and displayed when selected by the user.

Advantages of Improved Folder Retrieval

The following are some of the advantages of the indexed-based folder retrieval and display techniques discussed above:

1. No need for folders and folder structures—eliminates overhead, space, creation operations, and maintenance operations.

2. No empty folders.

3. Dynamic manufacture of virtual folders.

4. Virtual folders, sub-folders, and contents defined by dynamic relations, not static assignment.

5. Virtual folders for full text relations as well as data relations.

6. Display full subsumed contents at each virtual folder level.

7. Display individual pages at each virtual folder level.

8. Automatic segmentation and prefixing of large folder lists.

For item 1, the folders or folder structures do not even need to exist. Rather, the folders are implemented using the indexes that were created for the document properties and, if desired, word indexes, and from those the folders are virtually manufactured and created. They do not need to be predefined, the files do not need to be placed into folders, and no cross folders are needed.

As indicated in item 2, there are no empty folders returned. Since the system does not maintain folders there are no empty folders and the system only creates the view or the virtual folder where data actually exist. That is the advantage of item 3. The folders are dynamically manufactured. They are actually virtual folders. They don't exist physically as folders, but looking at the contents of the data in the indexes as required or as specified will manufacture what will appear to be folders.

With regard to item 4, the user can define the content of virtual folders and subfolders by dynamic relations not static assignment. So that means that the user can, as is shown in the examples, find all documents where the department is greater than or equal to department 27, and that is done dynamically and the user does not need to have a predefined subfolder.

As indicated by item 5, the system can provide virtual folders for full text relations as well as data relations. And everything that that has been discussed above for enumerating the folders based on document properties, like the document type or the customer name, can also be done based on the text within the document. So the user can find everything with a range of words, or a list of words, and so forth and put them into a single folder. So this works on any text within the document as well as with the actual data indexes, or properties indexes, for the document.

With regard to item 6, the examples shown above so that the user can display the full subsumed content in each folder level. So for any customer the user can see all the documents for that customer, as well as all of the document types or even products or other listings of properties or text associated with the documents corresponding to that customer. The user could add another folder to, for example, see all the documents created January and so forth.

For item 7, as discussed above in connection with FIG. 60o, the system can display individual pages again using the indexes associated with the document contents. So under a document or within a results folder the user can be given only those pages of a document that fit the user's query.

The advantage of item 8, automatic segmentation and prefixing of larger folder lists will be discussed in connection with the next section concerning implementation and use of queries to generate the folder results. This features is useful where, for example, there are thousands of customers or ten or hundreds of thousands of customers, and if the user tires to open up and show that list of folders, that's a huge unmanageable list. The folder retrieval techniques used herein can be used to handle these large lists by, for example, manufacturing a folder for all customers that start with A, B, C and so forth and then let the user immediately go to the section of the alphabet where the desired customer is and then go to the next level.

Operation of Improved Folder Retrieval

The following discussion of the folder retrieval operation is in terms of folders of documents and pages, but the virtual folder techniques described herein are applicable to folders of anything or things, such as units, directories, and files in a traditional computer file system. The page indexes (or any indexes described herein) are used to simulate folders and produce virtual folders. Key enumeration will be described below and is used to show virtual folder names. Full text and data index query (described above) are used to show the virtual folder contents.

As mentioned above, the enumeration of virtual folders and listing of their contents is achieved using the index structures defined farther above. Thus, no description of the actual indexes or use of coarse and fine slices or bit vectors, etc. is included here since they can be used in exactly the same manner for the folders as they are used for the queries described earlier. The page indexes are used for both the key enumeration and the full text queries. Key enumeration is used to show the virtual folder names, and if you look at the examples in FIG. 60, everywhere it shows the folder icon was the result of using the key enumeration. The word (text) and document properties queries already described above were used in FIG. 60 to show the virtual folder contents, which are either documents or pages within documents which have the document icon.

Key Enumeration To Show Virtual Folders

The key enumeration operation is used to show the virtual folders and is an operator that is given one or more parameters and returns a list of virtual folders. Thus, the first thing being shown below are the parameters. Whenever the user wants to enumerate folders, some or all of the following parameters need to be specified:

| | |
|---|---|
| Attribute Name | (attname) |
| Attribute Prefix Value | (prefix) |
| Enumerate Depth | (depth) |
| Max Folder Count | (maxcnt) |
| Branch Query Procedure | (qp) |

“attname” is the name of the attribute to be treated as a set of virtual folders. This is the Attribute Name part of the Attribute Name::Attribute Value Pair Key described in FIG. 20. Only those entries in the index whose Attribute Name matches attname in total will be processed for enumeration.

“prefix” is a prefix value to be matched against the Attribute Value part of the Attribute Name::Attribute Value Pair Key described in FIG. 20. Only those entries in the index whose Attribute Value matches prefix in part will be processed for enumeration. If prefix is null, all entries will be processed. If prefix is not null, only those entries whose Attribute Value length is at least as long as the prefix length, and which match prefix for the prefix length, will be processed. For example, if the prefix is “A”, only those entries which start with “A” will be processed (only the A folders will be shown).

“depth” is the length beyond the prefix length to be used from the Attribute Value part of the Attribute Name::Attribute Value Pair Key described in FIG. 20 to build the virtual folder names. If depth is 0, the full Attribute Value will be processed for enumeration. If depth is not 0, only the unique part of the Attribute Value with length specified by the prefix length plus depth will be processed for enumeration. For example, if the prefix is “A” and the depth is 1, only the Attribute Value “AA” would be returned as a single virtual folder for the entries “AAA, “AARDVARK”, and “AARON”.

“maxcnt” is the maximum number of virtual folders to be enumerated. If this amount is exceeded enumeration of virtual folders is terminated and an OVERFLOW error is returned. maxcnt is used to limit the maximum number of virtual folders enumerated when there may be a very high number of such virtual folders.

“qp” is a query procedure as described in FIGS. 38-39 which identifies all of the pages (and thus documents) which fall within the current branch of the virtual folder hierarchy. The qp is executed to show the full subsumed contents of documents at the current branch of the virtual folder hierarchy. And the qp is executed to restrict the enumerated virtual folders documents within the current branch of the virtual folder hierarchy to those which contain one or more documents within the current branch of the virtual folder hierarchy, eliminating empty folders.

For the following examples, the fields Customer, Type, and Product are page indexes as described above. The following examples are illustrated with FIG. 61. In this example, customer is a attribute name, type, as in contract or proposal, is an attribute name, product is an attribute name.

Prefix is a value that lets the user select a range within an attribute name. So for the attribute name customer, if the prefix was “A”, that would mean that the user only wants to select those customers that start with “A”. If the prefix were two characters long, if it were “Ab”, it would mean the user only wants to select those customers whose name starts with “Ab”. If desired, the prefix can be null. If the user does not want to do any prefix matching, then the prefix is set to null and that means it will match all entries for that attribute name.

The depth is the length beyond prefix that will be used to build unique folder names. If the depth is zero, then the full attribute name is used. So if the attribute is customer, and the depth is zero, whenever a customer name is enumerated the full name will be used. Typically, depth is used when there are too many folders to show all of the customers. So, for instance, if the prefix is set to the letter “A”, so that only items that start with “A” will be returned, and the depth is set to 1, then its only going to return customers that start with “Aa”, “Ab”, “Ac” and so forth. If there were five customers that started with “Ab”, it's only going to show the letters “Ab”. So this is a way that the system can break the huge numbers of folders into manageable, group folders.

Maximum count is the maximum number of folders that the user wants returned. And by doing this the system can be dynamic so that if the result is a large number of folders, then they can be grouped by initial letter only, say A, B, or C; whereas if only a few are returned the system can display each individually, showing the full name. The maximum count can be used to return an error if exceed so that if, for example the maximum count is set to 100, and there is 100 or less the folder results will be returned, if not an overflow error is given.

The branch query procedure is the same query procedure that is described above in connection with FIGS. 38-39. So that is basically the expression that is evaluated using the indexes to return a set of pages that match the query. And from the set of pages the system can determine the documents as was shown above. When the system is doing an enumeration, the query procedure is used to restrict the enumerated virtual folders to only be those that contain documents within the current branch structure. And the query procedure is referred to as the branch query procedure, because not only does it indicate the relationship or the query for the current level, for instance department number greater or equal to 50, but it is also added in to show the previous levels, that was within a folder call customer name equal Baker, then the query would be customer name equals Baker and the department number greater then or equal to 27.

The sample data of FIG. 61 will now be used to explain the query processing rather than the data of FIG. 57, which was a simplified sample data set used for the descriptions of the traditional folder retrieval. The sample data is shown in FIG. 61 in table form showing the name of the document, the customer for each document, the customer name, the document type, the product and then within that product the page numbers that have that product associated with them, and the last column are the page IDs. So those are the page IDs as described in connection with the word indexing and that are assigned as the pages are indexed and stored. As noted on this example, the fields customer type and product are page indexes as described above.

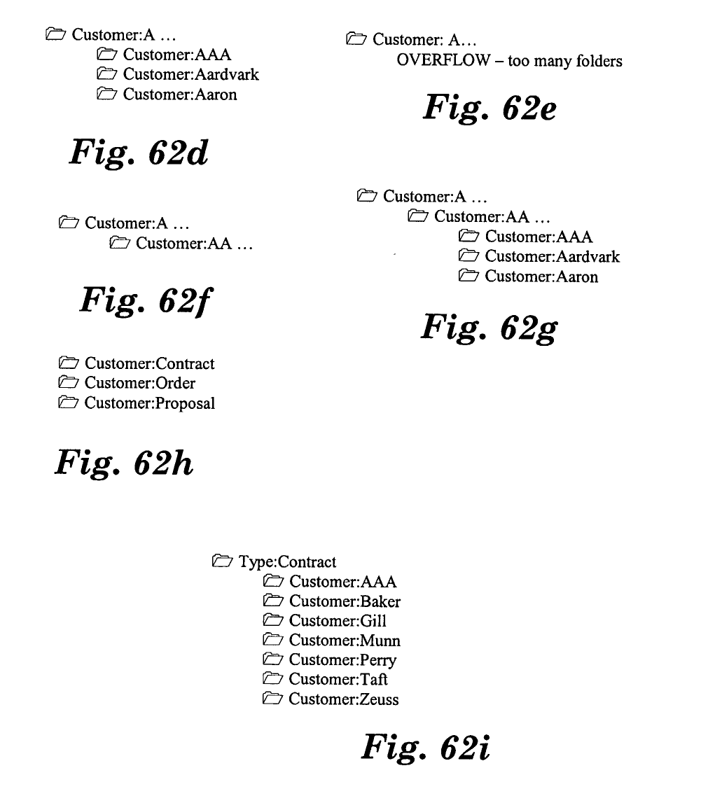

In each one of the following examples the five parameters are shown along with the values of the five parameters, with the results then being shown in the accompanying FIG. 62.

For example A, the following enumeration request will show one virtual folder for each customer, up to a maximum of 256 folders. This is a root level enumeration. This is typically used as a first enumeration request at the root level.

| | |
|---|---|
| attname: | Customer |
| prefix: | null |
| depth: | 0 |
| maxcnt: | 256 |
| qp: | [Page Validity] |

So example A is a basic level of enumeration. It is a root level enumeration, which means that the query procedure is the query procedure that just shows everything for the attribute name Customer, rather than being a folder. For instance, if it was document type within customer, in the query procedure there would be an expression for the previous folder and within this level. So in this case the attribute name is customer. Because the prefix is null, that means show all values. Because the depth is zero, that means return the whole value of the customer attribute. The maximum count is 256, so it will return up to 256 folders. And the query procedure is the page validity. So basically that means that all the pages that are valid. So the query into the index will find all pages that have a valid page on them, that haven't been deleted and then for each one of these pages the system will enumerate the customer attribute.

For the sample data set, this returns customer AAA, Aardvark, Aaron and so forth as shown in FIG. 62a, and they are returned in order, because the method that is used (with the keys being stored in order of key value) maintains them internally in order. So one of the things about the enumeration request, is that the data is always returned in order of the attribute name that is enumerated. Following the examples is a flow chart that shows in detail how the enumeration request takes the five parameters and returns the results that are shown. Root level enumeration is typically the kind of enumeration that is done at the first level. That is why the result includes just the folders down the left, the folder icons, and the customer name.

In Example B, the maximum count has been artificially set to 10 to show what happens if there are too many folders. Thus, the following enumeration request will show one virtual folder for each customer, up to a maximum of 10 folders. This is a root level enumeration. This is typically used as a first enumeration request at the root level. This is the same as the previous query, except the maximum folder count has been reduced to 10 to show the effect of too many folders for the enumeration.

| | |
|---|---|
| attname: | Customer |
| prefix: | null |
| depth: | 0 |
| maxcnt: | 10 |
| qp: | [Page Validity] |

With reference to the test data, there are actually 14 customer names, and in this case because there is more than 10, the user will get the error “overflow too many folders” as shown in FIG. 62b. And the only difference from example A to example B was that the maximum count was dropped down just to show that error. In example A, the same thing would occurred if there were more than 256 unique customer names.

Example C shows the response that the user might do in response to receiving the results of example B. If the user executes an enumeration request and gets an overflow error “too many folders” then the user can instead request a partial name returned rather than the full name. Thus, the following enumeration request will show one virtual folder for the first letter of each customer, up to a maximum of 256 folders. This is a root level enumeration. Since only the first letter of each customer is enumerated, there will be at most 256 folders in an 8-bit character set.

| | |
|---|---|
| attname: | Customer |
| prefix: | null |
| depth: | 1 |
| maxcnt: | 256 |
| qp: | [Page Validity] |

In example C, the request still uses the attribute name customer, the prefix is still null, because the user is at the base root level. The depth is one, which means that the system should return the first letter of each name. The maximum count is set to 256, and that's a good choice in this case since the first letter in each customer is at least an 8 bit character, there will be at most 256 folders. If the system was designed to be used with a unicode, that number bigger would have to be bigger to show all the potential first characters. That number must be large enough to handle of the potential one-character names. Otherwise, a query would have to be used to show all customer names from A-M and show only the first character and then do from N-Z for example. The results of example C are shown in FIG. 62c with the single characters being shown for each folder followed by the ellipsis to indicates that is a folder that is a partial name and that it can be expanded further. So in this case there are 9 partial folders, A, B, G, M, O, P, R, T and Z because those are the nine characters that our test data starts with.

Example D shows the next logical step in this case. This is useful where the user wants to see the contents of the customer A . . . folder, in effect showing all the customers starting with A. So in this case, attribute name is customer. Instead of a null, the letter A is passed as the prefix, meaning the system should return only those customer names that start with A. The depth is set to zero and the depth of zero means return the full name. The max count is again set to 256 and the same query procedure, a page validity, is used because the user wants to return all valid pages that are stored.

| | |
|---|---|
| attname: | Customer |
| prefix: | A |
| depth: | 0 |
| maxcnt: | 256 |
| qp: | [Page Validity] |

The results shown in FIG. 62d are the customer A . . . folder, and underneath it are the three customers that start with the letter A-AAA, Aardvark and Aaron. Again the data is fairly small here, with only have three customers that start with the letter A, so the user would probably see all of them.

Example E will show what will happen if there were too many that start with the letter A to fit comfortably, and this can be done by redoing the last query (Example D) only now there is at a maximum count of two.

| | |
|---|---|
| attname: | Customer |
| prefix: | A |
| depth: | 0 |
| maxcnt: | 2 |
| qp: | [Page Validity] |

So find all the customers that start with A, return the full name and set a maximum count of two. The result shown in FIG. 62e is the folder customer A . . . , and underneath it, it says overflow, too many folders. The user can then re-request the enumeration, and the attribute name is customer, the prefix is A, just as above, but the depth is now set to one, as follows.

| | |
|---|---|
| attname: | Customer |
| prefix: | A |
| depth: | 1 |
| maxcnt: | 256 |
| qp: | [Page Validity] |

The depth of one says only show the next unique value for the next character that comes after A and in this case the system returns the customer A . . . , which is expanded to get the customer Aa . . . which can be expanded and so forth. This is shown in FIG. 62f. This is helpful for a huge number of folders, where the first level will be like A, B, C, D, all followed by . . . and the next level, might be Aa . . . , Am . . . , Ar . . . and so forth. But again those will only exist where there's actual data, if there was customers that started with Aa, there was no Ab or Ac, the user is not going to see those folders. The next thing will be Ad . . .

Example G shows how one can take the second level partial name, in this case Aa . . . , and enumerate and expand that.

| | |
|---|---|
| attname: | Customer |
| prefix: | AA |
| depth: | 0 |
| maxcnt: | 256 |
| qp: | [Page Validity] |

So in this case the attribute name again is customer, in this case the prefix is Aa, which is the current partial prefix. The depth is zero, it says return the full name of the customer attribute. The maximum count 256, and again it all the pages in all, meaning in all the documents. The result is shown in FIG. 62g. It is customer A . . . , within that folder it is customer Aa . . . , and within that it will be expanded to three folders for customer AAA, customer Aardvark and customer Aaron.

Next, there is shown an example for doing an enumeration for folder, nested within prior folder, higher level folder, and these are examples H and I. So in example H, this is root level enumeration and is being done now by document type.

| | |
|---|---|
| attname: | Type |
| prefix: | null |
| depth: | 0 |
| maxcnt: | 256 |
| qp: | [Page Validity] |

In this case the attribute is type. The prefix is null, which means find all values. Depth is zero, which means return the full name. The max count is set at 256. And the query procedure is page validity. Since this is root level its finds all values of attribute type for all indexed pages. And in the example data, we get the results shown in FIG. 62h, for type contract, type order and type proposal.

If the user wanted to expand the type contract folder and see the subfolders for customer for that type of contract, that could be done by the following:

| | |
|---|---|
| attname: | Type |
| prefix: | null |
| depth: | 0 |
| maxcnt: | 256 |
| qp: | [Page Validity] AND [Type] = “Contract” |

Here, the attribute name is customer, because the user now wants to look at the customers that are enumerated, and wants customer names back for the folder that is being adding. The user doesn't have to say type, because he is not looking for any type results. The attribute name is the result the user is looking for. The prefix is null to return all values of the customer name. The depth is zero, meaning return the full customer name. The maximum count is 256 and it is the query procedure here that is different and which is how the system builds the nested or hierarchical query. So that query procedure is now page validity and type equal contract. So the system takes the page validity from example H, that's the parent folder and is the query that returned the pages, and combining it with type equals contract. So the effect is substituting the previous results from page validity and saying in addition to that within those pages only those whose type is contract. And then of these pages the system will enumerate all the values of the customer attribute. In the example here, the Type:Contract is the major folder, and underneath it are the customers who have that type, AAA and Baker and so forth on through Zeuss. This is shown in FIG. 62i.

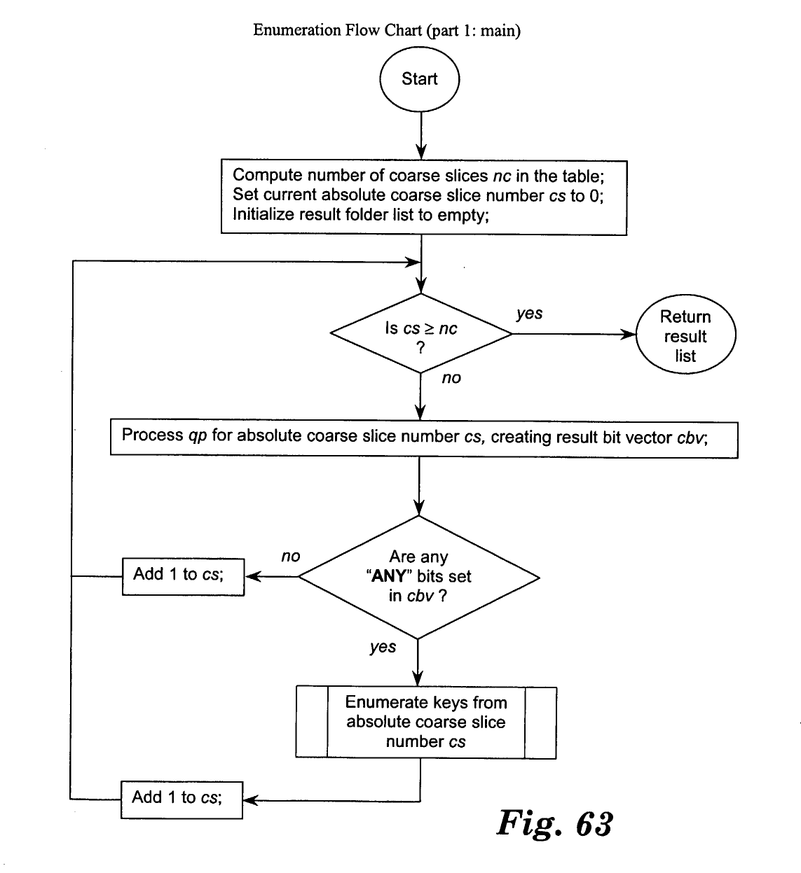

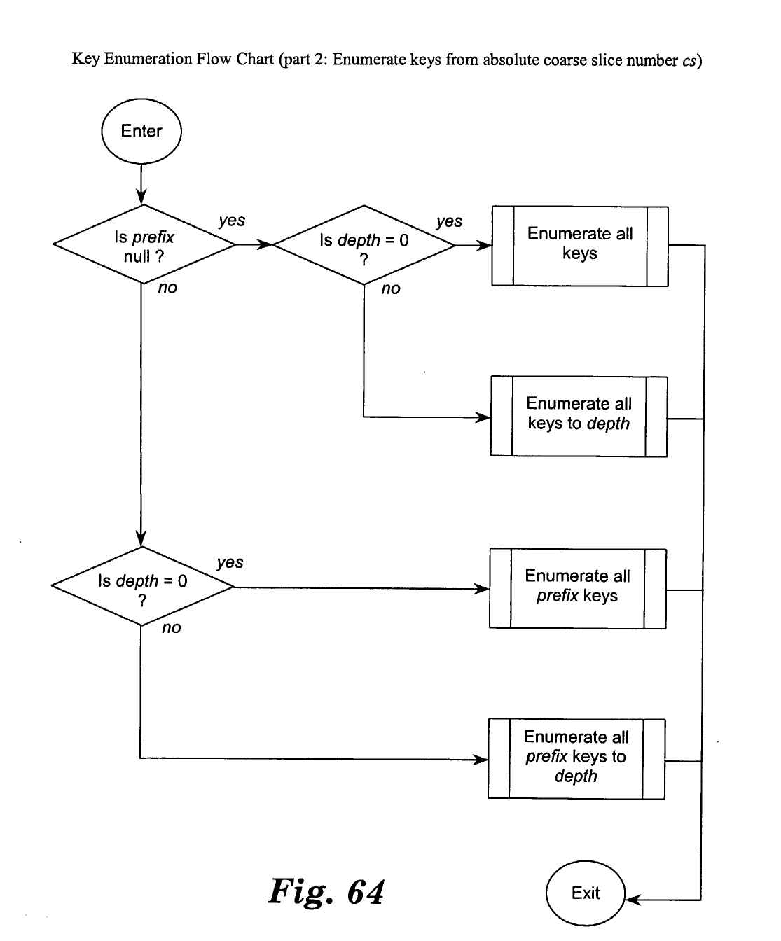

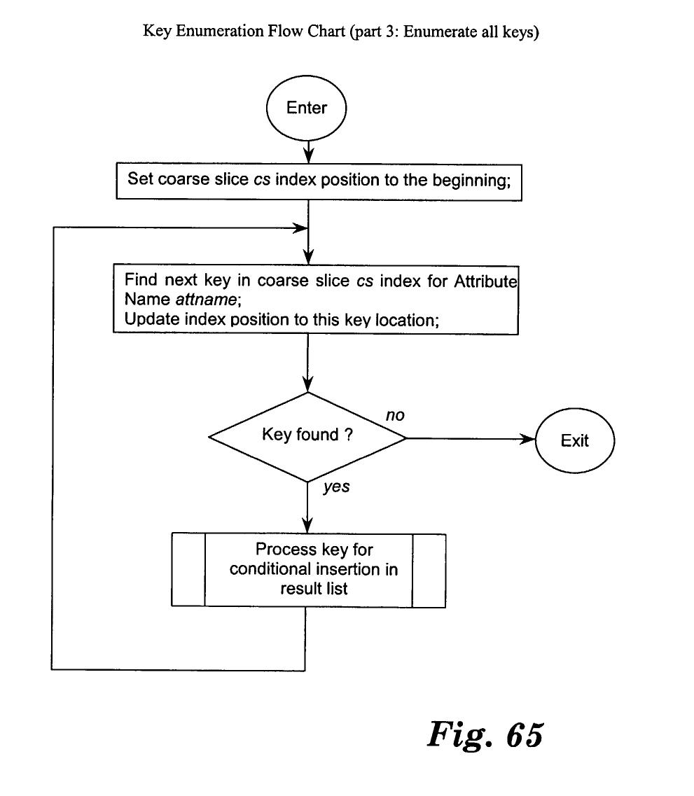

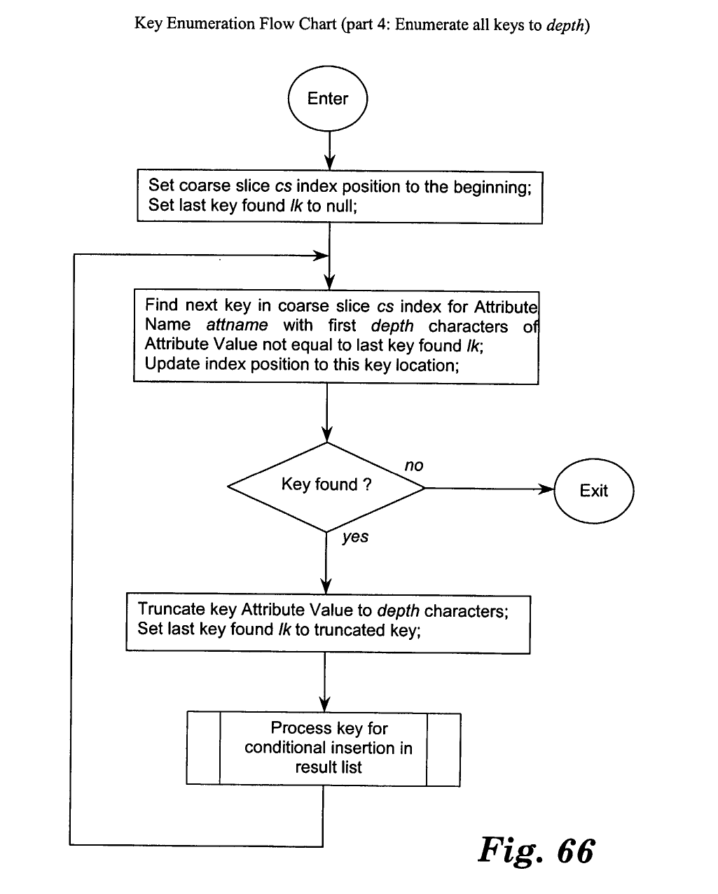

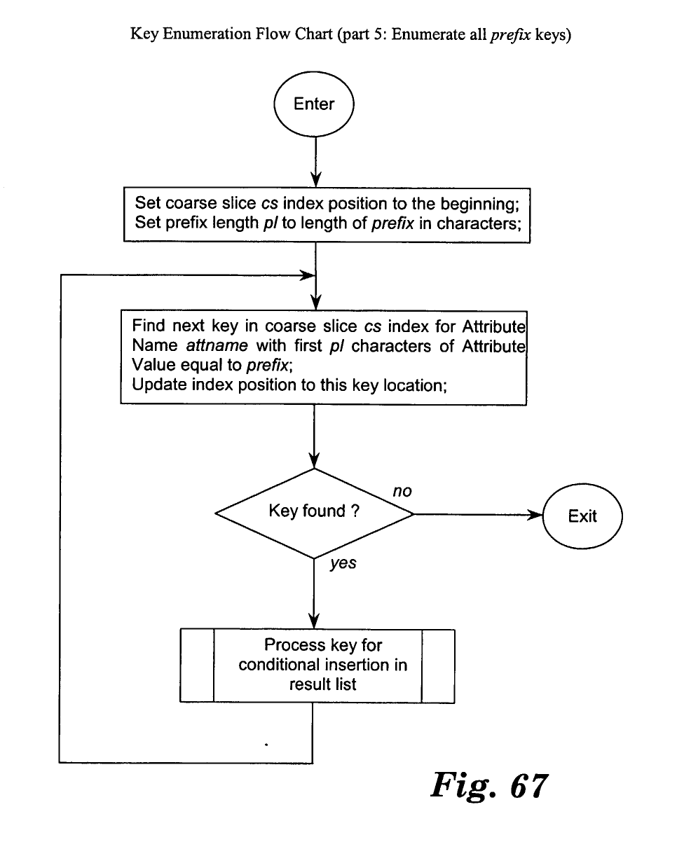

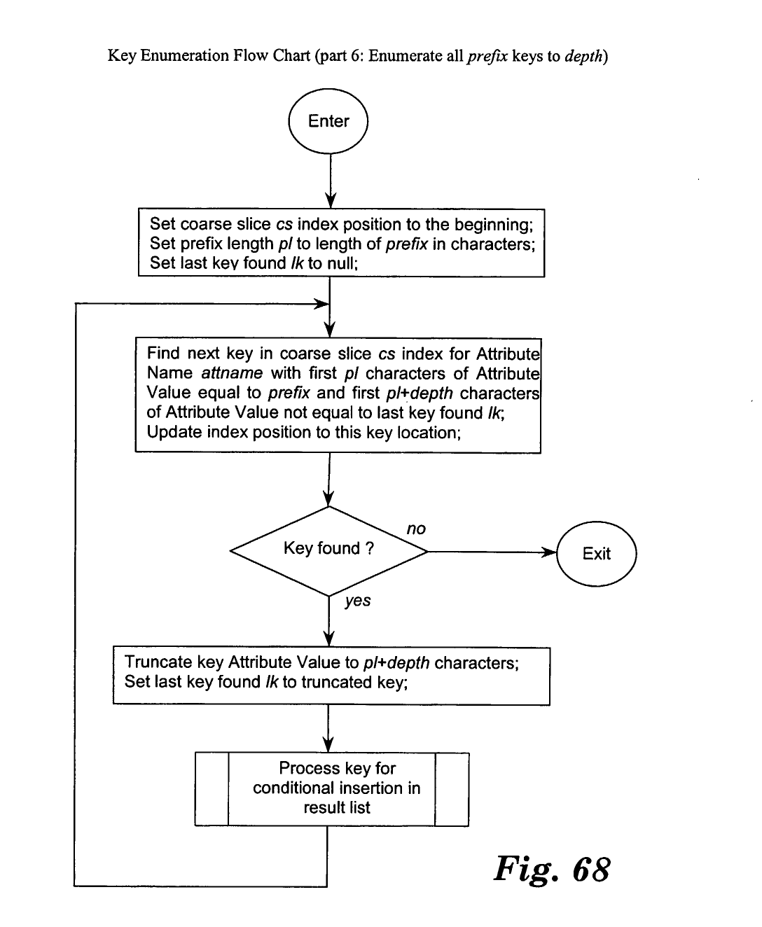

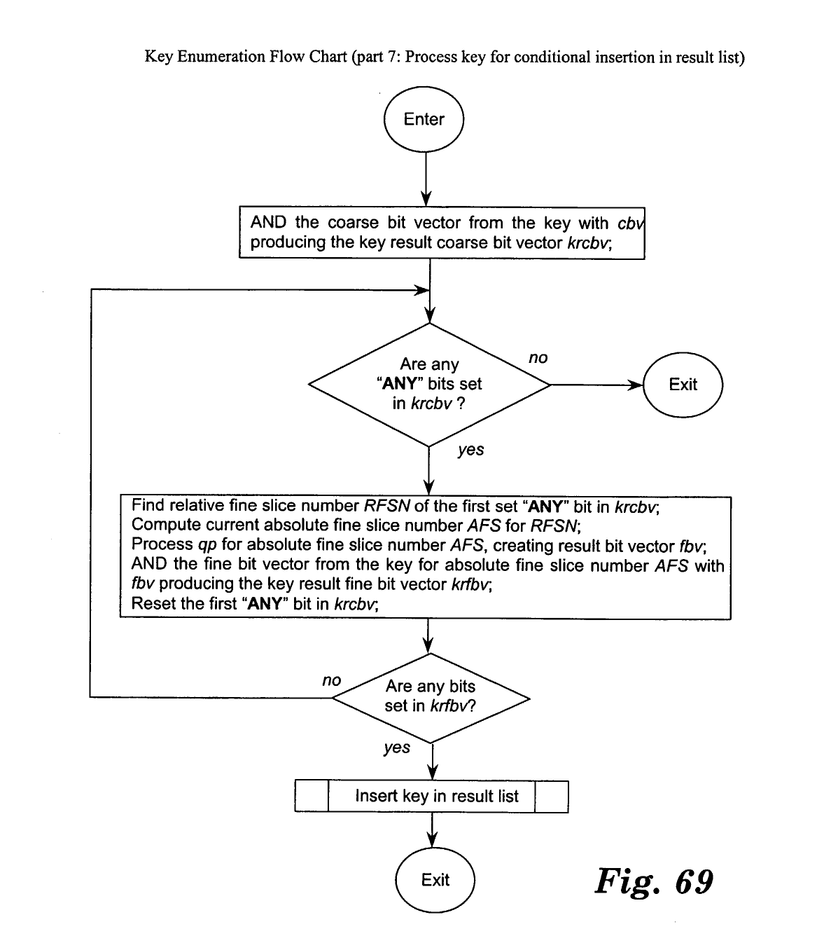

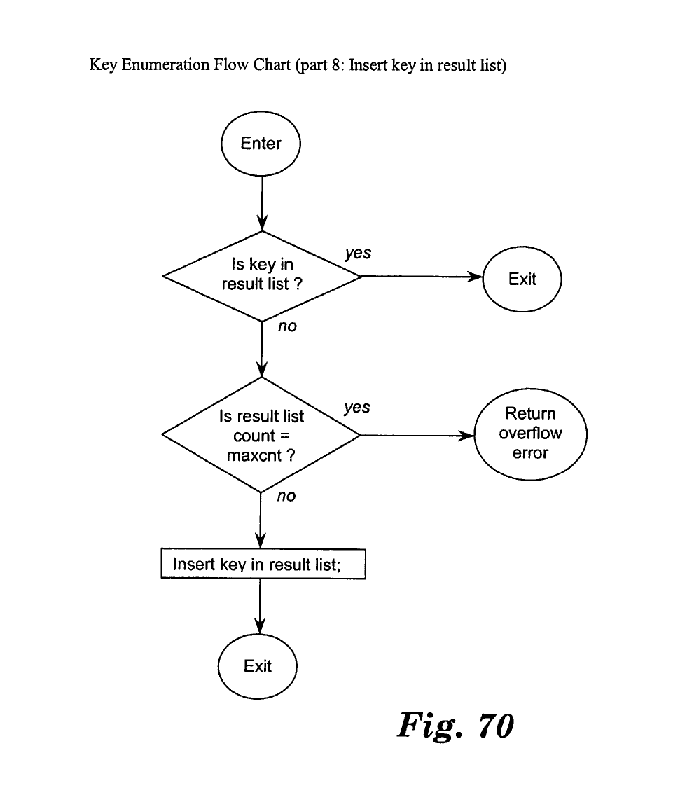

FIGS. 63-70 show a flow chart that depict how to key enumeration works. This is similar to the earlier flow charts that show how user query work using coarse and fine slices.

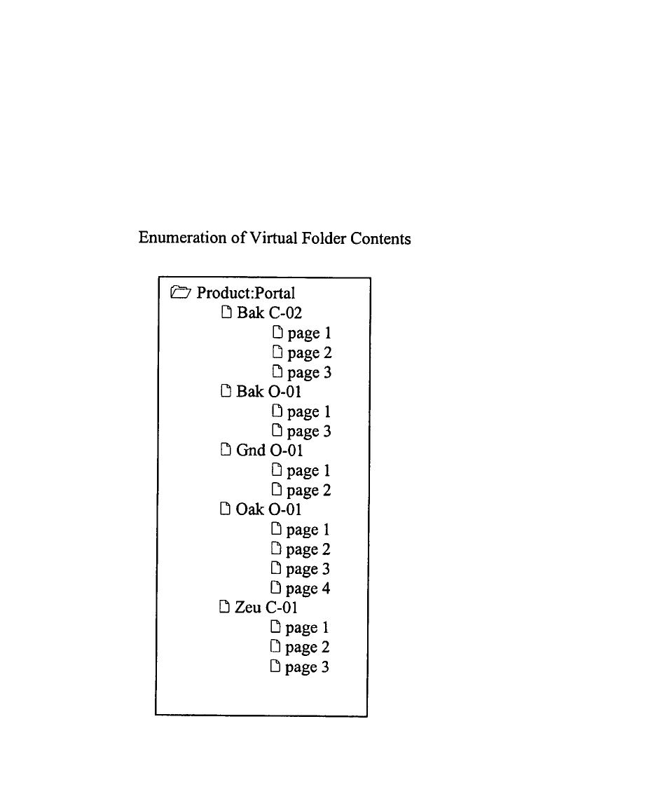

Referring finally to FIG. 71, enumeration of the contents of a virtual folder hierarchy will now be discussed. The enumeration is requested with the following parameters:

Branch Query Procedure (qp)

“qp” is a query procedure as described in connection with FIGS. 38-39 which identifies all of the pages (and thus documents) which fall within the current branch of the virtual folder hierarchy. The qp is executed as described in connection with FIGS. 38-56 to show the full subsumed contents of documents with associated pages at the current branch of the virtual folder hierarchy.

FIG. 71 is an example wherein the user has a folder product Portal which was retrieved using the folder enumeration method described above. Now if the user wants to see the contents of product Portal, he would execute the query procedure:

qp: [Page Validity] AND [Product]=“Portal”

For the example data set, this will return the following Page IDs:

8, 9, 10, 13, 15, 22, 23, 35, 36, 37, 38,49, 50

For the example data set, combined with the virtual folder enumeration, this will show the virtual folder with its contents of documents and pages, as indicated in FIG. 71.

So that finds all pages that are stored in index with the product value equal to Portal. For the example data set used in this section that lists the page IDs 8, 9, 10 and so forth, the system would then, for each one of the page IDs using the methods that described above, retrieve the logical page numbers within a document. So under product Portal there is document Bak C-02 and page 1, 2, 3 and document Bak O-01 and its pages and so forth on through the end.

Generalization of Improved Folder Retrieval

Although the improved folder retrieval has been described using folders of documents and pages, it can be advantageously applied to managing the organization and retrieval of any kinds of objects. For example, it could be used to replace a typical file system of devices, directories and files. Or it could be used to manage a hierarchy or network of programs; datasets; databases; servers; clients; users; personnel; resources; and so forth.

It will, thus, be apparent that there has been provided in accordance with the present invention an indexing and database management method and apparatus which achieves the aims and advantages specified herein. It will of course be understood that the foregoing description is of a preferred exemplary embodiment of the invention and that the invention is not limited to the specific embodiment shown. Various changes and modifications will become apparent to those skilled in the art. For example, to conserve storage memory, the size of the data value portions of the keys can be made variable rather than being fixed at a size selected to accommodate the larger data values. All such variations and modifications are intended to come within the scope of the appended claims.

What is claimed is:

1. A computer-readable memory for storing one or more indexes used to associate data with a plurality of objects, wherein each of the objects has a plurality of attributes associated therewith and one or more data values for each of the attributes, said computer-readable memory comprising:
a non-volatile data storage device;
an index stored on said data storage device, said index being associated with a first attribute of the objects, wherein said index comprises a number of keys that include one or more coarse keys and a number of fine keys, wherein each of said fine keys is associated with a group of the objects and with one of the first attribute's data values, and wherein said one or more coarse keys are each associated with a particular one of the first attribute's data values and with a set of said fine keys that are also each associated with that particular data value.

2. A computer-readable memory as defined in claim 1, wherein some of said fine keys are associated with a first data value and others of said fine keys are associated with a second data value, wherein both said first and second data values are data values associated with the first attribute.

3. A computer-readable memory as defined in claim 2, wherein said index includes coarse keys associated with each of said first and second data values.

4. A computer-readable memory as defined in claim 1, wherein said keys include a first portion that identifies whether it is a group key or a set key, a second portion that identifies the group or set to which it corresponds, and a third portion that indicates the data value to which it corresponds.

5. A computer-readable memory as defined in claim 4, wherein said third portion comprises an attributename::attributevalue pair wherein the attributename identifies the attribute with which the key is associated and the attributevalue indicates the data value with which the key is associated.

6. A computer-readable memory as defined in claim 4, wherein said keys are stored in order based upon the contents of said first, second, and third portions.

7. A computer-readable memory as defined in claim 4, wherein said first portion comprises the left most portion of each key, said second portion comprises the middle portion of each key, and said third portion comprises the right-most portion of each key.

8. A computer-readable memory as defined in claim 7, wherein said first portion comprises a single bit.

9. A computer-readable memory as defined in claim 1, wherein said index includes a number of bit vectors, each comprising a sequence of bits, and wherein each of said bit vectors is associated with a particular one of the keys and with the data value associated with that particular key.

10. A computer-readable memory as defined in claim 9, wherein said index includes a link for each of said keys, and wherein at least some of said links each indicate the location of the bit vector corresponding to the key associated with the link.

11. A computer-readable memory as defined in claim 9, wherein at least some of said bit vectors comprise fine bit vectors, with each bit within any selected one of the fine bit vectors corresponding to one of the objects and indicating whether its corresponding object has the data value associated with the bit vector as it first attribute.

12. A computer-readable memory as defined in claim 11, wherein each bit position with a fine bit vector corresponds to a different one of the objects.

13. A computer-readable memory as defined in claim 11, wherein each of said fine keys is associated with a fine link and wherein at least some of said fine links each provide a pointer to a corresponding one of said fine bit vectors.

14. A computer-readable memory as defined in claim 13, wherein at least one other of said fine links identifies a single object within the group of objects associated with that fine link.

15. A computer-readable memory as defined in claim 14, wherein each of said fine links includes at least one bit that indicates whether the link includes a pointer to a fine bit vector or an identifier of the single object.

16. A computer-readable memory as defined in claim 9, wherein at least some of said bit vectors comprise coarse bit vectors each associated with a different one of the coarse keys, with each bit within any selected one of the coarse bit vectors corresponding to a different group of objects and indicating whether any of the objects with the corresponding group has the data value associated with the coarse bit vector as it first attribute.

17. A computer-readable memory as defined in claim 16, wherein each of said coarse keys is associated with a coarse link and wherein at least some of said coarse links are each used to link one of the coarse bit vectors with its associated key.

18. A computer-readable memory as defined in claim 17, wherein at least one other of said coarse links identifies a single group of objects within the set of groups associated with that coarse link.

19. A computer-readable memory as defined in claim 18, wherein each of said coarse links includes at least one bit that indicates whether the link includes a pointer to a coarse bit vector or an identifier of the single group.

20. A computer-readable memory as defined in claim 18, wherein each of the ones of said coarse links that identify a single group include at least one bit that identifies whether or not all of the records within that single group contain the data value associated with the coarse link.

21. A computer-readable memory as defined in claim 1, wherein said index is stored as a B-tree.

22. A computer-readable memory as defined in claim 21, wherein said B-tree includes a root node, a plurality of intermediate nodes, and a plurality of leaves and wherein some of said keys are stored at said leaves and others of said keys are stored at said root and intermediate nodes.

23. A computer-readable memory as defined in claim 1, wherein said non-volatile data storage device comprises a plurality of fixed magnetic disk drives, wherein said database is stored as a single file that spans at least two of said fixed magnetic disk drives.

24. A computer-readable memory as defined in claim 1, further comprising a second index stored on said non-volatile data storage device, said second index being associated with a second attribute of the objects, wherein said second index comprises a number of keys that include one or more coarse keys and a number of fine keys, wherein each of said fine keys of said second index is associated with a group of the objects and with one of the second attribute's data values, and wherein said one or more coarse keys of said second index are each associated with a particular one of the second attribute's data values and with a set of said fine keys from said second index that are also each associated with that particular data value.

25. A computer-readable memory as defined in claim 24, wherein said indexes are each stored in a separate file on said non-volatile data storage device.

26. A computer-readable memory as defined in claim 24, wherein said indexes are stored as a single file and together comprise a single index with each key of the single index including an indexname::attributename::attributevalue triplet, wherein the indexname identifies one of the two indexes, the attributename identifies the attribute with which the key is associated, and the attributevalue indicates the data value with which the key is associated.

27. A computer-readable memory for storing one or more indexes used to associate data with a plurality of objects, wherein each of the objects has a plurality of attributes associated therewith and one or more data values for each of the attributes, said computer-readable memory comprising:
a non-volatile data storage device;
an index stored on said data storage device and being associated with a first one of the attributes, said index including a plurality of compressed bit vectors used to identify which objects have a particular data value for the first attribute, wherein at least some of said compressed bit vectors utilize run length encoding and have a variable run length field size.

28. A computer-readable memory for storing one or more word indexes used to index words contained in documents, said computer-readable memory comprising:
a non-volatile data storage device;
a word index stored on said data storage device, said word index being associated with a text word contained in at least one of the documents, wherein said word index includes a number of bit vectors that include a sequence of bits wherein each bit corresponds to a portion of one of the documents, with some of the bits corresponding to an individual page of the document and others corresponding to portions of two adjacent pages of the document.

29. A computer-readable memory for storing indexes used to associate a time stamp with a plurality of objects, said computer-readable memory comprising:
a non-volatile data storage device;
a plurality of indexes stored on said data storage device, each having time stamp information related to an event concerning each of the associated objects, wherein each index includes a number of keys with the keys of each index being associated with a different length time interval than the keys of the other index(es), and wherein the time stamp for each of the objects is determinable from a combination of data contained in each of the indexes.

30. A computer-readable memory for storing one or more indexes used to represent hierarchical relationships between objects, wherein each of the objects has a plurality of attributes associated therewith and one or more data values for each of the attributes, said computer-readable memory comprising:
a non-volatile data storage device;
a plurality of indexes stored on said data storage device and each being associated with a different one of the attributes and each index associating data values of its corresponding attribute with objects that have those data values of the corresponding attribute; and
a computer program operable to access the indexes and to provide a graphical user interface displaying a virtual folder corresponding to a particular one of the data values and displaying a set of object identifiers contained within that virtual folder, wherein the object identifiers represent those objects that are associated with the particular data value.
